(19) United States
(12) Patent Application Publication
(10) Pub. No.: US 2012/0201902 A1
(43) Pub. Date: Aug. 9, 2012

(54) ANTIMICROBIAL/PRESERVATIVE COMPOSITIONS COMPRISING BOTANICALS

(75) Inventors: Shanta M. Modak, River Edge, NJ (US); Nayana Baiju, Kochi (IN); Lauserpina A. Caraos, Hollis, NY (US); Hari Krishnan Ramachandran, New York, NY (US)

(73) Assignee: The Trustees of Columbia University in the City of New York, New York, NY (US)

(21) Appl. No.: 13/335,363

(22) Filed: Dec. 22, 2011

Related U.S. Application Data
(63) Continuation of application No. PCT/US2010/040667, filed on Jun. 30, 2010.
(60) Provisional application No. 61/221,971, filed on Jun. 30, 2009.
(60) Provisional application No. 61/221,991, filed on Jun. 30, 2009.
(60) Provisional application No. 61/352,183, filed on Jun. 7, 2010.

(51) Int. Cl. A01N 59/16; A01P 1/00; A01N 31/00; A01N 65/20; A01N 65/08; A01N 65/00; A01N 65/42

(52) U.S. Cl. 424/618; 424/725; 424/729; 424/736; 424/744; 424/745; 424/757; 424/776; 424/777; 514/730

(57) ABSTRACT

The present invention relates to a preservative or antimicrobial compositions which comprise low concentrations of botanical extracts, in synergistic combinations with alkanediols in a solvent system, optionally with fruit acids. Additionally, the present invention relates to a preservative or antimicrobial compositions which comprise a silver compound, an essential oil or individual constituent, one or more zinc salts, and one or more alkanediol. The compositions of the invention may be used in personal care products including wound care products or in veterinary use. Preferably, the compositions of the invention have little or no human-detectable fragrance.

### CROSS-REFERENCE TO RELATED APPLICATIONS

The present application claims priority to U.S. Application Ser. Nos. 61/221,971, filed Jun. 30, 2009; 61/221,991, filed Jun. 30, 2009; and 61/352,183, filed Jun. 7, 2010, the disclosure of which are incorporated herein by reference in their entireties.

### 1. INTRODUCTION

The compositions of the present invention contain combinations of low concentrations of essential oils and botanical extracts (including plant extracts and fruit extracts), in synergistic combinations with alkanediols and solvents. The compositions optionally contain a fruit acid or anti-inflammatory agent as well. In specific embodiments, certain concentrations of the solvent benzyl alcohol have been found to exhibit synergistic antimicrobial efficacy with certain botanical acids, especially fruit acids.

The present invention additionally relates to compositions containing silver sulfadiazine, an antimicrobial agent and calendula oil, a wound healing agent. The compositions optionally contain silver releasing agents and/or antifungal activity enhancers. The compositions may be used in topical hydrophilic creams for the treatment of burns, wounds, and surface infections.

Preferably, the inventive compositions have very mild or little to no fragrance. The compositions of the invention may be used as non-toxic, non-fragrant alternatives to conventional preservatives or may be combined with other antimicrobial agents to enhance their activity, and may be particularly useful in personal care and veterinary product applications.

### 2. BACKGROUND OF THE INVENTION

Essential oils are volatile oils obtained from plant or animal sources and are composed of complex mixtures of several constituents, such as monoterpenes and sesquiterpene hydrocarbons, monoterpene and sesquiterpene alcohols, esters, ethers, aldehydes, ketones, oxides and the like. These essential oils and their isolated constituents are frequently utilized as fragrance and flavor agents, and have been widely used in folk medicine for wound healing properties.

Scientific research has corroborated the beneficial effects of essential oils. Essential oils of eucalyptus have been found to “possess central and peripheral analgesic effects as well as neutrophil-dependent and independent anti-inflammatory activities” (Silva et al., 2003, J. Ethnopharmacol. 89(2-3); 277-283), and similar activity has been observed in essential oils from Lavendula angustifolia Mill. (Hajhashemi et al., 2003, J. Ethnopharmacol. 89(1):67-71). Essential oils have been demonstrated to exhibit antibacterial (Bezic et al., 2003, Phytother. Res. 17(9:1037-1040; Goren et al., 2003, Z. Naturforsch. 58(9-10):687-690; de Abreu Gonzaga et al., 2003, Planta Med. 69(8:773-775; Valero and Salmera, 2003, Int. J. Food Microbiol. 85(1-2): 73-81) and antifungal (Paranagama et al., 2003, Lett. Appl. Microbiol. 37(1):86-90; Shin, 2003, Arch. Pharm. Res. 26(5):389-393; Velluti et al., 2003, Int. J. Food Microbiol. 89:145-154) activities. Virucidal activity of essential oils has also been observed, including direct virucidal effects against Herpes simplex viruses types 1 and 2 (Garcia et al., Phytother. Res. 17(9):1073-1075; Minami, et al., 2003, Microbial Immunol. 47(a):681-684; Schuhmacher et al., 2003, Phytomedicine 10:504-510).

United States Patent Application Publication No. 20050048139 by Modak et al., published Mar. 3, 2005, relates to topical compositions comprising an emollient solvent and an essential oil, which may further comprise additional additives, among which citric acid, glycolic acid and lactic acid are cited.

United States Patent Application Publication No. 20050019431 by Modak et al., published Jan. 27, 2005, relates to compositions comprising a quaternary ammonium compound and an essential oil (or active component thereof).

A number of patent applications relate to compositions comprising an essential oil (or component thereof) where zinc salts are added to inhibit irritation associated with essential oils. Examples of such patent applications include United States Patent Application Publication No. 20040102429 by Modak et al., published May 27, 2004 and United States Patent Application Publication No. 20050238602 by Modak et al., published Oct. 27, 2005, now U.S. Pat. No. 7,435,429.

U.S. Pat. No. 6,858,317 by Aamodt et al., issued Feb. 22, 2005, relates to methods for protecting wood from mold and sap staining fungi which employ a non-toxic mold inhibitor which may be a plant extract such as an essential oil.

U.S. Pat. No. 5,100,652 by Kross et al., issued Mar. 31, 1992, relates to low concentration chlorous-acid generating oral hygiene compositions which may comprise an essential oil as a flavoring agent.

U.S. Pat. No. 5,310,546 by Douglas, issued May 10, 1994, relates to a mouth rinse preparation comprising hydrogen peroxide, zinc chloride, sodium citrate, sodium lauryl sulfate, citric acid and ethanol and optionally an essential oil which is a denaturing agent.

BiON offers several skin care products comprising citric acid, botanicals, and other agents for topical use (San Diego, Calif., US).

Johnson et al. (U.S. Pat. No. 6,319,958 and US20020165130) relates to the use of sesquiterpenoids to promote uptake of exogenous antimicrobial compounds. Similarly, a related article discloses the use of sesquiterpenoids, such as nerolidol, farnesol, bisabolol and apritone, in enhancing bacterial permeability and susceptibility to exogenous antimicrobial compounds, suggesting that sesquiterpenoids have a non-specific and general effect (Brehm-Stecher et al. 2003, Antimicrobial Agents and Chemotherapy, 47(10):3357-3360). In particular, Brehm-Stecher et al. report that nerolidol, farnesol, bisabolol and apritone enhanced the susceptibility of S. aureus to the antibiotics erythromycin, gentamicin, vancomycin, ciproflaxin, clindamycin, and tetracycline.

U.S. Pat. No. 4,867,898 by Spaulding et al., issued Sep. 19, 1989, relates to a liquid hard surface cleaner comprising pine oil and organic, oil-soluble acids at a pH from 0-6.

U.S. Pat. No. 6,753,305 by Raso and Caselli, issued Jun. 22, 2004, relates to a hard surface disinfectant comprising up to 20 percent of cinnamon oil or a component thereof, 0.01-5 percent of an organic acid, and optionally an additional essential oil.

International Patent Application Publication No. WO2007/077573 by Mukhopadhyay, published Jul. 12, 2007, relates to antimicrobial compositions comprising an antimicrobial agent, such as triclosan, and a functionalized hydrocarbon, where the functionalized hydrocarbon can be an essential oil, and/or a solvent.

Infection continues to be the major problem in the management of patients with burn wounds, decubitus ulcers and other surface infections. Control of skin infections is most important in preventing bacteremia and enhancing wound healing. Topical creams containing silver sulfadiazine and other topical antimicrobial agents have been developed and widely used for such purposes. However, complete control of target infection has not been achieved with the use of these agents.

1% silver sulfadiazine (Silvadene®) cream has been effectively used as a prophylactic cream to control burn wound infections. However, it is not very effective in treating established deep wound infections due to the drug's failure to penetrate the wound eschar. The incidence of wound colonization with S. aureus or C. albicans in Silvadene® treated patients has spurred research for other agents.

It has been well established that continuous control of infection facilitates rapid healing of partial thickness burns, decubitus ulcers and other types of surgical wounds and facilitates their closure. Wound healing, especially in burns, is a complex process for which zinc has been found essential. Studies on zinc have shown beneficial results in wound healing with acceleration of the re-epithelialization process and an antibacterial effect. Zinc oxide has been reported to activate endogenous zinc-dependent matrix metalloproteinases, augment expression of endogenous growth factors and facilitate keratinocyte migration.

In earlier studies, topical treatment of burn wounds with zinc sulfadiazine was found to accelerate wound healing better than treatment with silver sulfadiazine. (Gyn and Obstet, 142:553-559 (1976)).

To prevent or reduce infection of burn wounds, topical ointments have been used. These ointments have incorporated silver sulfadiazine (U.S. Pat. No. 3,761,590, incorporated herein by reference) or various antibiotics. A topical ointment for burns has also been reported which contains a combination of silver salts and norfloxocin, a quinoline antibiotic, or its salts (U.S. Pat. No. 4,404,197, incorporated hereby by reference). In the case where the antibiotic is silver norfloxocin, U.S. Pat. No. 4,404,197 reports a synergistic enhancement of activity. U.S. Pat. No. 5,374,432 relates to topical anti-infective ointments containing an antibiotic, silver salt, and sterile carrier. These compositions were found to not only provide improved antimicrobial efficacy, but also reduced incidence of microbial resistance.

U.S. Pat. No. 6,987,133 relates to a topical preparation containing silver sulfadiazine dispersed or solubilized in a cream or lotion base matrix which can be sprayed directly on the burn wound. European Patent No. EP0653214 relates to a topical antibacterial preparation containing silver sulfadiazine and collagen for the treatment of infected hands and for the advancement of their healing.

There is a continuing desire for an antimicrobial or wound healing composition that are non-irritating, safe, and effective for repeated use in various professional and non-professional settings.

### 3. SUMMARY OF THE INVENTION

The compositions of the invention contain low concentrations of one or more essential oil (and/or one or more component (i.e., an “Individual Constituent” or “IC”) thereof) and one or more botanical extract, such as a plant or fruit extract, in combination with one or more alkanediol and one or more solvent. The invention is based, at least in part, on the discovery that certain low concentrations of specific combinations of these ingredients have an unexpected synergistic effect, namely the combinations can confer superior antimicrobial properties on personal care, veterinary, as well as household products. Preferably, all components of the preservative composition are derived from a natural (rather than a synthetic) source. Preferably, the compositions of the invention have little or no human-discernable fragrance.

In various non-limiting embodiments, the compositions of the present invention may include one or more botanical extract, benzyl alcohol, and 1,3-propanediol, wherein the amounts of botanicals and benzyl alcohol are present in a ratio of about 1:1 to 1:12, and wherein the composition pH ranges from 3-5. Optionally, the compositions may further contain fruit acids, additional solvents and/or anti-inflammatory compounds.

In various non-limiting embodiments, the present invention may be utilized in personal care products such as soaps, scrubs, cosmetics, topical creams and lotions, wound care products, burn wound cream, decubitous ulcer cream (with anti-inflammatory botanicals and the use of silver sulfadiazene as an anti-microbial agent), rapidly acting skin disinfectants, disinfecting wipes, and veterinary products, such as antimicrobial lotion for mastitis, teat dip, and therapeutic ointments. The compositions of the invention may be used in concentrations from about 1% to about 10% in personal care products or topical creams.

The present invention relates to topical creams containing antimicrobial agents such as silver salts, calendula oil, zinc salts, and curcumin compounds. Non-limiting examples of silver salts include silver sulfadiazine, silver nitrate, silver carbonate, and silver oxide. Additional antimicrobial agents include biguanides (chlorhexidine or polyhexamethelene biguanide), phenoxyethanol, miconazole, polymixin, neomycin bacitracin and povidone iodine. These antimicrobial agents provide for the control of infection and promote wound healing in a wide variety of skin lesions, including burns, abrasions, decubitus ulcers, and other local infections.

Furthermore, the synergistic combination of benzyl alcohol and 1,3 propanediol, octanediol and decanediol, which exhibit antifungal activity, is used in the above described topical cream to enhance the antifungal activity. Lactic acid or citric acid is used to assist in the controlled release of silver.

### 4. DETAILED DESCRIPTION OF THE INVENTION

For clarity of description, and not by way of limitation, the detailed description of the invention is divided into the following subsections:

(4.1) essential oils;

(4.2) botanical extracts;

(4.3) alkanediols;

(4.4) solvents;

(4.5) fruit acids;

(4.6) combinations of solvents, botanical extracts, and alkanediols;

(4.7) silver and silver salts;

(4.8) zinc and zinc salts;

(4.9) antimicrobials;

(4.10) synergistic combinations of benzyl alcohol and alkanediols;

(4.11) personal care products;

(4.12) wound healing;

(4.13) veterinary products;

(4.14) household/industrial products; and

(4.15) medical devices.

In preferred, non-limiting embodiments, the compositions of the invention have little or no human-discernable fragrance or scent. While certain embodiments of the invention may have a very slight scent, this scent is not sufficient to substantially distort or mask the scent of an added fragrance. Accordingly, the preservative compositions of the invention may be used either in unscented products or, alternatively, in products scented with a desired fragrance (for example, a fragrance associated with a particular brand of product). In the latter case, the preservative composition of the invention will not substantially alter (or preferably, detectably alter) the character of the desired fragrance. Preferably, the compositions are fragrance-free.

In preferred, non-limiting embodiments of the invention, the compositions include botanicals, which include essential oils or individual constituents thereof, and botanical extracts. Each category of botanicals is summarized below.

“About” as used in this document means plus or minus 20 percent of the recited value, so that, for example, “between about 0.125 and 1.0 percent” means a range between 0.125±0.025 and 1.0±0.2.

### 4.1 Essential Oils

Essential oils (“EOs”), as defined herein, are volatile oils obtained from plant or animal sources, or their synthetic equivalents, and are composed of complex mixtures of several constituents such as monoterpenes and sesquiterpene hydrocarbons, monoterpene and sesquiterpene alcohols, esters, ethers, aldehydes, ketones, oxides and the like. Examples of EOs include, but are not limited to, cinnamon oil, basil oil, bergamot oil, clary sage oil, ylang-ylang oil, neroli oil, sandalwood oil, frankincense oil, ginger oil, peppermint oil, lavender oil, jasmine absolute, geranium oil bourbon, spearmint oil, clove oil, patchouli oil, rosemary oil, rosewood oil, sandalwood oil, tea tree oil, vanilla oil, lemongrass oil, cedarwood oil, balsam oils, tangerine oil, Hinoki oil, Hiba oil, ginko oil, eucalyptus oil, lemon oil, orange oil, sweet orange oil, pomegranate seed oil, manuka oil, citronella oil, and calendula oil.

Individual constituents (“ICs”) of essential oils may be isolated from the oil (natural) or may be entirely or partially chemically synthetic, and include, but are not limited to, thyme, oregano, curcumin, 1-citronellol, α-amylcinnamaldehyde, lyral, geraniol, farnesol, hydroxycitronellal, isoeugenol, eugenol, camphor, eucalyptol, linalool, citral, thymol, limonene and menthol. Further examples of ICs include sesquiterpenoid compounds, which may be the active compounds in the essential oils. Sesquiterpenoid compounds, containing 15 carbons, are formed biosynthetically from three 5-carbon isoprene units. Sesquiterpenoid compounds include, but are not limited to, farnesol, nerolidol, bisabolol, apritone, chamazulene, santalol, zingiberol, carotol, and caryophyllen.

Mixtures of one or more EO one or more IC, and one or more EO as well as one or more IC, are encompassed by the present invention. In specific non-limiting embodiments of the invention, an IC is selected from the (non-limiting) group consisting of camphor, curcumin, alpha-pinene, constituents of cinnamon leaf oil such as, cinnamaldehyde, cinnamylacetic ester, cinnamic acid, ethyl cinnamate, methyl chavicol, linalool, beta-caryophyllene, and eugenol; constituents of lemongrass oil such as d-limonene, geranyl acetate, nerol, geraniol, citral, and/or myrcene; constituents of citronella oil such as geraniol, citronellol, citronellal, geranyl acetate, limonene, methyl isoueugenol, and/or elemol; components of basil oil such as camphor, limonene, and/or β-selinene; and constituents of orange oil such as α-pinene, sabinene, myrcene, limonene, linalool, citronellal, neral and/or geranial. An EO or IC for use in the invention may be obtained from its natural source or may be chemically synthesized.

In preferred non-limiting embodiments of the invention, the EO is selected from one or more EO from the group consisting of cinnamon oil (CO) (bark or leaf), lemongrass oil (LGO), and basil oil (BO), all of which have little to no fragrance, or nonfragrant oils such as pomegranate seed oil (PSO).

Calendula contains high amounts of flavonoids, plant-based antioxidants that protect the body against cell-damaging free radicals. It appears to have anti-inflammatory, antiviral, and antibacterial effects. Animal studies show that calendula accelerates wound healing, possibly by increasing blood flow to the wounded area and by helping the body produce collagen proteins, which are used to heal skin and connective tissue.

In various non-limiting embodiments, low concentrations of essential oils and ICs are used. Essential oils or ICs are present in stock solutions in amounts ranging from about 0.05% to about 30% (w/w). In alternative embodiments, for example compositions that may be used without dilution, the amounts range from about 0.01% to about 1% (w/w). These concentrations (and others recited throughout) may be increased in stock solutions intended for dilution.

In specific non-limiting embodiments of the invention, an IC is selected from the (non-limiting) group consisting of a curcumin compound and calendula oil. In various non-limiting embodiments, low concentrations of essential oils and ICs are used. Specifically, calendula oil are used in amounts ranging from about 0.3 to about 5% w/w, and curcumin compounds are used in amounts ranging from about 0.02 to about 0.2% w/w. These concentrations (and others recited throughout) may be increased in stock solutions intended for dilution.

### 4.2 Botanical Extracts

Botanical extracts, as defined herein, include plant, herbal, and fruit extracts, which are not “essential oils” as noted above. The botanical extracts utilized herein include but are not limited to Camellia sinensis (green tea), grapes, pomegranate, Echinacea, Centella Asiatica, Elderflower, Irish moss, Mallow, soap bark, Yucca, Clary sage, oregano, thyme, curcumin compounds, resveratrol (polyphenolic compound from grape, berries, etc.) and mixtures thereof. The botanical utilized to obtain the botanical extract may be obtained from any of the plant parts including the leaves, pulp, seeds, or stems, fruit and fruit seeds, as well as the whole plant. Herbal extracts can be, for example, standardized extracts that are dispersible and/or soluble in aqueous medium.

Examples of herbal extracts include, without limitation, extracts of chamomile, rosemary, aloe, nettle, Centella asiatica, ginkgo biloba, betula, and witch hazel. Such extracts may be delivered in a carrier such as water, propylene glycol, hydroalcohol, glycerine, or butylene glycol. Additional extracts with nutritional quality can be used, including, without limitation, green tea, white tea, grape skin, grape seed, grapefruit, grapefruit seed, grapefruit peel, citrus fruits (other than grapefruit extract) bilberry, blueberry, Ginkgo biloba, soy isoflavones, soy extract, fermented soy protein, black cohosh, St. John's wort, echinacea, chamomile, rosemary, aloe extract and juice, nettle, coconut fruit and Centella asiatica. Botanical extracts can be obtained from, for example, Active Organics (Lewisville, Tex.), New Age Botanicals (Garland, Tex.), Triarco Industries (Wayne, N.J.), and Aloecorp (Broomfield, Colo.).

Examples of nonfragrant botanicals include pomegranate seed oil (PSO), mixtures of edible plant extract Kefiprotect (KP), and tetrahydrocurcuminoid (THC). Turmeric and curcuminoids have been documented to have anti inflammatory, antioxidant and wound healing properties. The following curcuminoids can be used in topical creams, tetrahydrocurcumin, tetrahydrodemethoxycurcumin, tetrahydrobisdemethoxycurcumin, and mixtures thereof. Additional examples of botanical extracts include coconut derived phospholipid (Arlasik phospholipid PTM), natural blends of fatty acids which mimic those found in the stratum corneum, mixture of fatty acids with pigments such as carotenes, carotenoids or phytosterols that are known to facilitate repair to damaged skin, and the like. Specific examples of useful botanical extracts include avocado, which contains the sterol sitosterol; carrot, which contains beta carotene; sesame oil which contains a mixture of saturated and unsaturated fatty acids, and brazil nut oil. Because of its broad distribution of fatty acids, extracts such as brazil nut oil, can outperform single fatty acids with respect to incorporation into the lipid lamellar structures. Brazil nut oil (BNO) originates from the harvested fruit from the South American rain forest tree: Bertholletia excelsa.

Botanical extracts also include flavanoids and terpenoids. The flavinoids contemplated by the present invention include, but are not limited to, turin, quercetin, hesperidin, and naringin. Terpenoids contemplated by the present invention include, but are not limited to, monoterpenes, sesquiterpenes, and diterpenes.

In preferred non-limiting embodiments of the invention, the botanical extract is selected from one or more extract selected from the group consisting of grapefruit seed extract (GSE), pomegranate seed oil (PSO), citrus fruit extract, or mixtures of edible plant extract Kefiprotect (KP), coconut derived phospholipid (Arlasik phospholipid PTM), and tetrahydrocurcuminoid (THC).

In various non-limiting embodiments, low concentrations of botanical extracts are used. Botanical extracts are present in stock solutions in concentrations ranging from about 2.0% to about 45% (w/w), preferably from about 10% to about 20% (w/w). In alternative embodiments, the concentrations range from about 0% to about 20% (w/w), preferably from about 0% to about 10% (w/w), preferably from about 0% to about 4% (w/w). Alternative embodiments use from about 5% to about 10% (w/w).

### 4.3 Alkanediols

In non-limiting embodiments, bifunctional alcohols which may be used according to the present invention are alkanediols. Suitable alkanediols include, but are not limited to, propanediol, butanediol, dodecanediol, decanediol, nonanediol, octanediol, heptanediol, hexanediol, and pentanediol.

In particular non-limiting embodiments, the alkanediols have a carbon backbone of between 3 and 25 carbon atoms, including but not limited to 1,9 Nonanediol, 1,2-Decanediol, 1,10-Decanediol, 1,11-Undecanediol, 1,2-Dodecanediol, 1,12 Dodecanediol, Cyclododecanediol, 1,13-Tridecanediol, 1,2-Tetradecanedio-1,1,14-Tetradecanediol, 1,15-Pentadecanediol, 1,16-Hexadecanediol, 1,17-Heptadecanediol, 1,18-Octadecanediol, 1,19-Nonadecanediol, 1,20-Eicosanediol, 1,21-Heneicosanediol, 1,22-Docosanediol, 1,23-Tricosanediol, 1,24-Tetracosanediol, 1,25-Pentacosanediol. A preferred non-limiting alkanediol is 1,3 propanediol (Zemea®), which is a natural product prepared from corn sugar.

In non-limiting embodiments of the invention, the stock solution concentration of the alkanediols ranges from about 0.5% to about 70% (w/w), preferably from about 10% to about 70% (w/w). In alternative embodiments, the concentration of alkanediols ranges from about 0% to about 50% (w/w), preferably from about 0% to about 10% (w/w), more preferably from about 5% to about 10% (w/w). In other embodiments, the concentration of alkanediols ranges from about 1% to about 5% (w/w).

### 4.4 Solvents

In various non-limiting embodiments, the compositions of the present invention may include one or more solvent, including but not limited to solvent(s) selected from the group consisting of water, alcohols, glycols, glycerol, glycerine, octoxyglycerin, diglycerol, propylene glycol, dipropylene glycol, and vegetable oils.

Preferred but non-limiting examples of non-alkanediol alcohols for solubilisation are aliphatic alcohols having between about 1 and 8 carbon atoms such as methanol, ethanol, n-propanol, isopropyl alcohol, 2-methyl-2 propanol, hexanol, or combinations thereof. Aromatic alcohols, for example, but not by way of limitation, phenoxyethanol, benzyl alcohol, 1-phenoxy-2-propanol, and/or phenethyl alcohol, may also optionally be used in combination with aliphatic alcohols.

Aromatic alcohols, for example, but not by way of limitation, include phenoxyethanol, benzyl alcohol, 1-phenoxy-2-propanol, and/or phenethyl alcohol, for example at a concentration of between about 0.5 and 5% (weight/weight) may also optionally be used in combination with aliphatic alcohols. A further solvent which optionally may be comprised in a composition of the invention is isopropyl myristate. Additional aliphatic alcohols include ethanol, denatured alcohol (SDA 40B and SDA 3C) and isopropanol.

Compositions comprising synergistic combination of benzyl alcohol, botanicals, and 1,3 propanediol and its derivatives such as 2-methyl-1-nitro 1,3-propanediol (Diol) or 2-Hydroxymethyl 2-nitro 1,3-propanediol (Triol), further contain cosolvents such as glycerin, octoxyglycerin, alcohol, glycols, butanediol, and phenoxy ethanol.

In preferred non-limiting embodiments of the invention, the solvent is benzyl alcohol, glycerin, or a combination thereof. The solvents are used in stock solution concentrations ranging from about 0% to about 90% (w/w), preferably from about 0% to about 85% (w/w), preferably from about 0% to about 70% (w/w), preferably from about 30% to about 65% (w/w). Benzyl alcohol concentrations range from about 0% to about 90%, more preferably from about 0% to about 70%, preferably from about 5% to about 90% (w/w). In other embodiments, the concentrations are from about 1% to about 10% (w/w), more preferably from about 5% to about 10% (w/w). In alternative embodiments, the concentration ranges range from about 5% to about 90% (w/w), preferably from about 30% to about 90% (w/w), and more preferably from about 40% to about 80% (w/w). In a preferred embodiment, the solvent is a natural product, for example, benzyl alcohol derived from the Cassia plant.

In alternative preferred non-limiting embodiments of the invention, the solvent is benzyl alcohol or its derivatives, e.g., hydroxyl benzyl alcohol, nitro benzyl alcohol, or other derivatives. Benzyl alcohol concentrations ranging from about 0.5% to about 10% (w/w), preferably from about 0.5% to about 5% (w/w), more preferably from about 0.5% to about 4% (w/w), have been found to exhibit synergistic antimicrobial efficacy with certain botanical organic acids, and in particular fruit acids. Alternative embodiments use from about 1.0% to about 5.0% (w/w), or from about 1% to about 3% (w/w) benzyl alcohol. Use of other botanicals and synthetic antimicrobials along with benzyl alcohol and these acids further enhances the synergistic activity as discussed in further detail below.

### 4.5 Fruit Acids

Fruit acids which may be used according to the invention include but are not limited to citric acid, glycolic acid, lactic acid, malic acid, tartaric acid and acetic acid. In certain non-limiting embodiments, the fruit acid is Multifruit BSC (Arch Chemicals), which is a mixture of lactic, citric, tartaric, glycolic, and malic acid extracted from plants. In preferred non-limiting embodiments of the invention, the fruit acid is lactic acid. A fruit acid for use in the invention may be obtained from its natural source or may be chemically synthesized.

Organic acids may also be used according to the invention. Organic acids include but are not limited to benzoic acid and its derivatives including salt forms, for example, a benzyl benzoate, paramino benzoic acid, nitro benzoic acid, hydroxyl benzoic acid, fluorobenzoic acid, and benzyl salicylate.

Fruit acids may be used according to the invention to assist in the controlled release of the silver compound. Non-limiting examples of fruit acids include but are not limited to citric acid, glycolic acid, lactic acid, malic acid, tartaric acid and acetic acid. In certain non-limiting embodiments, the fruit acid is Multifruit BSC (Arch Chemicals), which is a mixture of lactic, citric, tartaric, glycolic, and malic acid extracted from plants. A fruit acid for use in the invention may be obtained from its natural source or may be chemically synthesized. In preferred non-limiting embodiments of the invention, the fruit acid is lactic acid or citric acid.

In non-limiting embodiments of the invention, the stock solution concentrations of the fruit acids ranges from about 0% to about 70%, preferably from about 5% to about 70%, more preferably from about 5% to about 20% (w/w), more preferably from about 10% to about 20% (w/w). In alternative non-limiting embodiments of the invention, the concentrations range from about 0% to about 40%, preferably from about 0.1% to about 20% (w/w), more preferably from about 0.2% to about 4% (w/w), even more preferably from about 0.5% to about 4% (w/w), or from about 2% to about 4% (w/w). In alternative embodiments, the concentrations range from about 0.2% to about 2% (w/w), more preferably from about 0.2 to about 1% w/w.

### 4.6 Combinations of Solvents, Botanical Extracts, and Alkanediols

In various non-limiting embodiments, the present invention provides for compositions comprising a combination of a solvent, a botanical extract, and an alkanediol. Preferably, this combination produces a synergistic anti-microbial effect against at least one microbe selected from the group consisting of Escherichia coli, Pseudomonas aeruginosa, Staphylococcus aureus, methicillin-resistant S. aureus, and Candida albicans (“synergistic” means that the antimicrobial effect of the combination is greater than the sum of the antimicrobial effects of the individual components).

In particular, non-limiting embodiments, the present invention provides for formulations that are concentrated and may be diluted to provide a composition for personal, household, or industrial use. The present invention further provides for methods of providing an antimicrobial effect to a surface comprising applying, to the surface, an effective amount of a composition as described herein. An antimicrobial effect means killing and/or inhibiting the growth/proliferation of a microbe. In particular non-limiting embodiments of the invention, the microbe is selected from the group consisting of from the group consisting of Escherichia coli, Pseudomonas aeruginosa, Staphylococcus aureus, methicillin-resistant S. aureus, and Candida albicans. In specific non-limiting embodiments, the composition is exposed to the surface for at least 20 seconds, at least 30 seconds, or at least 60 seconds, or at least 5 minutes or at least 10 minutes. In various non-limiting embodiments, the surface may be the a skin or mucosal surface, a household surface (e.g., a surface of a countertop, table sink, toilet, wall, floor, appliance, window, shower surface, rug, upholstery, fabric, etc.) or an industrial surface (e.g., a surface of a countertop, table sink, toilet, wall, floor, appliance, window, shower surface, rug, upholstery, fabric, etc.).

In particular, non-limiting embodiments of the invention, the compositions comprise between about 0.0 and 70% (w/w) of one or more solvent, between 10% and 70% (w/w) alkanediols, and between about 2.0 and 45% (w/w) essential oils and/or botanical extracts. In a particular embodiment of the invention, the compositions comprise benzyl alcohol, 1,3 propanediol (Zemea®), and grapefruit seed extract (GSE). Fragrance free botanicals such as grape fruit seed extract (GSE), Curcumin compounds (CRMN) with or without fruit acid exhibits synergistic antimicrobial efficacy with benzyl alcohol. The stability and efficacy of the composition can be enhanced by the use of 1,3 propanediol.

The following table provides examples of such formulations.

TABLE 1

| | | % w/w in |
|---|---|---|
| Preservative | Ingredient | stock |
| Preservative 5 | Benzyl alcohol | 41.7 |
| | Zemea ® | 41.7 |
| | GSE | 16.6 |
| Preservative 5A | Benzyl alcohol (synthetic) | 41.7 |
| | 1,3 propanediol (synthetic) | 41.7 |
| | GSE | 16.6 |
| Preservative 15A | GSE | 16.7 |
| | Zemea ® | 41.65 |
| | Benzyl alcohol | 41.65 |

In preferred non-limiting examples of the invention, lactic acid or a comparable fruit acid is optionally added to the formulation.

TABLE 2

| | | % w/w in |
|---|---|---|
| Preservative | Ingredient | stock |
| Preservative 8 | GSE | 20.0 |
| | Benzyl alcohol | 33.3 |
| | Glycerin | 33.3 |
| | Lactic acid | 13.3 |
| Preservative 12 | GSE | 20 |
| | Benzyl alcohol | 33.3 |
| | Zemea ® | 33.3 |
| | Lactic acid | 13.3 |
| Preservative 15B | GSE | 14.3 |
| | Zemea ® | 35.7 |
| | Benzyl alcohol | 35.7 |
| | Lactic acid | 14.3 |

In preferred non-limiting examples of the invention, an anti-inflammatory may be optionally added to the formulation. For example, tetrahydrocurcuminoid (THC) may be added to the formulation.

TABLE 3

| | | % w/w in |
|---|---|---|
| Preservative | Ingredient | stock |
| Preservative 15 | GSE | 14.3 |
| | Lactic acid | 14.3 |
| | Zemea ® | 35.7 |
| | Benzyl alcohol | 35.7 |
| Preservative 16 | GSE | 13.3 |
| | Lactic acid | 13.3 |
| | Zemea ® | 33.3 |
| | Benzyl alcohol | 37.3 |
| | tetrahydro curcuminoid | 2.8 |
| Preservative 17 | Lactic acid | 16.1 |
| | Zemea ® | 40.3 |
| | Benzyl alcohol | 40.3 |
| | tetrahydro curcuminoid | 3.23 |
| Preservative 22 | GSE | 20 |
| | Zemea ® | 25 |
| | Benzyl alcohol | 50 |
| | Tetrahydro curcuminoids | 5.0 |
| Preservative 23 | GSE | 16.7 |
| | Zemea ® | 20.8 |
| | Benzyl alcohol | 41.6 |
| | Lactic acid | 16.7 |
| | Tetrahydro curcuminoids | 4.2 |

In non-limiting examples of the present invention, benzyl alcohol is combined with GSE, Zemea®, lemongrass oil, and lactic acid.

TABLE 4

| | | % w/w in |
|---|---|---|
| Preservative | Ingredient | stock |
| Preservative 13 | GSE | 16.7 |
| | Lactic acid | 13.3 |
| | Zemea ® | 66.7 |
| | Lemongrass oil | 3.3 |
| Preservative 14 | GSE | 16.7 |
| | Lactic acid | 13.3 |
| | Benzyl alcohol | 33.3 |
| | Lemongrass oil | 3.3 |
| | Zemea ® | 33.3 |

In certain non-limiting examples of the invention, the antimicrobial composition contains synergistic amounts of benzyl alcohol and botanicals. In these embodiments, the inclusion of an alkanediol, such as 1,3-propanediol, which acts as an emollient solvent, is optional. The benzyl alcohol has been found to exhibit synergistic antimicrobial efficacy with certain botanical organic acids, in particular fruit acids. Use of other botanicals and synthetic antimicrobials along with benzyl alcohol and these acids further enhances the synergistic activity. A nonlimiting example of an antimicrobial composition containing the synergistic combination includes from about 0.5 to about 10% (w/w) benzyl alcohol and from about 0.2 to about 4% (w/w) fruit acids which include but are not limited to lactic acid, citric acid, plant-based benzoic acid, and combinations thereof. These compositions exhibit broad spectrum and persistent activity at a pH range from about 3.0 to about 6.0, preferably from about 3.0 to about 5.0.

In addition to the above ingredients, a composition of the invention may optionally further comprise an emollient to further reduce irritation, such as, but not limited to, a fatty alcohol, behentrimonium methosulfate-cetyl alcohol (Incroquat TMS), or a polyol such as glycerol, propylene glycol, diglycerol, ethylene glycol, diethylene glycol, triethylene glycol, dipropylene glycol, tripropylene glycol, hexylene glycol, butylene glycol, etc.

Essential oils are volatile and therefore it is desirable that the antimicrobial composition containing essential oils is incorporated in a suitable base in which it is stable at higher temperature and over a long period of time. Accordingly, a composition of the invention may optionally comprise a hydrophilic or hydrophobic gel forming polymer, a fatty acid, a plant oil, etc. Suitable hydrophilic gel polymers include, but are not limited to, hydroxypropylmethyl cellulose, cationic hydroxyethyl cellulose (U-care polymers), ethyl cellulose, hydroxypropyl cellulose, hydroxymethyl cellulose, carboxy methyl cellulose, polyethylene oxide (polyox resins), and chitosan pyrrolidone carboxylate (Kytamer PC), silica gel, carbomerpolymers etc. Suitable hydrophobic gel polymers include, but are not limited to, silicone polymers, for example polydimethylsiloxane polymer (Dow Corning 225 Silicone Fluid), dimethiconol fluid in dimethicone (Dow Corning 1403 Silicone Fluid), cyclomethicone and dimethicone copolyl (Dow Corning 3225C and Q2-5220 Silicone Fluid), silicone glycol (BASF 1066 DCG polyol), KSG series Silicone gels (Shin-etsu), and combinations thereof. Suitable plant oils include, but are not limited to, olive oil, almond oil, avocado oil, basil oil, primrose oil, peanut oil, safflower oil, sesame oil, soya or soy bean oil, wheat germ oil.

The compositions of the present invention may optionally further contain other botanicals or synthetic antimicrobial compounds. Exemplary but non-limiting antimicrobials may include synthetic antimicrobial agents such as quaternary ammonium compounds such as benzalkonium chloride and/or benzethonium chloride, biguanides, chlorhexidine, polyhydroxymethylbiguanide (PHMB), Vantocil (polyiminoimidocarbonyliminoimidocarbonyl-iminohexamethylene)hydro-chloride, chlorinated phenols (Triclosan, PCMX (Para Chloro Meta Xylenol), propanediol and their derivatives, iodine compounds, silver salts, and antifungal agents such as miconazole. Concentrations range from about 0% to about 10% (w/w), preferably from about 0% to about 5% (w/w), more preferably from about 0% to about 2% (w/w).

### 4.7 Silver and Silver Salts

The silver component of the invention may be elemental silver or a silver salt. Suitable silver salts include silver acetate, silver benzoate, silver carbonate, silver iodate, silver iodide, silver lactate, silver laurate, silver nitrate, silver oxide, silver palmitate, silver protein and silver sulfadiazine.

Non-limiting examples of silver salts include silver sulfadiazine in an amount ranging from about 0.5 to about 1% w/w, silver nitrate in an amount ranging from about 0.2 to about 0.5% w/w, silver carbonate in an amount ranging from about 0.2 to about 0.5% w/w, and silver oxide in an amount ranging from about 0.2 to about 0.5% w/w. The preferred compound for use as the silver component is silver sulfadiazine (AgSD).

### 4.8 Zinc and Zinc Salts

Suitable zinc salts for use in these formulations include zinc acetate (molar solubility in water of 1.64 moles/l), zinc butyrate (molar solubility in water of 0.4 moles/l), zinc citrate (molar solubility in water of <0.1 moles/l), zinc gluconate (molar solubility in water of 0.28 moles/l), zinc glycerate (moderately water soluble), zinc glycolate (moderately water soluble), zinc formate (molar solubility in water of 0.33 moles/l), zinc lactate (molar solubility in water of 0.17 moles/l), zinc picolinate (moderately water soluble), zinc propionate (molar solubility in water of 1.51 moles/l), zinc salicylate (low water solubility), zinc tartrate (moderately water soluble) and zinc undecylenate (moderately water soluble).

Combinations of zinc salts may be used, as soluble and nonsoluble salts. Zinc salts are used in amounts ranging from about 0.2 to about 1% w/w.

### 4.9 Antimicrobials

Various embodiments of the invention may comprise one or more antimicrobial agent. Non-limiting examples of antimicrobial agents include, but are not limited to, chlorhexidine gluconate (CHG), benzalkonium chloride (BZK), or iodopropynylbutyl carbamate (IPBC; Germall plus). Further examples of antimicrobial agents include, but are not limited to, iodophors, iodine, benzoic acid, dihydroacetic acid, propionic acid, sorbic acid, methyl paraben, ethyl paraben, propyl paraben, butyl paraben, cetrimide, quaternary ammonium compounds, including but not limited to benzethonium chloride (BZT), dequalinium chloride, biguanides such as chlorhexidine (including free base and salts (see below)), PHMB (polyhexamethylene biguanide), ehloroeresol, chlorxylenol, benzyl alcohol, bronopol, chlorbutanol, ethanol, phenoxyethanol, phenylethyl alcohol, 2,4-dichlorobenzyl alcohol, thiomersal, clindamycin, erythromycin, benzoyl peroxide, mupirocin, bacitracin, polymyxin B, neomycin, triclosan, parachlorometaxylene, foscarnet, miconazole, fluconazole, itriconazole, ketoconazole, and pharmaceutically acceptable salts thereof. Additional antimicrobial agents may be used in the present compositions.

Pharmaceutically acceptable chlorhexidine salts that may be used as antimicrobial agents according to the invention include, but are not limited to, chlorhexidine palmitate, chlorhexidine diphosphanilate, chlorhexidine digluconate, chlorhexidine diacetate, chlorhexidine dihydrochloride, chlorhexidine dichloride, chlorhexidine dihydroiodide, chlorhexidine diperchlorate, chlorhexidine dinitrate, chlorhexidine sulfate, chlorhexidine sulfite, chlorhexidine thiosulfate, chlorhexidine di-acid phosphate, chlorhexidine difluorophosphate, chlorhexidine diformate, chlorhexidine dipropionate, chlorhexidine di-iodobutyrate, chlorhexidine di-n-valerate, chlorhexidine dicaproate, chlorhexidine malonate, chlorhexidine succinate, chlorhexidine malate, chlorhexidine tartrate, chlorhexidine dimonoglycolate, chlorhexidine monodiglycolate, chlorhexidine dilactate, chlorhexidine di-.alpha.-hydroxyisobutyrate, chlorhexidine diglucoheptonate, chlorhexidine di-isothionate, chlorhexidine dibenzoate, chlorhexidine dicinnamate, chlorhexidine dimandelate, chlorhexidine di-isophthalate, chlorhexidine di-2-hydroxynapthoate, and chlorhexidine embonate. Chlorhexidine free base is a further example of an antimicrobial agent. These and further examples of antimicrobial agents useful in this invention can be found in such references as Goodman and Gilman's The Pharmacological Basis of Therapeutics (Goodman Gilman A, Rall T W, Nies A S, Taylor P, ed. (Pergamon Press; Elmsford, N.Y.: 1990)), the contents of which are hereby incorporated by reference.

In preferred embodiments of the invention, the antimicrobials include biguanides (chlorhexidine or polyhexamethelene biguanide), phenoxyethanol, miconazole, polymixin, neomycin, bacitracin and povidone iodine. Such antimicrobials are used in amounts ranging from about 0.1 to about 2.0% w/w.

### 4.10 Synergistic Combinations of Benzyl Alcohol and Alkanediols

In non-limiting embodiments, bifunctional alcohols which may be used according to the present invention are alkanediols. Suitable alkanediols include, but are not limited to, 1,3 propanediol, dodecanediol, decanediol, nonanediol, octanediol, heptanediol, hexanediol and pentanediol. In particular non-limiting embodiments, the alkanediols have a carbon backbone of between 3 and 25 carbon atoms, including but not limited to 1,9 Nonanediol, 1,2-Decanediol, 1,10-Decanediol, 1,11-Undecanediol, 1,2-Dodecanediol, 1,12 Dodecanediol, Cyclododecanediol, 1,13-Tridecanediol, 1,2-Tetradecanediol, 1,14-Tetradecanediol, 1,15-Pentadecanediol, 1,16-Hexadecanediol, 1,17-Heptadecanediol, 1,18-Octadecanediol, 1,19-Nonadecanediol, 1,20-Eicosanediol, 1,21-Heneicosanediol, 1,22-Docosanediol, 1,23-Tricosanediol, 1,24-Tetracosanediol, 1,25-Pentacosanediol.

In a preferred non-limiting embodiment, the alkanediol is 1,3 propanediol (Zemea®), which is a natural product prepared from corn sugar. In another non-limiting embodiment, the alkanediols include 1,3 propanediol, octanediol and decanediol, and mixtures thereof. The alkanediols are present in amounts ranging from about 0.2 to about 1% w/w. In preferred embodiments the benzyl alcohol may be prepared from a natural source such as the Casia plant.

In various non-limiting embodiments, the compositions of the present invention may include a solvent including but not limited to water, alcohols, glycols, glycerol, glycerine, octoxyglycerine, diglycerol, propylene glycol, dipropylene glycol, and vegetable oils. Non-limiting examples of non-alkanediol alcohols for solubilisation are aliphatic alcohols having carbon atoms about 1 to 8 such as methanol, ethanol, n-propanol, isopropyl alcohol, 2-methyl-2 propanol, hexanol, or combinations thereof. Aromatic alcohols, for example, but not by way of limitation, phenoxyethanol, benzyl alcohol, 1-phenoxy-2-propanol, and/or phenethyl alcohol, may also optionally be used in combination with aliphatic alcohols. aromatic alcohols, for example, but not by way of limitation, include phenoxyethanol, benzyl alcohol, 1-phenoxy-2propanol, and/or phenethyl alcohol, for example at a concentration of between about 0.5 and 5 percent (weight/weight) may also optionally be used in combination with aliphatic alcohols. A further solvent which optionally may be comprised in a composition of the invention is iso propyl myristate. Additional aliphatic alcohols include ethanol, denatured alcohol (SDA 40B and SDA 3C) and isopropanol. A preferred non-limiting solvent is benzyl alcohol, which is used in amounts ranging from about 0.5 to about 5% w/w.

### 4.11 Personal Care Products

The compositions of the invention may be used as alternatives to conventional preservatives or may be combined with one or more antimicrobial agent to enhance their activity, particularly providing persistent antimicrobial protection without causing skin sensitivity.

In non-limiting embodiments, the present invention provides for personal care product compositions comprising low concentrations of one or more essential oil and/or one or more botanical extract, for example a plant or fruit extract, in combination with one or more solvent and one or more alkanediol. In preferred, non-limiting embodiments, the above-listed components produce a synergistic antimicrobial effect, and the low concentrations of the active agents are such that regular exposure of skin to the personal care product does not produce skin irritation in a normal subject. Preferably, the pH of personal care products is between about 3.0 and 6.0.

Non-limiting examples of personal care products which may utilize the invention include bar soap, liquid soap (e.g., hand soap), hand sanitizer (including rinse off and leave-on alcohol based and aqueous-based hand disinfectants), preoperative skin disinfectant, cleansing

wipes, disinfecting wipes, body wash, acne treatment products, antifungal diaper rash cream, antifungal skin cream, shampoo, conditioner, cosmetics (including but not limited to liquid or powder foundation, liquid or solid eyeliner, mascara, cream eye shadow, tinted powder, “pancake” type powder to be used dry or moistened, etc.) deodorant, antimicrobial creams, body lotion, hand cream, topical cream, aftershave lotion, skin toner, mouth wash, toothpaste, sunscreen lotion, and baby products such as, but not limited to, cleansing wipes, baby shampoo, baby soap, and diaper cream. The present invention may also be applied to wound care items, such as, but not limited to, wound healing ointments, creams, and lotions, wound coverings, burn wound cream, bandages, tape, and steri-strips, and medical articles such as medical gowns, caps, face masks, and shoe-covers, surgical drops, etc. Additional products include but are not limited to oral products such as mouth rinse, toothpaste, and dental floss coatings, veterinary and pet care products, preservative compositions, and surface disinfectants including solutions, sprays or wipes.

Personal care compositions according to the invention, in addition to botanical extract, solvent, and alkanediol, may further comprise one or (preferably) more than one component selected from the group consisting of emollients, stabilizing agents, thickening agents, humectants, anti-inflammatory agents, antimicrobial agents, neutralizing agents, surfactants, water, silicone polymers, alcohols, and hydrogels, as well as additional components as may be known in the art. Non-limiting examples of such components are set forth below.

In various non-limiting embodiments of the invention, a personal care product comprising a combination of one or more essential oil and/or IC together with one or more fruit acid may further comprise an emollient, for example PEG 20 almond glycerides, Probutyl DB-10, Glucam P-20, Glucam E-10, Glucam P-10, Glucam E-20, Glucam P-20 distearate, glycerin, propylene glycol, octoxyglycerin, cetyl acetate, acetylated lanolin alcohol (e.g., Acetulan), cetyl ether (e.g., PPG-10), myristyril ether (e.g., PPG-3), hydroxylated milk glycerides (e.g., Cremeral HMG), polyquaternium compounds (e.g., U-care compounds), copolymers of dimethyl dialyl ammonium chloride and acrylic acid (e.g., Merquat), dipropylene glycol methyl ethers (e.g., Dowanol DPM, Dow Corning), polypropylene glycol ethers (e.g., Ucon 50-HB-600, Union Carbide) and silicon polymers. Other suitable emollients may include hydrocarbon-based emollients such as petrolatum or mineral oil, fatty ester-based emollients, such as methyl, isopropyl and butyl esters of fatty acids such as isopropyl palmitate, isopropyl myristate, isopropyl isostearate, isostearyl isostearate, diisopropyl sebacate, and propylene dipelargonate, 2-ethylhexyl isononoate, 2-ethylhexyl stearate, C₁₂-C₁₆ fatty alcohol lactates such as cetyl lactate and lauryl lactate, isopropyl lanolate, 2-ethylhexyl salicylate, cetyl myristate, oleyl myristate, oleyl stearate, oleyl oleate, hexyl laurate, and isohexyl laurate. Additional useful emollients include lanolin, olive oil, cocoa butter, and shea butter.

In various non-limiting embodiments of the invention, a personal care product comprising a combination of one or more essential oil and/or IC together with one or more fruit acid may further comprise a stabilizing agent consisting of antioxidants, including but not limited to vitamin C (ascorbic acid) and vitamin E (tocopherol), and surfactants, including but not limited to incromide or silicone-based surfactants (Masil SF-19, BASF).

In various non-limiting embodiments of the invention, a personal care product comprising a combination of one or more essential oil and/or IC together with one or more fruit acid may further comprise a thickening and/or gelling agent such as stearyl alcohol, cationic hydroxy ethyl cellulose (Ucare; JR30), hydroxy propyl methyl cellulose, hydroxy propyl cellulose (Klucel), chitosan pyrrolidone carboxylate (Kytamer), behenyl alcohol, zinc stearate, emulsifying waxes, including but not limited to Incroquat and Polawax, an addition polymer of acrylic acid, a resin such as Carbopol® ETDT™ 2020, guar gum, acacia, acrylates/steareth-20 methacrylate copolymer, agar, algin, alginic acid, ammonium acrylate co-polymers, ammonium alginate, ammonium chloride, ammonium sulfate, amylopectin, attapulgite, bentonite, C9-15 alcohols, calcium acetate, calcium alginate, calcium carrageenan, calcium chloride, caprylic alcohol, carbomer 910, carbomer 934, carbomer 934P, carbomer 940, carbomer 941, carboxymethyl hydroxyethyl cellulose, carboxymethyl hydroxypropyl guar, carrageenan, cellulose, cellulose gum, cetearyl alcohol, cetyl alcohol, corn starch, damar, dextrin, dibenzlidine sorbitol, ethylene dihydrogenated tallowamide, ethylene diolamide, ethylene distearamide, gelatin, guar gum, guar hydroxypropyltrimonium chloride, hectorite, hyaluronic acid, hydrated silica, hydroxybutyl methylcellulose, hydroxyethylcellulose, hydroxyethyl ethylcellulose, hydroxyethyl stearamide-MIPA, isocetyl alcohol, isostearyl alcohol, karaya gum, kelp, lauryl alcohol, locust bean gum, magnesium aluminium silicate, magnesium silicate, magnesium trisilicate, methoxy PEG-22/dodecyl glycol copolymer, methylcellulose, microcrystalline cellulose, montmorillonite, myristyl alcohol, oat flour, oleyl alcohol, palm kernel alcohol, pectin, PEG-2M, PEG-5M, polyacrylic acid, polyvinyl alcohol, potassium alginate, potassium aluminium polyacrylate, potassium carrageenan, potassium chloride, potassium sulfate, potato starch, propylene glycol alginate, sodium acrylate/vinyl alcohol copolymer, sodium carboxymethyl dextran, sodium carrageenan, sodium cellulose sulfate, sodium chloride, sodium polymethacylate, sodium silicoaluminate, sodium sulfate, stearalkonium bentotnite, stearalkonium hectorite, stearyl alcohol, tallow alcohol, TEA-hydrochloride, tragacanth gum, tridecyl alcohol, tromethamine magnesium aluminium silicate, wheat flour, wheat starch, xanthan gum, abietyl alcohol, acrylinoleic acid, aluminum behenate, aluminum caprylate, aluminum dilinoleate, aluminum salts, such as distearate, and aluminum isostearates, beeswax, behenamide, butadiene/acrylonitrile copolymer, C29-70 acid, calcium behenate, calcium stearate, candelilla wax, carnauba, ceresin, cholesterol, cholesterol hydroxystearate, coconut alcohol, copal, diglyceryl stearate malate, dihydroabietyl alcohol, dimethyl lauramine oleate, dodecanoic acid/cetearyl alcohol/glycol copolymer, erucamide, ethylcellulose, glyceryl triacetyl hydroxystearate, glyceryl tri-acetyl ricinolate, glycol dibehenate, glycol di-octanoate, glycol distearate, hexanediol distearate, hydrogenated C6-14 olefin polymers, hydrogenated castor oil, hydrogenated cottonseed oil, hydrogenated lard, hydrogenated menhaden oil, hydrogenated palm kernel glycerides, hydrogenated palm kernel oil, hydrogenated palm oil, hydrogenated polyisobutene, hydrogenated soybean oil, hydrogenated tallow amide, hydrogenated tallow glyceride, hydrogenated vegetable glyceride, hydrogenated vegetable oil, Japan wax, jojoba wax, lanolin alcohol, shea butter, lauramide, methyl dehydroabietate, methyl hydrogenated rosinate, methyl rosinate, methylstyrene/vinyltoluene copolymer, microcrystalline wax, montan acid wax, montan wax, myristyleicosanol, myristyloctadecanol, octadecene/maleic anhyrdine copolymer, octyldodecyl stearoyl stearate, oleamide, oleostearine, ouricury wax, oxidized polyethylene, ozokerite, paraffin, pentaerythrityl hydrogenated rosinate, pentaerythrityl tetraoctanoate, pentaerythrityl rosinate, pentaerythrityl tetraabietate, pentaerythrityl tetrabehenate, pentaerythrityl tetraoleate, pentaerythrityl tetrastearate, ophthalmic anhydride/glycerin/glycidyl decanoate copolymer, ophthalmic/trimellitic/glycols copolymer, polybutene, polybutylene terephthalate, polydipentene, polyethylene, polyisobutene, polyisoprene, polyvinyl butyral, polyvinyl laurate, propylene glycol dicaprylate, propylene glycol dicocoate, propylene glycol diisononanoate, propylene glycol dilaurate, propylene glycol dipelargonate, propylene glycol distearate, propylene glycol diundecanoate, PVP/eiconsene copolymer, PVP/hexadecene copolymer, rice bran wax, stearlkonium bentonite, stearalkonium hectorite, stearamide, stearamide DEA-distearate, stearamide DIBA-stearate, stearamide MEA-stearate, stearone, stearyl erucamide, stearyl stearate, stearyl stearoyl stearate, synthetic beeswax, synthetic wax, trihydroxystearin, triisononanoin, triisostearin, tri-isostearyl trilinoleate, trilaurin, trilinoleic acid, trilinolein, trimyristin, triolein, tripalmitin, tristearin, zinc laurate, zinc myristate, zinc neodecanoate, zinc rosinate, and mixtures thereof. The gelling agents used in vehicles may be natural gelling agents such as natural gums, starches, pectins, agar and gelatin. Often, the gelling agents are based on polysaccharides or proteins Examples include but are not limited to guar gum, Xanthum gum, Alginic acid (E400), sodium alginate (E401), potassium alginate (E402), ammonium alginate (E403), calcium alginate (E404,—polysaccharides from brown algae), Agar (E406, a polysaccharide obtained from red seaweeds), Carrageenan (E407, a polysaccharide obtained from red seaweeds), Locust bean gum (E410, a natural gum from the seeds of the Carob tree), Pectin (E440, a polysaccharide obtained from apple or citrus-fruit), and Gelatin (E441, made by partial hydrolysis of animal collagen).

In various non-limiting embodiments of the invention, a personal care product comprising the combination of one or more botanical extract, solvent, and alkanediol, may further comprise a humectant, such as, for example, glycerin, 1-2-propylene glycol, dipropylene glycol, polyethylene glycol, 1,3-butylene glycol, or 1,2,6-hexanetriol.

In certain non-limiting embodiments of the invention, the antimicrobial effect of the inventive composition is achieved by a composition consisting of the combination of one or more botanical extract, solvent, and alkanediol, and optionally with a fruit acid or anti-inflammatory. In alternative embodiments of the invention, one or more additional antimicrobial agent may be comprised, for example, where such antimicrobial agent may be selected from the group consisting of silver salts, iodophors, iodine, benzoic acid, dihydroacetic acid, propionic acid, sorbic acid, methyl paraben, ethyl paraben, propyl paraben, butyl paraben, cetrimide, benzalkonium chloride, dequalinium chloride, chlorhexidine, chloroeresol, chlorxylenol, benzyl alcohol, bronopol, chlorbutanol, phenoxyethanol, phenylethyl alcohol, 2,4-dichlorobenzyl alcohol, thiomersal, clindamycin, erythromycin, benzoyl peroxide, mupirocin, bacitracin, polymyxin B, neomycin, triclosan, parachlorometaxylene, foscarnet, miconazole, fluconazole, itriconazole, ketoconazole, silver sulfadiazine, octoxyglycerine, biguanides such as, but not limited to, chlorhexidine free base, chlorhexidine palmitate, chlorhexidine diphosphanilate, chlorhexidine digluconate, chlorhexidine diacetate, chlorhexidine dihydrochloride, chlorhexidine dichloride, chlorhexidine dihydroiodide, chlorhexidine diperchlorate, chlorhexidine dinitrate, chlorhexidine sulfate, chlorhexidine sulfite, chlorhexidine thiosulfate, chlorhexidine di-acid phosphate, chlorhexidine difluorophosphate, chlorhexidine diformate, chlorhexidine dipropionate, chlorhexidine di-iodobutyrate, chlorhexidine di-n-valerate, chlorhexidine dicaproate, chlorhexidine malonate, chlorhexidine succinate, chlorhexidine malate, chlorhexidine tartrate, chlorhexidine dimonoglycolate, chlorhexidine monodiglycolate, chlorhexidine dilactate, chlorhexidine di-α-hydroxyisobutyrate, chlorhexidine diglucoheptonate, chlorhexidine di-isethionate, chlorhexidine dibenzoate, chlorhexidine dicinnamate, chlorhexidine dimandelate, chlorhexidine di-isophthalate, chlorhexidine di-2-hydroxynapthoate, chlorhexidine embonate, and parahexamethylenebiguanide (“PHMB”).

In various non-limiting embodiments of the invention, a personal care product comprising a combination of one or more essential oil and/or IC together with one or more fruit acid may further comprise a neutralizing agent to neutralize carboxyl groups present in one or more other component, such as carboxyl groups in a thickening agent. Suitable neutralizing agents include diisopropylamine and triethanolamine.

In various non-limiting embodiments of the invention, the compositions used in a personal care product may further comprise a surfactant. The surfactant may be an anionic surfactant, a cationic surfactant, an ampholytic surfactant, or a nonionic surfactant. Examples of nonionic surfactants include polyethoxylates, fatty alcohols (e.g., ceteth-20 (a cetyl ether of polyethylene oxide having an average of about 20 ethylene oxide units) and other “BRIJ”® nonionic surfactants available from ICI Americas, Inc. (Wilmington, Del.)), cocamidopropyl betaine, alkyl phenols, fatty acid esters of sorbitol, sorbitan, or polyoxyethylene sorbitan. Suitable anionic surfactants include ammonium lauryl sulfate and lauryl ether sulfosuccinate.

In various non-limiting embodiments of the invention, a personal care product may comprise water.

In various non-limiting embodiments of the invention, the compositions used in a personal care product may further comprise a hydrogel comprising, for example, a compound such as hydroxypropylmethyl cellulose, cationic hydroxyethyl cellulose (U-care polymers), ethyl cellulose, hydroxypropyl cellulose, hydroxymethyl cellulose, carboxy methyl cellulose, polyethylene oxide (polyox resins), and chitosan pyrrolidone carboxylate (Kytomer PC).

In various non-limiting embodiments of the invention, a personal care product may further comprise an alcohol or a mixture of alcohols, for example, ethanol, isopropyl alcohol, n-propyl alcohol, and mixtures thereof; fatty alcohols, including, but not limited to, cetyl alcohol, myristol alcohol, stearyl alcohol, octyl alcohol, decyl alcohol and lauryl alcohol, and mixtures thereof; and hexanol.

In various non-limiting embodiments of the invention, the compositions used in a personal care product may further comprise a silicone polymer, for example one or more than one polydimethylsiloxane polymer (Dow Corning 225 Silicone Fluid), dimethiconol fluid in dimethicone (Dow Corning 1403 Silicone Fluid), cyclomethicone and dimethicone copolyl (Dow Corning 3225C Silicone Fluid), and silicone glycol (BASF 1066 DCG polyol).

In various non-limiting embodiments of the invention, the compositions used in a personal care product comprising a combination of one or more essential oil and/or IC together with one or more fruit acid may further comprise an emollient solvent such as a glycidyl ether having an alkyl chain up to and including 18 carbon molecules and ethoxylates and propoxylates thereof, a glyceryl ether having an alkyl chain up to and including 18 carbon molecules and ethoxylates and propoxylates thereof, a mono- or diglyceryl ether having an alkyl chain up to and including 18 carbon molecules and ethoxylates and propoxylates thereof, ethoxylate and propoxylate ethers, ethoxy diglycol esters, ethyl hexyl alcohol propoxylate, and propylene glycol esther ethoxylates and propoxylates, and Arlamol (Alias).

In various non-limiting embodiments of the invention, the compositions used in a personal care product comprising a combination of one or more essential oil and/or IC together with one or more fruit acid may further comprise additives such as dyes, fragrances, pH adjusters, including basic pH adjusters such as ammonia, mono-, di- and tri-alkyl amines, mono-, di- and tri-alkanolamines, alkali metal and alkaline earth metal hydroxides (e.g., ammonia, sodium hydroxide, potassium hydroxide, lithium hydroxide, monoethanolamine, triethylamine, isopropylamine, diethanolamine and triethanolamine); acid pH adjusters such as mineral acids and polycarboxylic acids (e.g., hydrochloric acid, nitric acid, phosphoric acid, sulfuric acid, citric acid, glycolic acid, and lactic acid); vitamins such as vitamin A, vitamin E and vitamin C; polyamino acids and salts, such as ethylenediamine tetraacidic acid (EDTA), preservatives such as Germall plus and DMDM hydantoin, and sunscreens such as aminobenzoic acid, arobenzone, cinoxate, diioxybenzone, homosalate, menthyl anthranilate, octocrylene, octyl methoxycinnamate, octyl salicylate, oxybenzoate, padimate O, phenylbenzimidazole, sulfonic acid, sulisobenzone, titanium dioxide, trolamine salicylate and zinc oxide.

In one set of non-limiting embodiments, the present invention provides for personal care compositions that are antimicrobial and anti-inflammatory (AM-AI) compositions for use in skin cleansers and topical creams. The following Table provides a general formula for the AM-AI compositions for skin cleanser.

TABLE 5

| Ingredients | % in cleansers (w/w) |
|---|---|
| GSE | 0.1-0.5 |
| Citric acid | 0-1.0 |
| 1,3 propanediol | 0.5-5.0 |
| Benzyl alcohol | 0.25-5.0 |
| Lemongrass oil | 0-0.5 |
| Cinnamon oil | 0-0.5 |
| Orange oil | 0-0.2 |
| TetraHydrocurcuminoids | 0-0.2 |
| Alkanediols (Pentanediol, | 0-1.0 |
| Octanediol, Decanediol) | |
| Ethanol | 0-10 |

Specific examples of AM-AI skin cleanser formulations are as follows.

TABLE 6

| Ingredients | | | | |
|---|---|---|---|---|
| (% w/w) | AM-AI - 7 | AM-AI - 16 | AM-AI - 17 | AM-AI - 18 |
| GSE | 0.2 | 0.2 | 0.5 | 0.5 |
| Lemongrass oil | 0.3 | 0.3 | 0.3 | 0.3 |
| Orange oil | 0.1 | 0.1 | 0.1 | 0.1 |
| Benzyl alcohol | 0.5 | 1.0 | 0.5 | 1.0 |
| Zemea ® | 1.0 | 1.0 | 1.0 | 1.0 |
| Citric acid | 1.0 | 1.0 | 1.0 | 1.0 |
| THC | 0 | 0.15 | 0 | 0.15 |
| Ethanol (SDA-3C) | 4.9 | 4.25 | 4.6 | 3.95 |

The present invention also provides for rapidly acting AMI hand disinfectant lotions. The synergistic combination of GSE, Benzyl alcohol and 1,3 propanediol when used along with the anti inflammatory agent CRMN, edible plant extract (Kefiprotect®) and Pomegranate seed oil (PSO) exhibits additional synergistic activity. The following Tables includes formulations for cleanser compositions.

TABLE 7

| Soap | Ingredient | % w/w |
|---|---|---|
| Soap - L+ | LG | 0.3 |
| | BA | 0.5 |
| | Zemea ® | 0.5 |
| | SDA 3C | 4.7 |
| | Citric acid | 0.5 |
| | Plain soap | 93.5 |
| Soap - B+ | BO | 0.3 |
| | BA | 0.5 |
| | Zemea ® | 0.5 |
| | SDA 3C | 4.7 |
| | Citric acid | 0.5 |
| | Plain Soap | 93.5 |
| Soap - C+ | BO | 0.3 |
| | BA | 0.5 |
| | Zemea ® | 0.5 |
| | SDA 3C | 4.7 |
| | Citric acid | 0.5 |
| | Plain Soap | 93.5 |
| Soap - KP+ | KP | 0.3 |
| | BA | 0.5 |
| | Zemea ® | 0.5 |
| | SDA 3C | 4.7 |
| | Citric acid | 0.5 |
| | Plain soap | 93.5 |
| Soap - PO+ | PSO | 0.3 |
| | BA | 0.5 |
| | Zemea ® | 0.5 |
| | SDA 3C | 4.7 |
| | Citric acid | 0.5 |
| | Plain soap | 93.5 |

TABLE 7A

| | | |
|---|---|---|
| Soap - LP | LG | 0.3 |
| | Orange oil | 0.1 |
| | BA | 0.5 |
| | Zemea ™ | 0.5 |
| | SDA 3C | 4.1 |
| | Phospholipid PTM | 0.5 |
| | Incroquat | 0.5 |
| | Plain soap | 93.5 |
| Soap - GP | Grapeseed oil | 0.2 |
| | BA | 0.5 |
| | Zemea ™ | 0.5 |
| | SDA 3C | 4.3 |
| | Phospholipid PTM | 0.5 |
| | Incroquat | 0.5 |
| | Plain Soap | 93.5 |
| Soap - LGP | LG | 0.30 |
| | Grape seed oil | 0.15 |
| | Orange oil | 0.1 |
| | BA | 0.5 |
| | Zemea ™ | 0.5 |
| | SDA 3C | 3.95 |
| | Phospholipid PTM | 0.5 |
| | Incroquat | 0.5 |
| | Plain soap | 93.5 |

The present invention also contemplates rapidly acting botanical AM-AI hand disinfectant lotions. The following Tables provide general and specific formulations.

TABLE 8

| Ingredients | % (w/w) |
|---|---|
| GSE | 0.2-1.0 |
| Benzyl alcohol | 0.5-2.0 |
| Zemea ® | 0.5-5.0 |
| THC | 0.02-0.2 |
| SDA 40-B Natural alcohol | 5-15 |
| Incroquat Behenyl TMS | 0-2.0 |
| Hydroxypropyl | 0.-0.5 |
| Methylcellulose (Methocel) | |
| Polyqyaternium 10 | 0.05-0.5 |
| Arlasilk phospholipid PTM | 0.5-2.0 |
| (coconut derived) | |
| Water | 30-70 |
| pH | 3.0-6.0 |

TABLE 9

| | % (w/w) | % (w/w) | % (w/w) | % (w/w) | % (w/w) | % (w/w) | % (w/w) |
|---|---|---|---|---|---|---|---|
| Ingredients | HS-1 | HS-2 | HS-3 | HS-4 | HS-5 | HS-6 | HS-7 |
| GSE | 0.5 | 0.5 | 0.5 | 0.5 | 0.5 | 0.5 | 0.2 |
| BA | 1.0 | 1.0 | 0.5 | 0.5 | 0.5 | 0.5 | 0.5 |
| Zemea ® | 1.0 | 1.0 | 0.5 | 0.5 | 0.5 | 0.5 | 0.5 |
| THC | 0.15 | 0.15 | 0.05 | 0.05 | 0.05 | 0.05 | 0.05 |
| Citric acid | 1.0 | 1.0 | — | — | — | — | — |
| LG | 0.1 | — | — | — | — | — | — |
| PO | — | 0.05 | — | — | — | — | — |
| Octoxyglycerin | — | 1.0 | — | — | — | — | — |
| SDA 40-B | 10 | 9.0 | 10 | 10 | 10 | 10 | 10 |
| Natural alcohol | | | | | | | |
| Incroquat Behenyl | 1.0 | 1.0 | 1.0 | 1.0 | — | — | — |
| TMS | | | | | | | |
| Polyquaternium 10 | 0.15 | 0.15 | 0.15 | 0.15 | 0.15 | 0.15 | 0.15 |
| Symrise PCL liquid | 1.0 | 1.0 | — | — | — | — | — |
| 100 | | | | | | | |
| Arlasilk | 0.5 | 0.5 | 1.0 | 0.5 | 1.0 | 0.5 | 1.0 |
| phospholipid PTM | | | | | | | |
| Hydroxypropyl | — | — | — | — | 0.15 | 0.15 | 0.15 |
| methylcellulose | | | | | | | |
| (Methocel) | | | | | | | |
| Water | 83.6 | 83.65 | 86.3 | 86.8 | 87.15 | 87.65 | 87.45 |

TABLE 9A

| | % (w/w) | % (w/w) | % (w/w) |
|---|---|---|---|
| Ingredients | HS-8 | HS-9 | HS-10 |
| GSE | 0.5 | 0.5 | 0.5 |
| BA | 0.5 | 0.5 | 0.5 |
| Zemea ™ | 0.5 | 0.5 | 0.5 |
| THC | 0.05 | 0.05 | 0.05 |
| SDA 40-B | 10.325 | 11.95 | 11.95 |
| Natural alcohol | | | |
| Incroquat Behenyl | 0.5 | 1.0 | — |
| TMS | | | |
| U-care Jr | 0.075 | 0.15 | 0.15 |
| Arlasilk phospholipid | — | 0.5 | 0.5 |
| PTM | | | |
| Hydroxypropyl | — | — | 0.15 |
| methylcellulose | | | |
| (Methocel) | | | |
| Water | 87.55 | 84.85 | 85.7 |

In specific, non-limiting embodiments, the present invention provides for the preparation of topical cream formulations containing anti-irritant, anti-inflammatory agents, gelling agents, and botanicals for minor cuts and wounds. General and specific formulations for AM-AI compositions for topical creams follow below.

TABLE 10

| General formula | % in cream (w/w) |
|---|---|
| GSE | 0.1-0.5 |
| Lactic acid | 0-0.5 |
| 1,3 propanediol (Zemea ®) | 0.5-10.0 |
| Benzyl alcohol | 0.5-5.0 |
| Lemongrass oil | 0-0.5 |
| TetraHydrocurcuminoids | 0-0.2 |

Antifungal activity of antifungal agents can be significantly enhanced by the use of synergistic combination of alcohols such as benzyl alcohol, fruit acids, and optionally biguanide and benzalkonium chloride.

TABLE 11

| | Ingredients | % (w/w) |
|---|---|---|
| AM-AI antifungal cream 1 | White Petrolatum | 4.0 |
| | Stearyl Alcohol | 5.6 |
| | Polyquaternium 10 | 0.24 |
| | Inroquat Behenyl TMS | 2.4 |
| | Polowax N F | 2.4 |
| | Isopropyl Myristate | 3.2 |
| | Sorbitan Oleate | 1.6 |
| | Polyoxyl 40 Stearate | 1.6 |
| | Propylene Glycol | 1.6 |
| | Benzyl alcohol | 1.0 |
| | Grape seed extract | 0.2 |
| | Tetrahydrocucuminoid | 0.15 |
| | Zemea ® | 1.0 |
| | Phospholipid PTM | 0.5 |
| | Water | 74.51 |
| AM-AI antifungal cream 2 | White Petrolatum | 4.0 |
| | Stearyl Alcohol | 5.6 |
| | Polyquaternium 10 | 0.24 |
| | Inroquat Behenyl TMS | 2.4 |
| | Polowax N F | 2.4 |
| | Isopropyl Myristate | 3.2 |
| | Sorbitan Oleate | 1.6 |
| | Polyoxyl 40 Stearate | 1.6 |
| | Propylene Glycol | 1.6 |
| | Benzyl alcohol | 1.0 |
| | Grape seed extract | 0.2 |
| | Tetrahydrocucuminoid | 0.1 |
| | Kefiprotect ® | 0.1 |
| | Zemea ® | 1.0 |
| | Lactic acid | 0.5 |
| | Water | 74.46 |
| AM-AI antifungal cream 3 | White Petrolatum | 4.0 |
| | Stearyl Alcohol | 5.6 |
| | Polyquaternium 10 | 0.24 |
| | Inroquat Behenyl TMS | 2.4 |
| | Polowax N F | 2.4 |
| | Isopropyl Myristate | 3.2 |
| | Sorbitan Oleate | 1.6 |
| | Polyoxyl 40 Stearate | 1.6 |
| | Propylene Glycol | 1.6 |
| | Benzyl alcohol | 1.0 |
| | Grape seed extract | 0.2 |
| | Tetrahydrocucuminoid | 0.15 |
| | Lemongrass oil | 0.5 |
| | Zemea ® | 1.0 |
| | Lactic acid | 0.5 |
| | Octanediol | 1.0 |
| | Water | 73.01 |
| AM-AI antifungal cream 4 | White Petrolatum | 4.0 |
| | Stearyl Alcohol | 5.6 |
| | Polyquaternium 10 | 0.24 |
| | Inroquat Behenyl TMS | 2.4 |
| | Polowax N F | 2.4 |
| | Isopropyl Myristate | 3.2 |
| | Sorbitan Oleate | 1.6 |
| | Polyoxyl 40 Stearate | 1.6 |
| | Propylene Glycol | 1.6 |
| | Benzyl alcohol | 1.0 |
| | Grape seed extract | 0.2 |
| | Tetrahydrocucuminoid | 0.15 |
| | Lemongrass oil | 0.5 |
| | Zemea ® | 1.0 |
| | Octoxyglyerin | 1.0 |
| | Lactic acid | 0.5 |
| | Water | 73.01 |

The following Table provides a formulation for alcohol-based hand sanitizer compositions.

TABLE 12

| Ingredients | % in cleansers (w/w) |
|---|---|
| GSE | 0.1-0.5 |
| Lactic acid | 0-0.5 |
| 1,3 propanediol (Zemea ®) | 0.5-5.0 |
| Benzyl alcohol | 0.5-5.0 |
| Lemongrass oil | 0-0.3 |
| Octoxyglycerin | 0-3.0 |
| Ethyl alcohol | 40-70 |
| Water | 10-30 |
| TetraHydrocurcuminoids | 0-0.1 |
| Pomegranate oil | 0-0.1 |

The present invention also provides formulations containing GSE, benzyl alcohol, Zemea®, THC, and a coconut based phospholipid for alcohol-based hand sanitizer (AHS) compositions.

TABLE 13

| Ingredients | % (w/w) |
|---|---|
| GSE | 0.2-1.0 |
| Lactic acid | 0.2-2.0 |
| 1,3 propanediol (Zemea ®) | 0.5-5.0 |
| Benzyl alcohol | 0.5-2.0 |
| Water | 30-70 |
| TetraHydrocurcuminoids | 0.02-0.2 |
| SDA 40-B natural alcohol | 60-80 |
| Incroquat Behenyl TMS | 0-0.3 |
| Polyquaternium 10 | 0.05-0.3 |
| Arlasilk phopholipid PTM (coconut derived) | 0.5-2.0 |
| SymsitiveTM 1609 (Symrise) | 0-1.0 |
| pH | adjusted to 3.0-6.0 |

The following specific formulations were prepared.

TABLE 14

| | % (w/w) | % (w/w) | % (w/w) | % (w/w) |
|---|---|---|---|---|
| Ingredients | AHS-1 | AHS-2 | AHS-3 | AHS-4 |
| GSE | 0.2 | 0.2 | 0.2 | 0.2 |
| Benzyl alcohol | 0.5 | 0.5 | 0.5 | 0.5 |
| Zemea ® | 0.5 | 0.5 | 0.5 | 0.5 |
| Ethyl alcohol | 67.2 | 67.2 | 67.2 | 67.2 |
| THC | 0.05 | 0.05 | 0.05 | 0.05 |
| Incroquat Behenyl TMS | — | — | 1.0 | 1.0 |
| Polyquaternium 10 | 0.1 | 0.1 | 0.1 | 0.1 |
| SymsitiveTM 1609 | — | 0.5 | — | 0.5 |
| (Symrise) | | | | |
| Arlasilk phospholipid PTM | 1.0 | 1.0 | 1.0 | 1.0 |
| Hydroxypropyl | 0.05 | 0.05 | — | — |
| methylcellulose (Methocel) | | | | |
| Water | 30.4 | 29.9 | 29.45 | 28.95 |

The following formulations are for an topical cream products.

TABLE 15A
AM-AI topical cream acne treatment

| Ingredients | % in cleansers (w/w) |
|---|---|
| GSE | 0.1-0.5 |
| Salicylic acid | 0.5-3.0 |
| Lactic acid | 0-0.2 |
| 1,3 propanediol (Zemea ®) | 0.5-5.0 |
| Benzyl alcohol | 0.5-5.0 |
| Cinnamon oil | 0.1-0.3 |
| Octoxyglycerin | 0-3.0 |
| TetraHydrocurcuminoids | 0.04-0.2 |

TABLE 15B

| Topical cream ingredients | % (w/w) |
|---|---|
| Petrolatum | 9.68 |
| Stearyl alcohol | 14.52 |
| Isopropyl myristate | 4.84 |
| Sorbitan oleate | 2.42 |
| Polyoxy 40 stearate (Myrj 52) | 6.05 |
| Germal + | 0.3 |
| Propylene glycol | 4.0 |
| Zinc lactate | 0.2 |
| Zinc oxide | 0.3 |
| Calendula oil | 1.0 |
| Silver sulfadiazine | 1.0 |
| Benzyl alcohol | 0.5 |
| THC | 0.075 |
| 1,3 propanediol | 0.5 |
| Lactic acid | 0.06 |
| Water | 54.56 |

Provided below in Table 16A is a general formulation for aqueous hand disinfectants containing benzyl alcohol, 1,3 propanediol, fruit acid, and botanicals.

TABLE 16A

| Ingredients | % (w/w) |
|---|---|
| Botanical extract | 0.-4.0 |
| Benzyl alcohol | 0.5-4.0 |
| Aliphatic alcohol (C1-4) | 0-10.0 |
| Fruit acid (Lactic/citric acid) | 0.2-4.0 |
| Alkylglycoside | 0-2.0 |
| Polyquartenium 10 | 0-0.2 |
| Hydroxyl propyl methyl cellulose | 0.0-0.3 |
| Water | 50.0-90.0 |
| Glycerine | 0-5.0 |
| Benzoic acid | 0-1.0 |
| Bisbolol + Ginger extract | 0-0.1 |

Tables 16B and 16C provide additional general formulations for aqueous leave on hand disinfectants.

TABLE 16B
ALHD1

| Ingredients | % w/w (Range) |
|---|---|
| Chlorhexidine gluconate | 0.10-0.20 |
| Polyhexamethylene Biguanide | 0.00-0.30 |
| Benzethonium chloride | 0.10-0.30 |
| Triclosan | 0.00-1.00 |
| Incroquat Compounds | 0.10-1.00 |
| Diglycerol | 0.00 -5.00 |
| Dipropylene glycol | 0.50-5.00 |
| Nonionic Pluronic surfac tant | 0.10-2.00 |
| SDA 40B alcohol | 0.00-20.00 |
| Water | 80.00-90.00 |
| Octanediol | 0.30-1.00 |
| Salicylic acid | 0.00 |
| Salts of salicylic acid | 0.00 |
| Essential oils | 0.00 |
| Botanicals | 0.00 |
| Benzyl alcohol | 0.00 |
| Polyquaternium 10 | 0.10-0.20 |
| Polawax | 0.00-1.00 |
| Cyclohexyl pentanol | 0.00-1.00 |
| Lactic acid | 0.00-0.30 |
| Phenoxyethanol | 0.00-1.00 |
| (pH-3-5) | |

TABLE 16C
ALHD2

| Ingredients | % w/w (Range) |
|---|---|
| Polyhexamethylene | 0.00-0.30 |
| Biguanide | |
| Benzethonium chloride | 0.10-0.30 |
| Incroquat compounds | 0.10-1.00 |
| Diglycerol | 0.5-5.00 |
| Dipropylene glycol | 0.-5.00 |
| Nonionic surfactant | 0.10-2.00 |
| SDA 40B alcohol | 0.00-20.00 |
| Water | 80.00-90.00 |
| Alkanediol | 0.30-3.00 |
| Benzyl alcohol | 2-5.00 |
| Polyquaternium 10 | 0.10-0.30 |
| Polawax | 0.00-1.0 |
| Fruit acids | 0.00-2.0 |
| Benzoic acid and salt | 0.1-0.5 |
| Phenoxyethanol | 0.00-1.00 |
| Zinc gluconate | 0-0.2 |
| Zinc lactate | 0-0.2 |
| Symrelief (Symrise) | 0-0.1 |
| Aloe Juice | 0-1.0 |
| (pH-3-5) | |

Tables 17A and 17B below provide exemplary, nonlimiting, formulations for aqueous hand disinfectants.

TABLE 17A

| Ingredients | #18 | #19 | #20 | #21 | #29 |
|---|---|---|---|---|---|
| Pomegranate | 2.0 | 1.0 | 0 | 0 | 0 |
| seed oil | | | | | |
| Kefiprotect* | 0 | 0 | 2.0 | 1.0 | 4.0 |
| Benzyl alcohol | 1.0 | 2.0 | 1.0 | 2.0 | 1.0 |
| 1,3 Propanediol | 2.0 | 2.0 | 2.0 | 2.0 | 2.0 |
| Citric acid | 0.2 | 0.2 | 0.2 | 0.2 | 0.2 |
| Glucopon | 1.0 | 1.0 | 1.0 | 1.0 | 1.0 |
| 215UP | | | | | |
| SDA 3C | 8.8 | 8.8 | 8.8 | 8.8 | 7.0 |
| Base 26** | 85.0 | 85.0 | 85.0 | 85.0 | 85.0 |

*Mixture of fermented oregano and thyme plant extracts
**Base 26 contains 0.2% hydroxymethylpropyl cellulose and 0.2% polyquatemium10

TABLE 17B

| | % w/w | |
|---|---|---|
| Ingredients | #33 | #33A |
| Benzethonium chloride | 0.20 | 0.20 |
| Incroquat CTC 30 | 0.20 | 0.20 |
| Diglycerol | 5.00 | 5.00 |
| 1,3 Propanediol (Zemea) | 3.0 | 3.0 |
| Glucopon 215U | 0.20 | 0.20 |
| Pentanediol | 1.0 | 1.0 |
| Octanediol | 0.5 | 0.5 |
| Water | 79.25 | 79.25 |
| Benzoic acid | 0.1 | 0.1 |
| Sodium Benzoate | 0.1 | 0.1 |
| Benzyl alcohol | 2.0 | 2.0 |
| SDA 40 B alcohol | 7.0 | 7.0 |
| Zinc gluconate | 0.10 | 0.1 |
| Zinc lactate | 0.10 | 0.1 |
| Polyquatemium-10 | 0.3 | 0.3 |
| Hydroxypropul methyl | 0.20 | 0.2 |
| cellulose | | |
| Lactic acid | 0.20 | 0.05 |
| Symrelief | 0.05 | 0.5 |
| Aloe barbadensis juice | — | 0.5 |

Additional nonlimiting formulations for aqueous hand disinfectants containing benzyl alcohol, 1,3 propanediol, and botanicals are provided below.

TABLE 18

| Ingredients | #22 | #23 | 18LA | 18LAK | 18LAK5 |
|---|---|---|---|---|---|
| Pomegranate | 0.2 | 0 | 0 | 0 | 0 |
| seed extract | | | | | |
| Ursole | 0 | 0.2 | 0 | 0 | 0 |
| (rosemary | | | | | |
| extract) | | | | | |
| Kefiprotect | 0 | 0 | 0 | 0.024 | 1.0 |
| Grapefruit | 0 | 0 | 2.0 | 2.0 | 2.0 |
| seed extract | | | | | |
| Benzyl | 2.0 | 2.0 | 0.6 | 0.6 | 0.6 |
| alcohol | | | | | |
| 1,3 | 2.0 | 2.0 | 0.6 | 0.6 | 0.6 |
| Propanediol | | | | | |
| Citric acid | 0 | 0.2 | 0.2 | 0 | 0 |
| Lactic acid | 0 | 0 | 0.2 | 0.2 | 0.2 |
| Glucopon | 1.0 | 1.0 | 0 | 0 | 1.0 |
| 215UP | | | | | |
| SDA 40B | 7.0 | 7.0 | 9.0 | 9.0 | 8.0 |
| Water | 2.6 | 2.6 | 2.6 | 2.6 | 1.6 |
| Base 26** | 85.2 | 85.0 | 84.8 | 84.976 | 85.0 |

** Base 26 contains 0.2% hydroxymethylpropyl cellulose and 0.2% polyquaternium10

A general formulation for a stock solution of aqueous hand disinfectant containing higher concentrations of benzyl alcohol is provided below. The stock solution is used in various personal care products in amounts ranging from 2.0-20% (w/w).

TABLE 19

| Ingredients | % (w/w) Range |
|---|---|
| Botanical extract | 10.0-20.0 |
| Fruit acid | 0.5-4.0 |
| Benzyl alcohol | 5.0-10.0 |
| Propanediol | 5.0-10.0 |

The Table below provides nonlimiting examples of formulations of aqueous hand disinfectant containing higher concentrations of benzyl alcohol.

TABLE 20

| Ingredients | 18LA1 | 18LA2 | 37 | 37A |
|---|---|---|---|---|
| Grapefruit seed | 2.0 | 2.0 | 0 | 2.0 |
| exrtract | | | | |
| Benzyl alcohol | 1.0 | 0.6 | 2.0 | 2.0 |
| 1,3 Propanediol | 1.0 | 0.6 | 3.0 | 3.0 |
| Lactic acid | 0.2 | 0.2 | 2.0 | 2.0 |
| Glucopon 215UP | 1.0 | 1.0 | 1.0 | 1.0 |
| SDA 3C | 8.0 | 8.0 | 7.0 | 7.0 |
| Water | 1.8 | 2.55 | 0 | 0 |
| Symrelief | 0 | 0.05 | 0 | 0.05 |
| Base 26 | 85.0 | 85.0 | 85.0 | 82.95 |

Table 21 shows additional nonlimiting formulations of aqueous hand disinfectants containing higher concentrations of benzyl alcohol.

TABLE 21

| Ingredients | 18LA 4 | 18LA5 | 37B | 18LA4-S | 18LA6 | 18LA7 |
|---|---|---|---|---|---|---|
| Grapefruit | 1.0 | 1.0 | 0.0 | 1.0 | 2.0 | 0.0 |
| seed exrtract | | | | | | |
| Benzyl alcohol | 2.0 | 2.0 | 2.0 | 2.0 | 2.0 | 2.0 |
| Kefiprotect | 0 | 0 | 0 | 0 | 0 | 2.0 |
| 1,3 Propanediol | 3.0 | 3.0 | 3.0 | 3.0 | 3.0 | 3.0 |
| Lactic acid | 2.0 | 2.0 | 2.0 | 2.0 | 2.0 | 2.0 |
| Glucopon | 1.0 | 1.0 | 1.0 | 1.0 | 1.0 | 1.0 |
| 215UP | | | | | | |
| SDA 3C | 6.0 | 0 | 0 | 6.0 | 10.0 | 10.0 |
| Water | 0 | 6.0 | 7.0 | 0 | 0 | 0 |
| Base 26 | 85.0 | 85.0 | 85.0 | 84.95 | 80.0 | 80.0 |
| Symrelief | 0 | 0 | 0 | 0.05 | 0 | 0 |

A general formula for rapidly acting aqueous hand disinfectant containing synergistic combinations of benzyl alcohol, fruit acid, with or without benzalkonium chloride is provided below.

TABLE 22

| Ingredients | % Range |
|---|---|
| Benzyl alcohol | 1.0-5.0 |
| 1,3 Propanediol | 1.0-5.0 |
| Fruit acid | 0.2-2.0 |
| Benzalkonium chloride | 0.0-0.12 |
| Alcohol | 0.0-10.0 |
| Polyquartenium 10 | 0.0-0.2 |
| Hydroxypropyl methyl | 0.0-0.3 |
| cellulose | |
| Glycerine | 0.0-0.5 |
| Symrelief (Bisbolol + | 0.0-0.1 |
| Ginger extract) | |
| Water | 50.0-90.0 |

Nonlimiting exemplary formulations for compositions of aqueous hand disinfectants are provided below.

TABLE 23

| | % (w/w) | | | | |
|---|---|---|---|---|---|
| Ingredients | 28 | A | D | 28B | 28C |
| Benzalkonium | 0.1 | 0.1 | 0.1 | 0.1 | 0.1 |
| chloride | | | | | |
| Benzyl alcohol | 3.0 | 3.0 | 0 | 3.0 | 3.0 |
| 1,3 propanediol | 3.0 | 0 | 0 | 4.0 | 4.0 |
| Citric acid | 0.2 | 0.2 | 0 | 0 | 0 |
| Lactic acid | 0 | 0 | 0 | 0.2 | 0.2 |
| SDA 3C | 7.0 | 7.0 | 7.0 | 7.0 | 7.0 |
| Base 26 | 84.9 | 85.0 | 85.0 | 85.0 | 85.0 |
| Water | 1.8 | 4.7 | 7.9 | 0.7 | 0.65 |
| Symreleif | 0 | 0 | 0 | 0 | 0.05 |

The following Tables 24A, 24B, and 24C summarize a general formulation for the compositions of hand disinfectant soaps.

TABLE 24A
Wash off hand cleansing soap 1

| Ingredients | % w/w grams |
|---|---|
| Chlorhexidine gluconate | 0.10-1.00 |
| Polyhexamethylene Biguanide | 0.00-0.30 |
| Benzethonium chloride | 0.10-0.30 |
| Benzalkonium chloride | 0.00-0.10 |
| Triclosan | 0.00-1.00 |
| Incroquat Compounds | 0.10-1.00 |
| Diglycerol | 0.50-5.00 |
| Dipropylene glycol | 0.00-5.00 |
| Nonionic Pluronic surfactant | 0.50-2.00 |
| SDA 40B alcohol | 10.00-20.00 |
| Water | 40.00-60.00 |
| Octanediol | 0.00-1.00 |
| Salicylic acid | 0.00 |
| Salts of salicylic acid | 0.00 |
| Essential oils | 0.00 |
| Botanicals | 0.00 |
| Fruit acids | 0.00-0.00 |
| Benzyl alcohol | 0.00-3.00 |
| Arlasilk PTM | 0.00-2.00 |
| Phenoxyethanol | 0.00-1.00 |
| Polyquaternium10 | 0.10-0.50 |
| Germal ⁺ | 0.10-0.30 |
| Incromine oxid L | 5.00-15.00 |
| (pH 3-5) | |

TABLE 24B
Wash off hand cleansing soap 2

| Ingredients | % w/w (Range) |
|---|---|
| Polyhexamethylene Biguanide | 0.00-0.30 |
| Benzethonium chloride | 0.10-0.30 |
| Benzalkonium chloride | 0.00-0.10 |
| Triclosan | 0.00-1.0 |
| Incroquat compounds | 0.1-0.50 |
| Diglycerol | 0.50-5.00 |
| Dipropylene glycol | 0.00-5.00 |
| Nonionic Pluronic surfactant | 0.50-2.00 |
| SDA 40B alcohol | 10.00-20.00 |
| Water | 40.00-60.00 |
| Alkanediol | 0-1.00 |
| Salicylic acid | 0.00 |
| Salts of salicylic acid | 0.00 |
| Essential oils | 0.00 |
| Botanicals | 0.00 |
| Benzyl alcohol | 2.0-5.0 |
| Fruit acids | 0-2.0 |
| Arlasilk PTM | 0.00-2.00 |
| Phenoxyethanol | 0.00-1.00 |
| Polyquaternium10 | 0.10-0.50 |
| Germal ⁺ | 0.10-0.30 |
| Incromine oxide L | 5.00-15.00 |
| Zinc gluconate | 0-0.2 |
| Zinc lactate | 0-0.2 |
| (pH 3-5) | |

TABLE 24C

| Ingredients | % Range |
|---|---|
| Benzyl alcohol | 1.0-3.0 |
| 1,3 Propanediol | 1.0-5.0 |
| Fruitacid | 0.2-2.0 |
| Triclosan | 0.0-0.5 |
| Biguanide | 0.0-0.5 |
| Benzalkonium chloride | 0.1-0.12 |
| Benzethonium chloride | 0.0-0.18 |
| Phenoxyethanol | 0.0-1.0 |
| IncromineoxideL | 5.0-15.0 |
| Montaline C 40 | 5.0-10.0 |
| Crosultane C 50 | 3.0-5.0 |
| Nonionic surfactant | 0.5-5.0 |
| Dipropylene glycol | 0.0-5.0 |
| Diglycerol | 0.0-5.0 |
| Glycerine | 0.0-5.0 |
| Water | 40.0-80.0 |

Table 25 provides certain nonlimiting exemplary formulations of hand disinfectant soaps.

TABLE 25

| | %(w/w) | | | | | |
|---|---|---|---|---|---|---|
| | 14 | | | 15 | 16 | 14 |
| Ingredients | (BPC) | 14Tc | 14BZT | (Tc) | (Citric) | (BZK) |
| Citric acid | 1.0 | 1.0 | 1.0 | 1.0 | 1.0 | 1.0 |
| Benzyl alcohol | 2.0 | 2.0 | 2.0 | 2.0 | 0 | 2.0 |
| Propane diol | 1.0 | 1.0 | 1.0 | 1.0 | 0 | 1.0 |
| Phenoxy ethanol | 1.0 | 1.0 | 1.0 | 1.0 | 0 | 1.0 |
| SDA 40 B | 10 | 10 | 10 | 10 | 10 | 10 |
| Triclosan | 0 | 0.15 | 0 | 0.15 | 0 | 0 |
| Benzethonium | 0 | 0 | 0.18 | 0 | 0 | 0 |
| chloride | | | | | | |
| Benzalkonium | 0 | 0 | 0 | 0 | 0 | 0.1 |
| chloride | | | | | | |
| Water | 58 | 57.85 | 57.82 | 57.85 | 62 | 57.9 |
| Incromine oxide | 13 | 13 | 13 | 13 | 13 | 13 |
| Montalene | 5 | 5 | 5 | 5 | 5 | 5 |
| Dipropylene | 5 | 5 | 5 | 5 | 5 | 5 |
| glycol | | | | | | |
| Crosultane C-50 | 3 | 3 | 3 | 3 | 3 | 3 |
| Pluronic F 87 NF | 1 | 1 | 1 | 1 | 1 | 1 |

In certain embodiments of the invention, the general formula for alcohol-based hand disinfectants is as follows.

TABLE 26

| Ingredients | % w/w |
|---|---|
| Benzyl alcohol | 1-5 |
| 1,3 propanediol (Zemea) | 1-5 |
| Lactic acid | 0.2-4 |
| Benzoic acid | 0-2 |
| Grape fruit seed extract | 0.2-2 |
| Chlorhexidine gluconate | 0-0.2 |
| Polyhexamethyl biguanide | 0-0.3 |
| (PHMB) | |
| Octanediol | 0-1.0 |
| Aliphatic Alcohol | 60-70 |
| Water | 20-30 |
| Polyquartenium 10 | 0.1-0.3 |
| Hydroxypropyl methy | 0.1-0.3 |
| cellulose | |
| Symrelief | 0-0.1 |
| Aloe barbadensis juice | 0-1.0 |

Table 27 provides for specific nonlimiting examples of compositions of alcohol-based hand disinfectants.

TABLE 27

| | % (w/w) | | | | | | |
|---|---|---|---|---|---|---|---|
| | | | | | | ABHS - | ABHS- |
| Ingredients | A-4 | B-4 | C-4 | D-4 | E-4 | 5 | 6 |
| Benzyl alcohol | 1 | 1 | 1 | 1 | 1 | 1 | 1 |
| Zemea | 1 | 1 | 1 | 1 | 1 | 3 | 3 |
| Lactic acid | 2.0 | 0.2 | 0.2 | 0.2 | 0 | 0 | 0 |
| Grape fruit | 0.2 | 0.2 | 0 | 0 | 0 | 0 | 0 |
| seed extract | | | | | | | |
| Chlorhexidine | 0 | 0 | 0.2 | 0 | 0 | 0 | 0 |
| gluconate | | | | | | | |
| Polyhexamethyl | 0 | 0 | 0 | 0 | 0 | 0.3 | 0.3 |
| biguanide | | | | | | | |
| (PHMB) | | | | | | | |
| Octanediol | 0 | 0 | 0 | 0.5 | 0.5 | 0 | 0 |
| Lactic acid | 0 | 0 | 0 | 0 | 0.2 | 0.2 | 2.0 |
| SDA 3C alcohol | 67.2 | 67.2 | 67.2 | 67.2 | 67.2 | 67.2 | 67.2 |
| Water | 28.2 | 30 | 30 | 29.7 | 29.7 | 27.9 | 26.05 |
| Polyquartenium | 0.2 | 0.2 | 0.2 | 0.2 | 0.2 | 0.2 | 0.2 |
| 10 | | | | | | | |
| Hydroxypropyl | 0.2 | 0.2 | 0.2 | 0.2 | 0.2 | 0.2 | 0.2 |
| methy cellulose | | | | | | | |
| Symrelief | 0 | 0 | 0 | 0 | 0 | 0 | 0.05 |

Table 28 provides a general formula for the compositions containing benzyl alcohol, propanediol, and lactic acid.

TABLE 28

| Ingredients | % w/w |
|---|---|
| Aliphatic alcohol (C1-6) | 60-70 |
| Hydroxy propyl cellulose | 0.5-1.0 |
| Incroquat Behenyl TMS 50 | 0.2-1.0 |
| Benzyl alcohol | 1.0-5.0 |
| 1,3 Propanediol | 1.0-5.0 |
| Glycerine | 1.0-5.0 |
| Water | 5.0-20.0 |
| Lactic acid | 0.2-2.0 |
| Benzoic acid | 0-1.0 |
| Incromine oxide L | 3.0-10 |
| Pluronic F87 NF | 0.5-2.0 |
| Cocoamidopropyl betaine | 5.0-10.0 |
| Masil SF 19 | 0.5-2.0 |
| Aloe barbadensis Juice | 0.5-20 |
| Symrelief | 0-0.1 |

Table 29 provides nonlimiting formulations for the alcohol-based, wash-off, hand disinfectants.

TABLE 29

| Ingredients | 2A | 2B | 2C | 2D |
|---|---|---|---|---|
| SDA 40 B | 64.84 | 64.84 | 64.84 | 64.84 |
| Klucel | 0.5 | 0.5 | 0.5 | 0.5 |
| Benzyl alcohol | 2.0 | 2.0 | 2.0 | 2.0 |
| 1,3 Propanediol | 2.0 | 3.0 | 2.0 | 5.0 |
| Phenoxyethanol | 1.0 | 1.0 | 1.0 | 1.0 |
| Glycerine | 1.0 | 1.0 | 3.0 | 3.0 |
| Water | 10.66 | 9.66 | 6.56 | 3.56 |
| Citric acid | 1.0 | 1.0 | 1.0 | 1.0 |
| Incromine oxide | 8.0 | 8.0 | 8.0 | 8.0 |
| L | | | | |
| Pluronic F87 NF | 1.0 | 1.0 | 1.0 | 1.0 |
| Cocamidopropyl | 8.0 | 8.0 | 8.0 | 8.0 |
| betaine | | | | |
| Masil SF 19 | — | — | 1.0 | 1.0 |
| Aloe | — | — | 1.0 | 1.0 |
| barbadensis | | | | |
| juice | | | | |
| Symrelief | — | — | 0.1 | 0.1 |

The following Tables 30A and 30B provides nonlimiting examples of alcohol-based compositions for wash-off hand disinfectant, and wash off hand cleansing specific soaps (3E and 3G).

TABLE 30A

| Ingredients | 3C | 3D | 4C | 4D | 5C | 5D |
|---|---|---|---|---|---|---|
| SDA 40 B | 64.84 | 64.84 | 64.84 | 64.84 | 64.84 | 64.84 |
| Klucel | 1.0 | 1.0 | 0.5 | 0.5 | — | — |
| K₄M | — | — | 0.3 | 0.3 | 0.3 | 0.3 |
| Polyquartenium10 | — | — | — | — | 0.2 | 0.2 |
| Benzyl alcohol | 2.0 | 2.0 | 2.0 | 2.0 | 2.0 | 2.0 |
| 1,3 Propanediol | 2.0 | 5.0 | 2.0 | 5.0 | 2.0 | 5.0 |
| Phenoxyethanol | 1.0 | 1.0 | 1.0 | 1.0 | 1.0 | 1.0 |
| Glycerine | 3.0 | 3.0 | 3.0 | 3.0 | 3.0 | 3.0 |
| Water | 6.06 | 3.06 | 6.26 | 3.26 | 6.56 | 3.56 |
| Citric acid | 1.0 | 1.0 | 1.0 | 1.0 | 1.0 | 1.0 |
| Incromine oxide L | 8.0 | 8.0 | 8.0 | 8.0 | 8.0 | 8.0 |
| Pluronic F87 NF | 1.0 | 1.0 | 1.0 | 1.0 | 1.0 | 1.0 |
| Cocamidopropyl | 8.0 | 8.0 | 8.0 | 8.0 | 8.0 | 8.0 |
| Beataine | | | | | | |
| Masil SF 19 | 1.0 | 1.0 | 1.0 | 1.0 | 1.0 | 1.0 |
| Aloe barbadensis | 1.0 | 1.0 | 1.0 | 1.0 | 1.0 | 1.0 |
| Juice | | | | | | |
| Symrelief | 0.1 | 0.1 | 0.1 | 0.1 | 0.1 | 0.1 |

TABLE 30B
Wash Off Hand Cleansing
Specific Soaps

| | % w/w | |
|---|---|---|
| Ingredients | 3E | 3G |
| PHMB | 0.30 | 0.30 |
| Benzethonium chloride | 0.16 | 0.20 |
| Benzalkonium chloride | 0.07 | 0.00 |
| Triclosan | 0.15 | 0.00 |
| Incroquat behenyl TMS | 0.30 | 0.30 |
| Diglycerol | 3.00 | 3.00 |
| Pluronic F87 Prill | 1.00 | 1.00 |
| SDA 40 B alcohol | 12.00 | 12.00 |
| Water | 68.12 | 67.92 |
| Octanediol | 0.50 | 1.00 |
| Polyquaternium 10 | 0.20 | 0.20 |
| Germal⁺ | 0.20 | 0.20 |
| Incromone oxide L | 8.00 | 8.00 |
| Montalene C-40 | 5.00 | 5.00 |
| Arlasilk phospholipid | 1.00 | 0.00 |
| PTM | | |
| Phenoxy ethanol | 0.00 | 1.00 |
| Benzyl alcohol | 0.00 | 2.00 |
| Lactic acid | 0.00 | 0.20 |
| Zinc gluconate | 0.00 | 0.20 |
| Zinc lactate | 0.00 | 0.10 |

Table 31 provides a composition of an alcohol based broad spectrum rapidly acting wash off hand disinfectant (ABHS 5-E).

TABLE 31

| ABHS 5-E Ingredients | % w/w |
|---|---|
| SDA 40 B | 64.84 |
| Hydroxy propyl cellulose | 1.0 |
| Incroquat Behenyl TMS 50 | 0.5 |
| Benzyl alcohol | 2.0 |
| 1,3 Propanediol | 5.0 |
| Glycerine | 3.0 |
| Water | 6.56 |
| Lactic acid | 1.0 |
| Incromine oxide L | 5.0 |
| Pluronic F87 NF | 1.0 |
| Cocoamidopropyl betaine | 8.0 |
| Masil SF 19 | 1.0 |
| Aloe barbadensis Juice | 1.0 |
| Symrelief | 0.1 |

Table 32 provides a formulation for antifungal skin cream 27.

TABLE 32

| | |
|---|---|
| 1. Water | 65.02 |
| 2. Zinc gluconate | 0.10 |
| 3. Polyquartenium 10 | 0.24 |
| 4. Incroquat Behenyl TMS | 3.2 |
| 5. Polawax | 3.2 |
| 6. Petroleum Jelly | 4.7 |
| 7. Stearyl alcohol | 7.4 |
| 8. Myrj 52 | 2.8 |
| 9. Zinc Oxide | 0.20 |
| 10. Propylene Glycol | 2.0 |
| 11. Isopropyl Myristate | 3.30 |
| 12. Sorbitan Oleate | 1.50 |
| 13. Miconazole | 2.0 |
| 14. Dipropyleneglycol | 2.0 |
| 15. Benzyl alcohol | 0.8 |
| 16. 1,3 Propanediol (Zemea) | 0.5 |
| 17. Tetrahydrocurcuminoid | 0.05 |
| 18. Octanediol | 0.5 |
| 19. Lactic acid (88% active ) | 0.2 |
| 20. Benzalkonium chloride (Powder) | 0.09 |
| 21. Chlorhexidine gluconate | 0.2 |

In certain embodiments of the invention, the compositions are used in antifungal diaper rash creams. The following Table provides nonlimiting examples of such formulations.

TABLE 33

| Ingredients | 28S | 29S | 30 | 31A | 31B | 32 | 33A | 33B |
|---|---|---|---|---|---|---|---|---|
| Water | 49.21 | 43.21 | 41.85 | 36.15 | 36.25 | 41.8 | | |
| Zinc gluconate | 0.10 | 0.1 | 0.1 | 0.2 | 0.2 | 0.2 | 0.4 | 0.4 |
| Polyquartenium 10 | 0.24 | 0.24 | — | — | — | — | — | — |
| Incroquat Behenyl TMS | 3.2 | 3.2 | 3.6 | — | — | — | — | — |
| Polawax | 3.2 | 3.2 | — | — | — | — | — | — |
| Mineral oil | — | — | 2.0 | — | — | — | — | — |
| White petrolatum | — | — | — | 11.0 | 11.0 | 10.0 | 47.05 | 46.95 |
| Petroleum Jelly | 4.7 | 5.6 | 5.6 | — | — | — | — | — |
| Stearyl alcohol | 7.4 | 8.9 | 8.9 | 16.0 | 16.0 | 9.0 | 16.0 | 16.0 |
| Myrj 52 [Polyoxyl40] | 2.8 | 3.4 | 3.4 | 6.7 | 6.7 | 6.5 | 6.7 | 6.7 |
| Zinc Oxide | 3.0 | 5.0 | 10.0 | 10.0 | 10.0 | 5.0 | 10.0 | 10.0 |
| Propylene Glycol | 2.0 | 2.0 | 2.0 | — | — | — | — | — |
| Isopropyl Myristate | 3.30 | 4.0 | — | 6.0 | 6.0 | 6.0 | 6.0 | 6.0 |
| Sorbitan Oleate | 1.50 | 1.8 | — | 2.7 | 2.7 | 2.7 | 2.7 | 2.7 |
| Cetearyl alcohol | — | — | 4.4 | — | — | — | — | — |
| Popyleneglycol | — | — | 5.0 | — | — | — | — | — |
| Zinc stearate | 2.0 | 2.0 | 2.0 | 4.0 | 4.0 | 4.0 | 4.0 | 4.0 |
| Miconazole | 2.0 | 2.0 | 2.0 | 2.0 | 2.0 | 2.0 | 2.0 | 2.0 |
| Dipropyleneglycol | 2.0 | 2.0 | 2.0 | | | | | |
| Benzyl alcohol | 0.8 | 0.8 | 0.8 | 1.0 | 1.0 | 0.8 | 1.0 | 1.0 |
| 1,3 Propanediol (Zemea) | 0.5 | 0.5 | 0.5 | 3.0 | 3.0 | 0.5 | 3.0 | 3.0 |
| Tetrahydrocurcuminoid | 0.05 | 0.05 | 0.05 | 0.05 | 0.05 | 0.05 | 0.05 | 0.05 |
| Octanediol | 0.5 | 0.5 | 0.5 | — | — | — | — | — |
| Lactic acid (88% active) | 0.2 | 0.2 | 0.2 | 1.0 | 1.0 | 0.2 | 1.0 | 1.0 |
| Benzalkonium chloride | 0.1 | 0.1 | 0.1 | — | 0.1 | 0.1 | 0.1 | — |
| (Powder) | | | | | | | | |
| Chlorhexidine gluconate | 0.2 | 0.2x | 0.2 | 0.2 | — | — | — | 0.2 |
| Calendula oil | 1.0 | 1.0 | 1.0 | — | — | 1.0 | — | — |
| Silicone D C 1403 | 5.0 | 5.0 | — | — | — | 5.0 | — | — |
| Silicone D C 3225 C | 5.0 | 5.0 | — | — | — | 5.0 | — | — |
| Butyleneglycol | — | — | 2.0 | — | — | — | — | — |
| Sorbitan Oleate | — | — | 1.8 | — | — | — | — | — |

The compositions of the present invention may also be used in anti-bacterial first aid cream. The following table provides a nonlimiting examples of a formulation used in first aid creams.

TABLE 34

| Ingredients | % (w/w) |
|---|---|
| Water | 65.51 |
| Zinc gluconate | 0.20 |
| Polyquartenium 10 | 0.24 |
| Incroquat Behenyl TMS | 3.2 |
| Polawax | 3.2 |
| Petroleum Jelly | 4.7 |
| Stearyl alcohol | 7.4 |
| Myrj 52 | 2.8 |
| Zinc Oxide | 0.50 |
| Propylene Glycol | 2.0 |
| Isopropyl Myristate | 3.30 |
| Sorbitan Oleate | 1.50 |
| Dipropyleneglycol | 2.0 |
| Benzyl alcohol | 0.8 |
| 1,3 Propanediol (Zemea) | 0.5 |
| Tetrahydrocurcuminoid | 0.05 |
| Octanediol | 0.5 |
| Lactic acid (88% active) | 0.2 |
| Calendula oil | 1.0 |
| Benzalkonium chloride (Powder) | 0.1 |
| PHMB | 0.3 |

The compositions of the present invention may also be used in topical wound healing creams. The following Table provides nonlimiting examples of such formulations.

TABLE 35

| | % w/w | | | |
|---|---|---|---|---|
| Ingredients | A | A3 | A4 | AS |
| Water | 72.84 | 67.84 | 67.84 | 67.84 |
| Polyquartemium 10 | 0.24 | 0.24 | 0.24 | 0.24 |
| Incroquat Behenyl TMS | 2.40 | 2.40 | 2.40 | 2.40 |
| Polawax | 2.40 | 2.40 | 2.40 | 2.40 |
| Petroleum Jelly | 4.00 | 4.00 | 4.00 | 4.00 |
| Stearyl alcohol | 5.61 | 5.61 | 5.61 | 5.61 |
| Propylene glycol | 1.60 | 1.60 | 1.60 | 1.60 |
| Isopropyl myristate | 3.21 | 3.21 | 3.21 | 3.21 |
| Sorbitan Oleate | 1.60 | 1.60 | 1.60 | 1.60 |
| Myrj 52 | 1.60 | 1.60 | 1.60 | 1.60 |
| Pomegranate seed oil | 0.2 | 0.2 | 0.2 | 0.2 |
| Lactic acid | 0.2 | 0.2 | 0.2 | 0.2 |
| Benzyl alcohol | 2.0 | 2.0 | 2.0 | 2.0 |
| 1,3 Propanediol | 2.0 | 2.0 | 2.0 | 2.0 |
| Tetrahydrocurcuminoid | 0.1 | 0.1 | 0.1 | 0.1 |
| Mineral oil | — | 1.0 | 1.0 | 1.0 |
| Fermented soy protein | — | — | 2.0 | — |
| Resveratrol | — | 2.0 | 2.0 | 2.0 |
| Glycerine | — | 2.0 | — | 1.0 |
| Aloe barbadensis Juice | — | — | — | 1.0 |

Table 36 provides a nonlimiting examples of formulations for various compositions of oral care products.

TABLE 36

| | % (w/w) | | | | | | | | |
|---|---|---|---|---|---|---|---|---|---|
| Ingredients | OCP1 | OCP2 | OCP3 | OCP4 | OCP5 | OCP6 | OCP7 | OCP8 | OCP9 |
| Water | 70.46 | 70.46 | 66.528 | 66.338 | 66.238 | 66.078 | 66.235 | 76.737 | 76.587 |
| Polyquaternium10 | 0.175 | 0.175 | 0 | 0 | 0 | 0 | — | — | — |
| Hydroxypropul | 0.175 | 0.175 | 0 | 0 | 0 | 0 | — | — | — |
| cellulose | | | | | | | | | |
| Glycerin | 10 | 10 | 10 | 10 | 10 | 10 | 10 | 10 | 10 |
| Sodium saccharin | 0.08 | 0.08 | 0.08 | 0.08 | 0.08 | 0.08 | 0.08 | 0.08 | 0.08 |
| Pluronic F127 | 0.3 | 0.3 | 0.3 | 0.3 | 0.3 | 0.3 | 0.3 | 0.3 | 0.3 |
| Sorbic acid | 0.1 | 0.1 | 0 | 0 | 0 | 0 | — | — | — |
| Potassium sorbate | 0.1 | 0.1 | 0 | 0 | 0 | 0 | — | — | — |
| Spearmint oil | 0.01 | 0.01 | 0 | 0 | 0 | 0 | — | — | — |
| Zinc salicylate | 0.05 | 0.05 | 0 | 0.05 | 0.05 | 0.05 | 0.05 | 0.05 | 0.05 |
| Copper salicylate | — | — | — | — | — | — | 0.025 | 0.025 | 0.025 |
| Thymol | 0.05 | 0.05 | 0.05 | 0.05 | 0.05 | 0.05 | 0.064 | 0.064 | 0.064 |
| Menthol | 0 | 0 | 0.04 | 0.04 | 0.04 | 0.04 | 0.04 | 0.04 | 0.04 |
| Eucalyptol | 0 | 0 | 0.092 | 0.092 | 0.092 | 0.092 | 0.092 | 0.092 | 0.092 |
| Methyl salicylate | 0 | 0 | 0.06 | 0 | 0.06 | 0.06 | 0.06 | 0.06 | 0.06 |
| Benzyl alcohol | 0.6 | 0.6 | 1.0 | 1.0 | 1.0 | 1.0 | 1.0 | 1.0 | 1.0 |
| Grapefruit | 2.0 | 2.0 | 0 | 0 | 0 | 0 | — | — | — |
| seed extract | | | | | | | | | |
| 1,3 propranediol | 0.6 | 0.6 | 0 | 0 | 0 | 0 | — | — | — |
| Lactic acid | 0.2 | 0.2 | 0 | 0.2 | 0.2 | 0.2 | 0.2 | 0.2 | 0.2 |
| Sorbital solution | 0 | 0 | 0.1 | 0.1 | 0.1 | 0.1 | 0.1 | 0.1 | 0.1 |
| Benzoic acid | 0 | 0 | 0.1 | 0.1 | 0.1 | 0.1 | 0.1 | 0.1 | 0.1 |
| Sodium benzoate | 0 | 0 | 0.05 | 0.05 | 0.05 | 0.05 | 0.05 | 0.05 | 0.05 |
| Ethanol | 15 | 15 | 21.6 | 21.6 | 21.6 | 21.6 | 21.6 | 11.104 | 11.104 |
| Benzalkonium | 0.1 | 0 | 0 | 0 | 0 | 0 | — | — | — |
| chloride | | | | | | | | | |
| Chlorhexidine | 0 | 0.1 | 0 | 0 | 0 | 0 | — | — | — |
| gluconate | | | | | | | | | |
| Silver nitrate | 0 | 0 | 0 | 0 | 0.02 | 0 | — | — | — |
| Hydrogen peroxide | 0 | 0 | 0 | 0 | 0.02 | 0 | — | — | — |
| Sodium perborate | 0 | 0 | 0 | 0 | 0 | 0.2 | — | — | — |
| Chlorphyllin | — | — | — | — | — | — | 0.004 | 0 | |
| Coloring agent | — | — | — | — | — | — | 0 | 0.002 | 0.002 |
| Citrus extract | — | — | — | — | — | — | — | 0.5 | 0.5 |
| Triclosan | — | — | — | — | — | — | — | — | 0.15 |

Table 37 provides a general formulation of compositions for stock solutions to be used in cream products.

TABLE 37

| | Composition in Stock | Use level in cream (1-1.5%) |
|---|---|---|
| | Range | Range |
| Benzyl alcohol | 40-85 | 0.4-1.3 |
| Lactic acid | 10-20 | 0.1-0.3 |
| 1,3 Propanediol | 15-40 | 0.15-0.6 |
| Tetrhydrocurcuminoid | 3-10 | 0.03-0.15 |

Table 38 provides the formulations for various preservative compositions (PC) of the present invention.

TABLE 38

| | PC8 | | PC14 | | PC18 | | PC19 | | PC20 | |
|---|---|---|---|---|---|---|---|---|---|---|
| | | Cream | | Cream | | Cream | | Cream | | Cream |
| Ingredients | Stock | (1.1% stock) | Stock | (1.3% stock) | Stock | (1.2% stock) | Stock | (1.5% stock) | Stock | (1.5% stock) |
| Benzyl alcohol | 72.7 | 0.8 | 61.5 | 0.8 | 83.4 | 1.0 | 66.7 | 1.0 | 66.7 | 1.0 |
| 1,3 Propanediol | 22.7 | 0.25 | 19.2 | 0.25 | — | — | 16.6 | 0.25 | 20.0 | 0.3 |
| Tetrhydro- | 4.6 | 0.05 | 3.9 | 0.05 | — | — | 3.40 | 0.05 | — | — |
| curcuminoid | | | | | | | | | | |
| Lactic acid | — | — | 15.4 | 0.2 | 36.6 | 0.2 | 13.3 | 0.2 | 13.3 | 0.2 |

The compositions of the invention may also be used for preoperative skin disinfectant compositions. These compositions contain synergistic combinations of benzyl alcohol, fruit acid, and antimicrobials such as chlorhexidine glluconate (CHG) or povidone iodine (PVI). The following Table provides nonlimiting examples of such compositions.

TABLE 39

| | Pre-Op | Pre-Op | Pre-Op | Pre-Op |
|---|---|---|---|---|
| | Disinfectant- | Disinfectant- | Disinfectant- | Disinfectant- |
| | CHG | CHG-Gel | PVI | PVI-Gel |
| Ingredient | % w/w | % w/w | % w/w | % w/w |
| Benzyl alcohol | 3 | 3 | 3 | 3 |
| Lactic acid | 2 | 2 | 2 | 2 |
| SDA 3C alcohol | 67.2 | 67.2 | — | — |
| CHG | 2 | 2 | — | — |
| Polyquaternium | — | 0.2 | — | 0.2 |
| 10 | | | | |
| Hydroxypropyl | — | 0.2 | — | 0.2 |
| methyl cellulose | | | | |
| (K4M) | | | | |
| 1,3 propanediol | — | — | 2 | 2 |
| Glycerine | — | — | 4 | 4 |
| PVI | — | — | 7.5 | 7.5 |
| Water | 25.8 | 25.4 | 81.5 | 81.1 |

The following Table provides nonlimiting examples of concentrations of preservative compositions in stock solutions and their use in cream products.

TABLE 40
Preservative Composition 21A

| | Composition of | Cream containing |
|---|---|---|
| Ingredients | stock solution | 1.0% stock |
| Benzyl alcohol | 80 | 0.8 |
| Citrus extract | 20 | 0.2 |

TABLE 41
Preservative Composition 21B

| | Composition of | Cream containing |
|---|---|---|
| Ingredients | stock solution | 1.2% stock |
| Benzyl alcohol | 66.7 | 0.8 |
| Citrus extract | 16.7 | 0.2 |
| Grapefruit seed extract | 16.7 | 0.2 |

The present invention also provides for nutraceutical and food antibacterial (NFA) compositions. The following table provides the a nonlimitig example of an NFA preservative composition. The use level is in 50-200 fold dilution of stock in water.

TABLE 42

| | Composition of stock | Concetration |
|---|---|---|
| Ingredients | solution level | range in use |
| Benzyl alcohol | 80 | 0.4-1.6 |
| Citrus extract | 10.0 | 0.05-0.2 |
| Grapefruit seed extract | 10.0 | 0.05-0.2 |

Additionally, the present invention contemplates cosmaceutical preservative compositions containing benzyl alcohol and citrus extract. The following Table provides a nonlimiting Example of such a composition.

TABLE 43A

| | | Amount in cream |
|---|---|---|
| Ingredients | Stock (%) | containing 1.3% stock |
| Benzyl alcohol | 61.54 | 0.8 |
| Citrus extract (BS440D) | 15.38 | 0.2 |
| Tetrahydrocurcuminoid | 3.85 | 0.05 |
| (THC) | | |
| 1,3-propanediol | 19.23 | 0.25 |

Use level is 1.0-2.0%

TABLE 43B

| Ingredients | Composition in Stock (%) | Use level |
|---|---|---|
| Benzyl alcohol | 30-90 | 0.3-5.0 |
| Fruit Acid | 5-70 | 0.1-4.0 |
| 1,3-propanediol | 0-50 | 0-5.0 |
| Botanical Extract | 0-20 | 0-30 |
| Solvents | 5-90 | 0.2-12 |

Use level is 1.0-10.0%

Additional neutraceutical preservative (NP) and food disinfectant cleanser (FDC) compositions are provided below. Specifically, these formulations contain benzyl alcohol and citrus extract.

TABLE 44A

| NP-A | Stock (%) |
|---|---|
| Benzyl alcohol | 80 |
| Citirus extract | 20 |
| NP-B | Stock (%) |
| Benzyl alcohol | 80 |
| Citrus extract | 10 |
| Grapefruit seed extract | 10 |

Use Level is 1-2%

TABLE 44B

| FDC | % w/w |
|---|---|
| Benzyl alcohol | 0.5-5.0 |
| Citric acid | 0.2-2.0 |
| Citrus extract | 0.2-1.0 |
| Grapefruit seed extract | 0-1.0 |
| Natural surfactant | 0.2-5.0 |
| Water | 90-98 |
| pH 3-4 | |
| Use undiluted | |

TABLE 44C

| FDC-1 | % w/w |
|---|---|
| Benzyl alcohol | 2.0 |
| Citric acid | 1.0 |
| Citrus extract | 0.2 |
| Glucopon 215 UP | 2.0 |
| Water | 94.8 |
| pH 3.5 | |
| Use undiluted | |

The present invention also provides for oral care compositions. The following Table provides a nonlimiting example of an oral care composition.

TABLE 45

| Ingredients | OCP8 % (w/w) |
|---|---|
| Water | 76.739 |
| Glycerin | 10.0 |
| Sodium saccharin | 0.08 |
| Pluronic F127 | 0.3 |
| Zinc salicylate | 0.05 |
| Copper salicylate | 0.025 |
| Thymol | 0.064 |
| Menthol | 0.04 |
| Eucalyptol | 0.092 |
| Methyl salicylate | 0.06 |
| Benzyl alcohol | 1.0 |
| Lactic acid | 0.2 |
| Sorbitol solution | 0.1 |
| Benzoic acid | 0.1 |
| Sodium benzoate | 0.05 |
| Ethanol | 10.6 |
| Citrus extract [C-320C] | 0.5 |

The present invention also provides for aqueous hand sanitizers containing benzyl alcohol and botanicals. The following table provides three nonlimiting examples of formulations.

TABLE 46

| Phase A | 18LA8 | 37D | 32 |
|---|---|---|---|
| Grapefruit seed | 1.0 | 0 | 0 |
| extract | | | |
| Citrus extract | 0 | 0.5 | 0 |
| (Biosecure F440D) | | | |
| Benzethonium | 0 | 0 | 0.2 |
| chloride | | | |
| Benzyl alcohol | 2 | 2 | 2 |
| 1,3 Propanediol | 3 | 3 | 3 |
| Lactic acid | 2.0 | 2.0 | 0 |
| Citric acid | 0 | 0 | 2.0 |
| Glucopon 215UP | 1 | 1 | 1 |
| SDA 3C | 10 | 10 | 0 |
| SDA 40B | 0 | 0 | 10 |
| Phase B | | | |
| Water | 80.1 | 80.6 | 80.8 |
| HPMC (K4M) | 0.2 | 0.2 | 0.2 |
| Polyquaternium10 | 0.2 | 0.2 | 0.2 |
| 1,3 Propanediol | 0.5 | 0.5 | 0.5 |
| Zinc lactate | 0 | 0 | 0.1 |
| pH 3.3-3.6 | | | |

### 4.12 Wound Healing

The compositions of the present invention may be used to treat wound healing or surface infections. In various non-limiting embodiments, the present invention may be utilized in products such as topical creams and lotions, wound care products, burn wound cream, decubitous ulcer cream (with anti-inflammatory botanicals and the use of silver sulfadiazene as an anti-microbial agent), and therapeutic ointments. The present invention may also be applied to wound care items, such as, but not limited to, wound healing ointments, wound coverings, burn wound cream, bandages, tape, and steri-strips, and medical articles such as medical gowns, caps, face masks, and shoe-covers, surgical drops, etc.

In various non-limiting embodiments of the invention, the products may further comprise a thickening and/or gelling agent such as stearyl alcohol, cationic hydroxy ethyl cellulose (Ucare; JR30), hydroxy propyl methyl cellulose, hydroxy propyl cellulose (Klucel), chitosan pyrrolidone carboxylate (Kytamer), behenyl alcohol, zinc stearate, emulsifying waxes, including but not limited to Ineroquat and Polawax, an addition polymer of acrylic acid, a resin such as Carbopol® ETD™ 2020, guar gum, acacia, acrylates/steareth-20 methacrylate copolymer, agar, algin, alginic acid, ammonium acrylate co-polymers, ammonium alginate, ammonium chloride, ammonium sulfate, amylopectin, attapulgite, bentonite, C9-15 alcohols, calcium acetate, calcium alginate, calcium carrageenan, calcium chloride, caprylic alcohol, carbomer 910, carbomer 934, carbomer 934P, carbomer 940, carbomer 941, carboxymethyl hydroxyethyl cellulose, carboxymethyl hydroxypropyl guar, carrageenan, cellulose, cellulose gum, cetearyl alcohol, cetyl alcohol, corn starch, damar, dextrin, dibenzlidine sorbitol, ethylene dihydrogenated tallowamide, ethylene diolamide, ethylene distearamide, gelatin, guar gum, guar hydroxypropyltrimonium chloride, hectorite, hyaluronic acid, hydrated silica, hydroxybutyl methylcellulose, hydroxyethylcellulose, hydroxyethyl ethylcellulose, hydroxyethyl stearamide-MIPA, isocetyl alcohol, isostearyl alcohol, karaya gum, kelp, lauryl alcohol, locust bean gum, magnesium aluminium silicate, magnesium silicate, magnesium trisilicate, methoxy PEG-22/dodecyl glycol copolymer, methylcellulose, microcrystalline cellulose, montmorillonite, myristyl alcohol, oat flour, oleyl alcohol, palm kernel alcohol, pectin, PEG-2M, PEG-5M, polyacrylic acid, polyvinyl alcohol, potassium alginate, potassium aluminium polyacrylate, potassium carrageenan, potassium chloride, potassium sulfate, potato starch, propylene glycol alginate, sodium acrylate/vinyl alcohol copolymer, sodium carboxymethyl dextran, sodium carrageenan, sodium cellulose sulfate, sodium chloride, sodium polymethacylate, sodium silicoaluminate, sodium sulfate, stearalkonium bentotnite, stearalkonium hectorite, stearyl alcohol, tallow alcohol, TEA-hydrochloride, tragacanth gum, tridecyl alcohol, tromethamine magnesium aluminium silicate, wheat flour, wheat starch, xanthan gum, abietyl alcohol, acrylinoleic acid, aluminum behenate, aluminum caprylate, aluminum dilinoleate, aluminum salts, such as distearate, and aluminum isostearates, beeswax, behenamide, butadiene/acrylonitrile copolymer, C29-70 acid, calcium behenate, calcium stearate, candelilla wax, carnauba, ceresin, cholesterol, cholesterol hydroxystearate, coconut alcohol, copal, diglyceryl stearate malate, dihydroabietyl alcohol, dimethyl lauramine oleate, dodecanoic acid/cetearyl alcohol/glycol copolymer, erucamide, ethylcellulose, glyceryl triacetyl hydroxystearate, glyceryl tri-acetyl ricinolate, glycol dibehenate, glycol di-octanoate, glycol distearate, hexanediol distearate, hydrogenated C6-14 olefin polymers, hydrogenated castor oil, hydrogenated cottonseed oil, hydrogenated lard, hydrogenated menhaden oil, hydrogenated palm kernel glycerides, hydrogenated palm kernel oil, hydrogenated palm oil, hydrogenated polyisobutene, hydrogenated soybean oil, hydrogenated tallow amide, hydrogenated tallow glyceride, hydrogenated vegetable glyceride, hydrogenated vegetable oil, Japan wax, jojoba wax, lanolin alcohol, shea butter, lauramide, methyl dehydroabietate, methyl hydrogenated rosinate, methyl rosinate, methylstyrene/vinyltoluene copolymer, microcrystalline wax, montan acid wax, montan wax, myristyleicosanol, myristyloctadecanol, octadecene/maleic anhyrdine copolymer, octyldodecyl stearoyl stearate, oleamide, oleostearine, ouricury wax, oxidized polyethylene, ozokerite, paraffin, pentaerythrityl hydrogenated rosinate, pentaerythrityl tetraoctanoate, pentaerythrityl rosinate, pentaerythrityl tetraabietate, pentaerythrityl tetrabehenate, pentaerythrityl tetraoleate, pentaerythrityl tetrastearate, ophthalmic anhydride/glycerin/glycidyl decanoate copolymer, ophthalmic/trimellitic/glycols copolymer, polybutene, polybutylene terephthalate, polydipentene, polyethylene, polyisobutene, polyisoprene, polyvinyl butyral, polyvinyl laurate, propylene glycol dicaprylate, propylene glycol dicocoate, propylene glycol diisononanoate, propylene glycol dilaurate, propylene glycol dipelargonate, propylene glycol distearate, propylene glycol diundecanoate, PVP/eiconsene copolymer, PVP/hexadecene copolymer, rice bran wax, stearlkonium bentonite, stearalkonium hectorite, stearamide, stearamide DEA-distearate, stearamide DIBA-stearate, stearamide MEA-stearate, stearone, stearyl erucamide, stearyl stearate, stearyl stearoyl stearate, synthetic beeswax, synthetic wax, trihydroxystearin, triisononanoin, triisostearin, tri-isostearyl trilinoleate, trilaurin, trilinoleic acid, trilinolein, trimyristin, triolein, tripalmitin, tristearin, zinc laurate, zinc myristate, zinc neodecanoate, zinc rosinate, and mixtures thereof. The gelling agents used in vehicles may be natural gelling agents such as natural gums, starches, pectins, agar and gelatin. Often, the gelling agents are based on polysaccharides or proteins Examples include but are not limited to guar gum, Xanthum gum, Alginic acid (E400), sodium alginate (E401), potassium alginate (E402), ammonium alginate (E403), calcium alginate (E404,—polysaccharides from brown algae), Agar (E406, a polysaccharide obtained from red seaweeds), Carrageenan (E407, a polysaccharide obtained from red seaweeds), Locust bean gum (E410, a natural gum from the seeds of the Carob tree), Pectin (E440, a polysaccharide obtained from apple or citrus-fruit), and Gelatin (E441, made by partial hydrolysis of animal collagen).

Various embodiments may comprise a stabilizer. In a non-limiting example, sodium perborate is used as the stabilizing agent in an amount ranging from about 0.3 to about 1% w/w.

Various embodiments of the invention may further comprise a surfactant. The surfactant may be an anionic surfactant, a cationic surfactant, an ampholytic surfactant, or a nonionic surfactant. Examples of nonionic surfactants include polyethoxylates, fatty alcohols (e.g., ceteth-20 (a cetyl ether of polyethylene oxide having an average of about 20 ethylene oxide units) and other “BRIJ”® nonionic surfactants available from ICI Americas, Inc. (Wilmington, Del.)), cocamidopropyl betaine, alkyl phenols, fatty acid esters of sorbitol, sorbitan, or polyoxyethylene sorbitan. Suitable anionic surfactants include ammonium lauryl sulfate and lauryl ether sulfosuccinate. Preferred surfactants include lauroyl ethylenediamine triacetic acid sodium salt, Pluronic F87, Masil SF-19 (BASF) and incromide.

Water used in the formulations described herein is preferably deionized water having a neutral pH.

Various embodiments of the invention may comprise additional additives, including but not limited to a silicone fluid (such as dimethicone or cyclomethicone), a silicone emulsion, dyes, fragrances, pH adjusters, including basic pH adjusters such as ammonia, mono-, di- and tri-alkyl amines, mono-, di- and tri-alkanolamines, alkali metal and alkaline earth metal hydroxides (e.g., ammonia, sodium hydroxide, potassium hydroxide, lithium hydroxide, monoethanolamine, triethylamine, isopropylamine, diethanolamine and triethanolamine); acid pH adjusters such as mineral acids and polycarboxylic acids (e.g., hydrochloric acid, nitric acid, phosphoric acid, sulfuric acid, citric acid, glycolic acid, and lactic acid); vitamins such as vitamin A, vitamin E and vitamin C; polyamino acids and salts, such as ethylenediamine tetraacidic acid (EDTA), preservatives such as Germall plus and DMDM hydantoin, and sunscreens such as aminobenzoic acid, arobenzone, cinoxate, diioxybenzone, homosalate, menthyl anthranilate, octocrylene, octyl methoxycinnamate, octyl salicylate, oxybenzoate, padimate 0, phenylbenzimidazole, sulfonic acid, sulisobenzone, titanium dioxide, and trolamine salicylate.

In specific non-limiting embodiments, the present invention provides for a wound healing topical cream containing silver sulfadiazine, an insoluble zinc salt, a soluble zinc salt and calendula oil. In another non-limiting embodiment, the present invention provides for a wound healing topical cream containing silver sulfadiazine, an insoluble zinc salt, a soluble zinc salt, calendula oil, and anti inflammatory agents such as a curcumin compound.

The present invention also provides for a topical antimicrobial, wound healing, anti-inflammatory cream containing silver sulfadiazine, an insoluble zinc salt, a soluble zinc salt, calendula oil, and synergistic combinations of curcumin compounds, benzyl alcohol, and 1,3 propanediol or octanediol or decanediol, which also enhance the antifungal activity.

In various embodiments, the compositions further contain a silver releasing agent. In other embodiments, the compositions further contain a stabilizer.

Non-limiting examples of cream products may further contain white petrolatum (2-20%), fatty alcohol (2-20%), emollient (1-10%), emulsifying agent (0.5-10%), humectant (2-15%), preservative (0.1-0.5%), and deionized or distilled water q.s 100%. Fatty alcohols include stearyl, alcohol, cetyl alcohol, lauryl alcohol, myristyl alcohol, and other known fatty alcohols. Emollients include isopropyl myristate, lanolin, lanolin derivatives, isopropyl palmitate, isopropyl stearate and other known emollients. Emulsifying agents include sodium mono-oleate and polyoxyl 40 stearate. Humectants include propylene glycol, sorbitol, or glycerine or mixture thereof. Suitable water soluble preservatives include parabens, sorbic acid, benzoic acid, diazolidinyl urea, and iodopropylbutylcarbamate (Germal+).

The following Table provides a general nonlimiting formulation range of ingredients for topical wound healing compositions containing silver sulfadiazine, zinc salts, benzyl alcohol and botanicals.

TABLE 47
% Range of ingredients

| Ingredients | % (w/w) |
|---|---|
| Petrolatum | 8-12 |
| Stearyl alcohol | 10-18 |
| Isopropyl myristate | 3-7 |
| Sorbitan oleate | 1.5-3.5 |
| Polyoxy 40 stearate (Myrj 52) | 4.0-7.0 |
| Mineral oil | 0-2.0 |
| Germal + | 0.1-0.3 |
| Propylene glycol | 1-7 |
| Zinc lactate | 0.1-0.5 |
| Zinc oxide | 0.1-0.5 |
| Calendula oil | 0.5-2.0 |
| Silver sulfadiazine | 0.5-2.0 |
| Benzyl alcohol | 0.5-3.0 |
| THC | 0.-0.1 |
| 1,3 propanediol(Zemea) | 0.5-3.0 |
| Lactic acid | 0.01-0.2 |
| Benzoic acid | 0.1-0.5 |
| Sodium Benzoate | 0.1-0.5 |
| Water | 40-60 |

pH ranges from about 5 to about 6.8.

A specific non-limiting formulation for a topical wound healing composition is provided in the Table below.

TABLE 48
Specific formulation 1

| Topical cream ingredients | % (w/w) |
|---|---|
| Petrolatum | 10.7 |
| Stearyl alcohol | 16.0 |
| Isopropyl myristate | 6.0 |
| Sorbitan oleate | 2.7 |
| Polyoxy 40 stearate (Myrj 52) | 6.7 |
| Germal + | 0.3 |
| Propylene glycol | 2.0 |
| Zinc lactate | 0.2 |
| Zinc oxide | 0.3 |
| Calendula oil | 1.0 |
| Silver sulfadiazine | 1.0 |
| Benzyl alcohol | 2.0 |
| THC | 0.025 |
| 1,3 propanediol | 2.0 |
| Lactic acid | 0.015 |
| Benzoic acid | 0.2 |
| Sodium Benzoate | 0.2 |
| Water | 48.06 |

pH is at 6.3.

Provided below is another nonlimiting example of a topical wound healing composition.

TABLE 49
Specific formulation. 2

| Topical cream ingredients | % (w/w) |
|---|---|
| Petrolatum | 10.7 |
| Stearyl alcohol | 16.0 |
| Isopropyl myristate | 6.0 |
| Sorbitan oleate | 2.7 |
| Polyoxy 40 stearate (Myrj 52) | 6.7 |
| Germal + | 0.3 |
| Propylene glycol | 2.0 |
| Zinc lactate | 0.2 |
| Zinc oxide | 0.3 |
| Calendula oil | 1.0 |
| Silver sulfadiazine | 1.0 |
| Benzyl alcohol | 0.5 |
| THC | 0. |
| 1,3 propanediol | 2.0 |
| Lactic acid | 0.015 |
| Benzoic acid | 0.2 |
| Sodium Benzoate | 0.2 |
| Water | 50.185 |

pH is at 6.0.

The present invention also provides for antifungal diaper rash creams and ointments containing benzyl alcohol, botanicals and antifungal agents such as miconazole. Various topical antifungal agents may be used in the present invention, including but not limited to miconazole, oxiconazole, sulconazole, clotrimazole, econazole, ketoconozole, sertaconozol, fluconozole, and amphotericin B. The following tables provide for general and specific nonlimiting formulations.

TABLE 50

| Ingredients | % w/w (Range) |
|---|---|
| Water | 0-70 |
| Polyquartenium10 | 0-0.3 |
| Incroquat Behenyl TMS | 0-4.0 |
| Polawax | 0-4.0 |
| Petroleum Jelly | 5-65 |
| Stearyl alcohol | 5-20 |
| Myrj 52 | 1-7.0 |
| Calendula oil | 0.-1.0 |
| Silicone fluid | 2-10 |
| Propylene Glycol | 0-5.0 |
| Isopropyl Myristate | 2-.8.0 |
| Sorbitan Oleate | 0.5-.4.0 |
| Dipropyleneglycol | 0-2.0 |
| Benzyl alcohol | 0.5-5.0 |
| Alkanediol | 0.5-5.0 |
| Tetrahydrocurcuminoid | 0.05-0.2 |
| Zinc gluconate | 0.1-1.0 |
| Zinc Oxide | 0.5-10 |
| Zinc stearate | 0.5-5.0 |
| Lactic acid | 0.2-2.0 |
| Benzalkonium chloride | 0-0.2 |
| Chlorhexidine gluconate | 0.2-1.0 |
| Topical antifun gal agents^{x} | 0.5-5.0 |

TABLE 51
Specific formulation for antifungal diaper rash ointment

| Topical cream ingredients | % (w/w) |
|---|---|
| Petrolatum | 59.05. |
| Stearyl alcohol | 12.0 |
| Isopropyl myristate | 4.0 |
| Sorbitan oleate | 2.5 |
| Polyoxy 40 stearate (Myrj 52) | 6.0 |
| Calendula oil | 0.8 |
| Zinc stearate | 3.0 |
| Zinc lgluconate | 0.4 |
| Zinc oxide | 7.0 |
| Miconazole | 2.0 |
| Lactic acid | 1.0 |
| Benzyl alcohol | 1.0 |
| THC | 0.05 |
| 1,3 propanediol( Zemea) | 1.0 |
| Chlorhexidine gluconate | 0.2 |

### 4.13 Veterinary Products

In a subset of non-limiting embodiments, the present invention provides for veterinary products for care of any domestic animal, including but not limited to cats, dogs, birds, rodents, rabbits, horses, cows and cattle, sheep, goats, etc.

Non-limiting examples of veterinary care products which may utilize the invention include pet shampoo, pet cleansing wipes including body wipes, ear wipes, and eye wipes, dental wipes, toothpaste, ear cleaning liquid, cage cleaner, surface cleaner for housebreaking accidents, topical creams, ointments, teat dip therapeutic for mastitis and liquid to be applied to pet's skin (as in a “body splash”).

Veterinary care compositions according to the invention may further comprise one or (preferably) more than one component selected from the group consisting of emollients, stabilizing agents, thickening agents, humectants, antimicrobial agents, neutralizing agents, surfactants, water, silicone polymers, alcohols, and hydrogels, anti-inflammatory agents, wound healing agents, salicylic acid, as well as additional components as may be known in the art.

Specific, non-limiting examples of additional components which may be comprised in pet care products include the components listed above for personal care products.

In certain non-limiting embodiments of the invention, the compositions may be prepared for teat dip to treat mastitis. A general formulation for teat dip compositions is as follows.

TABLE 52

| General Formulation | |
|---|---|
| Ingredients | % (w/w) |
| Safflower oil | 10-20 |
| Lemongrass oil | 0-0.3 |
| Water | 50-70 |
| Xanthum gum | 0-0.5 |
| Zinc lactate | 0-0.2 |
| Symrelief (Bisabolol + Ginger extract) | 0-0.2 |
| Curcumin | 0-0.2 |
| PSO | 0-0.2 |
| Benzyl alcohol | 0-5.0 |
| 1.3 propanediol | 0-5.0 |
| Calendula oil | 0.5-0.1 |
| Glycerin | 5-12 |
| Grape fruit seed extract | 0.2-3.0 |
| Lactic acid | 0.2- 0.5 |
| pH adjusted with 10N NaoH | 6.5-6.7 |

The anti-irritants used for teat dip may include but are not limited to zinc salts with panthenol, or Bisabolol with ginger root extract (symrelief), or symrelief with a zinc salt. The gelling agents in the vehicle may include but are not limited to natural gelling agents such as natural gums, starches, pectins, agar and gelatin. Antimicrobial botanicals may include but are not limited to lemongrass oil, orange oil and fruit acids such as citric and lactic acid, phenoxyethanol (constituent of sage oil). The following Tables summarize various non limiting examples of formulations.

TABLE 53

| Mastitits treatment lotion 1 | % (w/w) |
|---|---|
| Safflower oil | 17.0 |
| Lemongrass oil | 0.1 |
| Water | 67.75 |
| Xanthum gum | 0.45 |
| Zinc lactate | 0.2 |
| Symrelief (Bisabolol + Ginger extract) | 0.2 |
| Calendula oil | 0.5 |
| Glycerin | 10.6 |
| Grape fruit seed extract | 3.0 |
| Lactic acid | 0.2 |
| pH adjusted with 10N NaoH | 6.5-6.7 |

TABLE 54

| Mastitits treatment lotion 2 | % (w/w) |
|---|---|
| Safflower oil | 17.0 |
| Water | 66.9 |
| Xanthum gum | 0.45 |
| Hydroxycurcuminoid | 0.15 |
| Benzyl alcohol | 1.0 |
| Symrelief (Bisabolol + Ginger extract) | 0.2 |
| Calendula oil | 0.5 |
| Glycerin | 10.6 |
| Grape fruit seed extract | 3.0 |
| Lactic acid | 0.2 |
| pH adjusted with 10N NaoH | 6.5-6.7 |

TABLE 55

| Mastitits treatment lotion 3 | % (w/w) |
|---|---|
| Safflower oil | 17.0 |
| Water | 61.54 |
| Xanthum gum | 0.45 |
| Hydroxycurcuminoid | 0.15 |
| Benzyl alcohol | 1.0 |
| Pomegranate seed oil | 0.1 |
| Calendula oil | 0.5 |
| Glycerin | 10.6 |
| Grape fruit seed extract | 3.0 |
| Lactic acid | 0.2 |
| pH adjusted with 10N NaoH | 6.5-6.7 |

TABLE 56

| Mastitits treatment lotion 4 | % (w/w) |
|---|---|
| Safflower oil | 17.0 |
| Water | 68.0 |
| Xanthum gum | 0.45 |
| Hydroxycurcuminoid | 0.15 |
| Benzyl alcohol | 1.0 |
| Zemea ® | 1.0 |
| Pomegranate see oil | 0.1 |
| Calendula oil | 0.5 |
| Glycerin | 10.6 |
| Grape fruit seed extract | 1.0 |
| Lactic acid | 0.2 |
| pH adjusted with 10N NaoH | 6.5-6.7 |

TABLE 57

| Cow teat dip solution ingredients | % (w/w) |
|---|---|
| Safflower oil | 10.0 |
| Water | 74.1 |
| Xanthum gum | 0.45 |
| Hydroxycurcuminoid | 0.15 |
| Benzyl alcohol | 1.0 |
| Zemea ® | 1.0 |
| PCL liquid 100 (Symrise) | 1.0 |
| Calendula oil | 0.5 |
| Glycerin | 10.6 |
| Grape fruit seed extract | 1.0 |
| Lactic acid | 0.2 |
| pH adjusted with 10N NaoH | 6.5-6.7 |

### 4.14 Household/Industrial Products

In a subset of non-limiting embodiments, the present invention provides for household/industrial products comprising the formulations outlined above.

Non-limiting embodiments of household/industrial products which may utilize the invention include householder cleaners such as concentrated liquid cleaners and spray cleaners, cleaning wipes, dish washing liquid, dish washer detergent, spray-mop liquid, furniture polish, indoor paint, outdoor paint, dusting spray, laundry detergent, fabric softener, rug/fabric cleaner, window and glass cleaner, toilet bowl cleaner, liquid/cream cleanser, etc. In a particular embodiment, the invention may be used in a food wash product, designed to clean fruits and vegetables prior to consumption. “Household products” are products, other than personal care products, that would be used by individual consumers. “Industrial products” refers to products that are used in industry.

Household-industrial compositions according to the invention may further comprise one or (preferably) more than one component selected from the group consisting of surfactants, builders (e.g., sequestering builders, precipitating builders, ion exchange builders), solvents, thickeners, abrasives, acids, bases (alkalis), antimicrobial agents, soaps, bleaching agents, enzymes, preservatives, and sudsing agents, as well as additional components as may be known in the art.

In various non-limiting embodiments of the invention, the compositions may further comprise a surfactant, for example, but not limited to, an anionic surfactant such as an alkyl sulfate, an alkyldiphenyloxide disulfonate salt (e.g., the DOWFAX series by the Dow Chemical Company), an alkylbenzenesulfonate, an alcohol ethoxysulfate; a cationic surfactant; a non-ionic surfactant, such as a secondary alcohol ethoxylate (e.g., the TERGITAOL series by the Dow Chemical Company) or an alkyl polyglucoside (e.g., the TRITON series by the Dow Chemical Company); or an amphoteric surfactant such as an imidazoline or betaine compound.

In various non-limiting embodiments of the invention, the compositions may further comprise a solvent, for example, but not limited to, water, an alcohol such as methanol, ethanol, isopropyl alcohol, or butanol; a hydrocarbon such as an aromatic hydrocarbon, propylene glycol, methylene chloride, acetone, a petroleum distillate, and/or a glycol ether.

In various non-limiting embodiments of the invention, the compositions used in a household/industrial product may further comprise a thickener, for example, but not limited to, a polyethylene glycol. a methoxypolyethylene glycol, and/or hydroxyethyl cellulose.

In various non-limiting embodiments of the invention, the compositions used in a household/industrial product may further comprise an abrasive, such as, but not limited to, silica, feldspar or calcite.

In various non-limiting embodiments of the invention, the compositions used in a household/industrial product may further comprise an acid, such as, but not limited to, acetic acid, hydroacetic acid, phosphoric acid or hydrochloric acid.

In various non-limiting embodiments of the invention, the compositions used in a household/industrial product may further comprise a base (alkali) such as, but not limited to, ammonia or sodium bicarbonate.

In various non-limiting embodiments of the invention, the compositions used in a household/industrial product may further comprise an antimicrobial agent, for example, but not limited to, compounds as set forth above for personal care compositions, and also pine oil and sodium hypochlorite.

In various non-limiting embodiments of the invention, the compositions used in a household/industrial product may further comprise a bleaching agent, for example, but not limited to, sodium hypochlorite, hydrogen peroxide, sodium percarbonate and sodium perborate.

In various non-limiting embodiments of the invention, the compositions used in a household/industrial product may further comprise an enzyme, such as, but not limited to, a protease or a lipase.

In various non-limiting embodiments of the invention, the compositions used in a household/industrial product may further comprise a preservative, such as, but not limited to, butylated hydroxytoluene, glutaraldehyde, and EDTA.

In various non-limiting embodiments of the invention, the compositions used in a household/industrial product may further comprise a sudsing agent, such as, but not limited to, diethanolamine or triethanolamine.

In specific, non-limiting embodiments, the present invention provides for the following surface cleaners, having concentrations of active ingredients as well as concentrated stock solutions of these formulations which may be diluted to achieve the respective concentrations.

The following Table 58A provides a general formulation for surface disinfectants composition containing benzyl alcohol, fruit acid and biguanide.

TABLE 58A

| Ingredient | % w/w |
|---|---|
| Vantocil | 0.1-0.5 |
| Glucopon (alkylpolyglycoside) | 0.5-3.0 |
| Lactic acid | 0.2-2.0 |
| Citric acid | 0-2.0 |
| Benzoic acid | 0-1.0 |
| Benzyl alcohol | 0.5-10.0 |
| Aliphatic Alcohol | 0-10 |
| Water | 80-95 |

Table 58B provides a general formulation for stock surface cleanser.

TABLE 58B

| Ingredients | % w/w (Range) |
|---|---|
| Chlorhexidine gluconate | 0.00-2.00 |
| Polyhexamethylene Biguanide | 1.00-6.00 |
| Benzethonium chloride | 5.00-12.00 |
| Triclosan | 0.00-10.00 |
| Incroquat Compounds | 0.10-1.00 |
| Diglycerol | 0.00-5.00 |
| Dipropylene glycol | 0.50-5.00 |
| Non ionic Pluronic L64 | 0.50-2.00 |
| Non ionic Pluronic RA 30 | 0.25-1.00 |
| Non ionic Pluronic 25 R4 | 0.25-1.00 |
| SDA 40B alcohol | 10.00-20.00 |
| Water | 40.00-90.00 |
| Octanediol | 5.00-12.00 |
| Salicylic acid | 0.00 |
| Salts of salicylic acid | 0.00 |
| Essential oils | 0.00 |
| Botanicals | 0.00 |
| Benzyl alcohol | 0.00 |
| Long Chain Quaternary ammonium | 1.00-5.00% |
| Compounds | |

The level of use is diluting 1 to 5 ounces of the stock solution to 1 gallon of water. Table 58C provides an alternative formulation for stock surface cleansers.

TABLE 58C

| Ingredients | % w/w (Range) |
|---|---|
| Polyhexamethylene Biguanide | 1.00-6.00 |
| Benzethonium chloride | 5.00-12.00 |
| Incroquat compounds | 0.10-0.50 |
| Diglycerol | 0.00-5.00 |
| Dipropylene glycol | 0.00-5.00 |
| Non ionic surface cleaner | 5-30.0 |
| SDA 40B alcohol | 10.00-20.00 |
| Water | 40.00-90.00 |
| Alkanediol | 5-12.00 |
| Salicylic acid | 0.00 |
| Salts of salicylic acid | 0.00 |
| Essential oils | 0.00 |
| Botanicals | 0.00 |
| Fruit acids | 10-50 |
| Benzyl alcohol | 10-50 |

### 4.15 Medical Devices

In a subset of non-limiting embodiments, the present invention provides for medical devices comprising the formulations outlined above.

Implantation of a medical device produces rapid inflammatory reaction at the implantation site. This may result in the formation of a biofilm on the surface of the medical device. The biofilm on the surface of a medical device serves as a receptor for microbes resulting in microbial adhesion. Prevention of inflammation around the implanted medical device can prevent bacterial adherence on the device. This may be achieved by maintaining an inflammation and infection-free environment around the device by coating and/or impregnating the device with anti inflammatory agents and antimicrobials.

Anti-inflammatory antimicrobial compositions comprising synergistic combination of benzyl alcohol, 1,3 propanediol and THC (with or without other antimicrobials such as chlorhexidine and silver salts) can be used to coat or impregnate medical devices such as catheters, wound dressing, soft tissue patches, etc.

### 5. EXAMPLES

The detailed description hereby incorporates, by reference, the specific working examples of the invention set forth below.

The working examples sometimes refer to Softsoap® or Dial® soaps. Softsoap® is a commercially sold liquid soap comprising water, sodium laureth sulfate, cocamidopropyl betaine, decylglucoside, sodium chloride, fragrance, DMDM hydantoin, PEG-120 methyl glucose dioleate, tetrasodium ethylene diamine tetracetic acid, sodium sulfate, polyquaternium-7, citric acid, poloxamer 124, PEG-7 glyceryl, cocoate, benzophenine-4, and colors. Dial® soap is a commercially sold liquid soap, where Dial® Antibacterial hand soap comprises, as active agent, 0.15 percent triclosan, and the inactive agents are water, sodium laureth sulfate, ammonium lauryl sulfate, decyl glucoside, cocamidopropyl betaine, glycerine, sodium chloride, PEG-18 gylceryl oleate/cocoate, fragrance, cocamide MEA, DMDM hydantoin, tetrasodium ethylene diamine tetracetic acid and colors.

### Example 1

The present example provides an evaluation of the synergistic efficacy of benzyl alcohol and GSE, with and without 1,3 propanediol.

The following preservative compositions were prepared, adjusted the pH to 5.0 and added to a hydrophilic cream base and tested for their efficacy against Aspergillus niger (Fungus) and C. albicans, which are the most prevalent contaminant in creams and is difficult to eradicate. The specific method used is described in Example 6. The pH of all the preservatives were adjusted between 4.5-5.0. 1-2% of the preservatives were used.

TABLE 59

| | | | | Efficacy (log₁₀ |
|---|---|---|---|---|
| | | | | reduction from |
| | | % w/w in | % w/w in | control growth^{x}) |
| Preservative | Ingredient | stock | cream | A. niger |
| Preservative 1 | GSE | 100 | 0.2 | 1.2 |
| Preservative 2 | Benzyl alcohol | 100 | 0.5 | 0.98 |
| | (natural) | | | |
| Preservative 3 | GSE | 28.6 | 0.2 | 3.1 |
| | Benzyl alcohol | 71.4 | 0.5 | |
| Preservative 4 | Benzyl alcohol | 50 | 0.5 | 1.0 |
| | Natural 1,3 | 50 | 0.5 | |
| | propanediol | | | |
| | (Zemea ®) | | | |
| Preservative 5 | Benzyl alcohol | 41.7 | 0.5 | 3.9 |
| | Zemea ® | 41.7 | 0.5 | |
| | GSE | 16.6 | 0.2 | |

^{x}Control growth - 1 × 10⁴-5 × 10⁴

Conclusion: GSE and benzyl alcohol exhibits synergistic efficacy. 1,3 propanediol renders the solution clear and enhances the activity. The synergistic activity can also be seen between benzyl alcohol Zemea® mixture and GSE.

### Example 2

The present example provides an evaluation of the synergistic efficacy of benzyl alcohol (synthetic) and GSE and 1,3 propanediol (synthetic).

TABLE 60

| | | | | Efficacy (log₁₀ |
|---|---|---|---|---|
| | | | | reduction from |
| | | % w/w in | % w/w in | control growth^{x}) |
| Preservative | Ingredient | stock | cream | A. niger |
| Preservative | Benzyl alcohol | 41.7 | 0.5 | 4.1 |
| 5A | (synthetic) | | | |
| | 1,3 propanediol | 41.7 | 0.5 | |
| | (synthetic) | | | |
| | GSE | 16.6 | 0.5 | |

^{x}Control growth - 1 × 10⁴-5 × 10⁴

Conclusion: Synthetic benzyl alcohol and 1,3 propanediol along with GSE show similar efficacy to the formulation that uses natural components.

### Example 3

The present example provides an evaluation of the synergistic effect of various fragrant and non-fragrant botanicals with benzyl alcohol, and Zemea®.

In order to determine whether the synergism seen between non-fragrant GSE and a benzyl alcohol-Zemea® mixture is unique to GSE or other botanicals also, the following botanicals were tested and the results are given below.

The following Table provides a summary of the efficacy of individual botanicals against A. niger.

TABLE 61

| | | | | Efficacy (log₁₀ |
|---|---|---|---|---|
| | | | | reduction from |
| | | % w/w in | % w/w in | control growth^{x}) |
| Fragrant | Ingredient | stock | cream | A. niger |
| Fragrant | LGO | 100 | 0.3 | 0.73 |
| Fragrant | BO | 100 | 0.3 | 0.87 |
| Fragrant | CO | 100 | 0.3 | 0.88 |
| Non-Fragrant | PSO | 100 | 0.05 | 0.87 |
| Non-Fragrant | KP | 100 | 0.3 | 0.89 |
| Non-Fragrant | THC | 100 | 0.15 | 0.58 |

^{x}Control growth - 1 × 10⁴-5 × 10⁴

The following table provides a summary of the efficacy of botanicals in combination with benzyl alcohol-Zemea® against A. niger.

TABLE 62

| | | | | Efficacy (log₁₀ |
|---|---|---|---|---|
| | | | | reduction from |
| | | % w/w in | % w/w in | control growth^{x}) |
| Preservative | Ingredient | stock | cream | A. niger |
| Preservative 4 | Benzyl alcohol | 50.0 | 0.5 | |
| | Zemea ® | 50.0 | 0.5 | 1.0 |
| Preservative 4X | Benzyl alcohol | 66.67 | 1.0 | |
| | Zemea ® | 33.3 | 0.5 | 2.2 |
| Preservative 4A | LGO | 23 | 0.3 | |
| | Benzyl alcohol | 38.5 | 0.5 | |
| | Zemea ® | 38.5 | 0.5 | 3.8 |
| Preservative 4B | CO | 23.0 | 0.3 | |
| | Benzyl alcohol | 38.5 | 0.5 | |
| | Zemea ® | 38.5 | 0.5 | 2.54 |
| Fragrant | BO | 23.0 | 0.3 | |
| Preservative 4C | Benzyl alcohol | 38.5 | 0.5 | |
| | Zemea ® | 38.5 | 0.5 | 1.0 |
| Non-fragrant | PSO | 4.8 | 0.05 | |
| Preservative 4D | Benzyl alcohol | 47.6 | 0.5 | |
| | Zemea ® | 47.6 | 0.5 | 1.29 |
| Non-fragrant | KP | 23.0 | 0.3 | |
| Preservative 4E | Benzyl alcohol | 38.5 | 0.5 | |
| | Zemea ® | 38.5 | 0.5 | 1.03 |
| Non-fragrant | THC | 9.1 | 0.15 | |
| Preservative 4F | Benzyl alcohol | 60.6 | 1.0 | |
| | Zemea ® | 30.3 | 0.5 | 4.2 |

^{x}Control growth - 1 × 10⁴-5 × 10⁴

Conclusion: Among the botanicals tested, only Lemongrass oil, cinnamon oil and THC exhibit synergism with the benzyl alcohol-Zemea® (BA-Z) combination.

### Example 4

The present example provides an evaluation of the effect of fruit acid (lactic acid) on the efficacy of (1) benzyl alcohol, GSE and Zemea®; and (2) benzyl alcohol, GSE and glycerin. Glycerin was used as the solvent for GSE and lactic acid. A. niger was used as the test organism.

TABLE 63

| | | | | Efficacy (log₁₀ |
|---|---|---|---|---|
| | | | | reduction from |
| | | % w/w in | % w/w in | control growth^{x}) |
| Preservative | Ingredient | stock | cream | A. niger |
| Preservative 6 | GSE | 40 | 0.3 | |
| | Lactic acid | 20 | 0.2 | |
| | Glycerin | 40 | 0.5 | 1.2 |
| Preservative 7 | Benzyl alcohol | 40 | 0.5 | |
| | Lactic acid | 20 | 0.2 | |
| | Glycerin | 40 | 0.3 | 0.5 |
| Preservative 8 | GSE | 20.0 | 0.3 | |
| | Benzyl alcohol | 33.3 | 0.5 | |
| | Glycerin | 33.3 | 0.5 | |
| | Lactic acid | 13.3 | 0.2 | 2.9 |
| Preservative 9 | Lactic acid | 16.6 | 0.2 | |
| | Benzyl alcohol | 41.7 | 0.5 | |
| | Zemea ® | 41.7 | 0.5 | 1.0 |
| Preservative 10 | GSE | 17.24 | 0.25 | |
| | Lactic acid | 13.79 | 0.2 | |
| | 1,3 propanediol | 68.97 | 1.0 | 1.0 |
| | (Zemea ®) | | | |
| Preservative 11 | GSE | 26.7 | 0.4 | |
| | Lactic acid | 13.3 | 0.2 | |
| | Zemea ® | 33.3 | 0.5 | |
| | Ethyl alcohol | 26.7 | 0.4 | 1.2 |
| Preservative 12 | GSE | 20 | 0.3 | |
| | Benzyl alcohol | 33.3 | 0.5 | |
| | Zemea ® | 33.3 | 0.5 | |
| | Lactic acid | 13.3 | 0.2 | 3.9 |

^{x}Control growth - 1 × 10⁴-5 × 10⁴

Conclusion: No significant activity was seen with the solution of GSE and lactic acid in combination with either Glycerin or Zemea® or Zemea® and ethyl alcohol. Benzyl alcohol and lactic acid in combination with either Glycerin or Zemea® also had no significant activity. However, synergistic activity was seen between (1) GSE, lactic acid, Zemea®, and benzyl alcohol; and (2) GSE, lactic acid, glycerin and benzyl alcohol. Superior synergistic activity was seen with GSE, lactic acid, Zemea® and benzyl alcohol.

### Example 5

The present example provides an evaluation on the effect of the addition of benzyl alcohol to the combination of GSE, Zemea®, lemongrass oil, and lactic acid.

TABLE 64

| | | | | Efficacy (log₁₀ |
|---|---|---|---|---|
| | | | | reduction from |
| | | % w/w in | % w/w in | control growth^{x}) |
| Preservative | Ingredient | stock | cream | A. niger |
| Preservative 13 | GSE | 16.7 | 0.25 | |
| | Lactic acid | 13.3 | 0.2 | |
| | Zemea ® | 66.7 | 1.0 | |
| | Lemongrass oil | 3.3 | 0.05 | 1.12 |
| Preservative 14 | GSE | 16.7 | 0.25 | |
| | Lactic acid | 13.3 | 0.2 | |
| | Benzyl alcohol | 33.3 | 0.5 | |
| | Lemongrass oil | 3.3 | 0.05 | |
| | Zemea ® | 33.3 | 0.5 | 4.2 |

^{x}Control growth - 1 × 10⁴-5 × 10⁴

Conclusion: Benzyl alcohol exhibits synergistic activity with the combination of GSE, lemongrass oil, and lactic acid.

### Example 6

The present example describes the method of testing the preservative efficacy of various preservative compositions.

Method 1. An overnight culture of bacteria grown in Trypticase Soy Broth (TSB) was diluted with TSB to obtain 108 CFU organism/ml (yeast and Fungi i.e. C. albicans and A. niger grown in Sabaraud dextrose broth is diluted to obtain 1×107 cfu organism/ml). For the test samples, the preservative was added to 10 grams of the cream at 1-1.5% and mixed well. From this sample, 1 gram aliquots were placed into 10 ml sterile plastic culture tubes and 0.1 ml (100 micro liters) of the test inoculum was added and vortexed until uniformly blended. The tubes were then placed into incubators under the following temperatures: 30° C. for Aspergillus niger and 37° C. for the remaining three microbes. All tubes were incubated for a 1 day for bacteria and 2 days for Fungi and yeast. At the end of the incubation period, 9.0 ml of Butterfield Phosphate Buffered solution with neutralizer was added to the incubated cultured sample and vortexed until completely mixed. The samples were serially diluted and then plated in Trypticase soy agar (TSA). The plates were incubated at 37° C. temperature for 24-48 hours, and the counts were read. Placebo cream was tested similarly and used as the control.

### Example 7

The present example demonstrates the efficacy of the addition of anti-inflammatory and antifungal tetra-hydrocurcuminoids to preservative compositions containing GSE, lactic acid, benzyl alcohol and Zemea®.

Curcuminoids are yellow in color and may not be suitable for personal care composition. Therefore, tetrahydrocurcuminoids, which are color-free compounds derived from the yellow curcuminoids, were evaluated. The use of anti-inflammatory curcuminoids, along with the natural preservative described in this invention, not only prevents spoilage of personal care products by eradicating the microbial contamination, but may also lower irritation and inflammation on the skin caused by the ingredients in the products. The following exemplary, but not limiting, list of curcuminoids can be used in the present invention: tetrahydrocurcumin, tetrahydrodemethoxy-curcumin, tetrahydrobisdemethoxycurcumin, and mixtures thereof.

TABLE 65

| | | | | Efficacy (log₁₀ | Efficacy (log₁₀ |
|---|---|---|---|---|---|
| | | | | reduction from | reduction from |
| | | % w/w | % w/w | control growth^{x}) | control growth^{x}) |
| Preservative | Ingredient | in stock | in cream | A. niger | C. albicans |
| Preservative 15 | GSE | 14.3 | 0.2 | | |
| | Lactic acid | 14.3 | 0.2 | | |
| | Zemea ® | 35.7 | 0.5 | | |
| | Benzyl alcohol | 35.7 | 0.6 | 3.7 | 4.5 |
| Preservative 16 | GSE | 13.3 | 0.2 | | |
| | Lactic acid | 13.3 | 0.2 | | |
| | Zemea ® | 33.3 | 0.5 | | |
| | Benzyl alcohol | 37.3 | 0.56 | | |
| | tetrahydrocurcuminoid | 2.8 | 0.04 | 4.2 | 7.4 |
| Preservative 17 | Lactic acid | 16.1 | 0.2 | | |
| | Zemea ® | 40.3 | 0.5 | | |
| | Benzyl alcohol | 40.3 | 0.5 | | |
| | tetrahydrocurcuminoid | 3.23 | 0.04 | 0.96 | 2.7 |

^{x}Control growth - 1 × 10⁴-5 × 10⁴ for aspergillus and 1 × 10⁷-5 × 10⁷ for candida in all groups

Conclusion: Tetrahydro curcuminoids enhances the activity of composition containing GSE, lactic, Zemea®, and benzyl alcohol.

### Example 8

The present example demonstrates the effect of the addition of various solvents on a composition containing lemongrass oil, GSE, and lactic acid. The solvents used are (1) Glycerin, (2) Benzyl alcohol, (3) Octoxyglycerin (Sensiva), and (4) Zemea® Octoxyglycerin.

TABLE 66

| | | | | Efficacy (log₁₀ | Efficacy (log₁₀ |
|---|---|---|---|---|---|
| | | | | reduction from | reduction from |
| | | % w/w | % w/w | control growth^{x}) | control growth^{x}) |
| Preservative | Ingredient | in stock | in cream | A. niger | C. albicans |
| Preservative 18 | GSE | 13.3 | 0.2 | | |
| | Lactic acid | 13.3 | 0.2 | | |
| | Zemia | 33.3 | 0.5 | | |
| | Benzyl alcohol | 36.7 | 0.55 | | |
| | Lemongrass oil | 3.3 | 0.05 | 4.2 | 6.5 |
| Preservative 19 | GSE | 11.8 | 0.2 | | |
| | Lactic acid | 11,8 | 0.2 | | |
| | Zemea ® | 29.4 | 0.5 | | |
| | Sensiva | 44.1 | 0.75 | | |
| | Lemongrass oil | 2.9 | 0.05 | 1.8 | 6.5 |
| Preservative 19A | GSE | 11.8 | 0.2 | | |
| | Lactic acid | 11.8 | 0.2 | | |
| | Zemea ® | 73.5 | 1.25 | | |
| | Lemongrass oil | 2.9 | 0.05 | 1.12 | 3.84 |
| Preservative 20 | GSE | 13.3 | 0.2 | | |
| | Lactic acid | 13.3 | 0.2 | | |
| | Sensiva | 70.0 | 1.05 | | |
| | Lemongrass oil | 3.3 | 0.05 | 1.92 | 6.5 |

^{x}Control growth - 1 × 10⁴-5 × 10⁴ for aspergillus and 1 × 10⁷-5 × 10⁷ for candida in all groups

Conclusion: The addition of benzyl alcohol to the combination of GSE, lemongrass oil and lactic acid exhibits a higher efficacy against A. niger and C. albicans. Addition of Sensiva without benzyl alcohol is effective against C. albicans but not against A. niger.

### Example 9

The present examples provides an evaluation of the synergistic efficacy of benzyl alcohol and GSE with higher (0.15%) concentration of tetrahydrocurcuminoids (THC).

TABLE 67

| | | Efficacy (log₁₀ | Efficacy (log₁₀ |
|---|---|---|---|
| | | reduction from | reduction from |
| Ingredients/ | % w/w in | control growth^{x}) | control growth^{x}) |
| Preservative | cream | A. niger | C. albicans |
| GSE | 0.2 | 1.2 | 1.0 |
| Benzyl alcohol | 0.5 | 1.0 | 1.0 |
| Benzyl alcohol | 1.0 | 1.9 | 2.7 |
| THC | 0.15 | 0.58 | 1.2 |
| Benzyl alcohol + | 1 + 0.5 | 2.2 | 6.8 |
| Zemea ® | | | |
| GSE + THC | 0.2 + 0.15 | 1.2 | 1.7 |
| GSE + THC + Benzyl | 0.2 + 0.15 + | 4.2 | 7.5 |
| alcohol + Zemea ® | 1 + 0.5 | | |
| Benzyl alcohol + THC | 1 + 0.15 | 4.2 | 6.8 |
| Zemea ® | 0.5 | 0.85 | 0.5 |

^{x}Control growth - 1 ×10⁴-5 × 10⁴ for aspergillus and 1 × 10⁷-5 ×10⁷ for candida in all groups

Conclusion: No enhanced efficacy was seen when THC was added to GSE. Higher concentrations of benzyl alcohol and THC exhibit synergistic activity against both A. niger and C. albicans. Significant synergism is seen against C. albicans. Higher concentrations of benzyl alcohol also exhibits synergistic activity with Zemea® against C. albicans

### Example 10

The present example provides the efficacy of PSO to the preservative containing THC.

TABLE 68

| | | | | Efficacy (log₁₀ | Efficacy (log₁₀ |
|---|---|---|---|---|---|
| | | | | reduction from | reduction from |
| | Ingredients/ | % w/w | % w/w | control growth^{x}) | control growth^{x}) |
| Preservative | Preservative | in stock | in cream | A. niger | C. albicans |
| Preservative 22 | GSE | 20 | 0.2 | | |
| | Zemea ® | 25 | 0.5 | | |
| | Benzyl alcohol | 50 | 0.5 | | |
| | tetrahydrocurcuminoids | 5.0 | 0.05 | 4.2 | 7.5 |
| Preservative 23 | GSE | 16.7 | 0.2 | | |
| | Zemea ® | 20.8 | 0.5 | | |
| | Benzyl alcohol | 41.6 | 0.5 | | |
| | Lactic acid | 16.7 | 0.2 | | |
| | Tetrahydrocurcuminoids | 4.2 | 0.05 | 4.2 | 7.5 |
| Preservative 24 | GSE | 16.7 | 0.2 | | |
| | Zemea ® | 20.8 | 0.5 | | |
| | Benzyl alcohol | 41.6 | 0.5 | | |
| | Lactic acid | 16.7 | 0.2 | | |
| | Pomegranate | 4.2 | 0.05 | 4.2 | 7.5 |
| | seed oil (P50) | | | | |

^{x}Control growth - 1 × 10⁴-5 × 10⁴ for aspergillus and 1 × 10⁷-5 × 10⁷ for candida in all groups

Conclusion: The addition of pomegranate seed oil and THC to preservatives containing GSE, Zemea®, benzyl alcohol and lactic acid (preservative 15) showed enhanced efficacy against C. albicans.

### Example 11

The present example evaluates the efficacy of various products comprising synergistic combination of benzyl alcohol, Zemea®, and botanicals.

Specifically, fragrance free anti-inflammatory preservative compositions comprising GSE, benzyl alcohol derived from Cassia plant, 1,3 Propanediol (Zemea®, DuPont Tate and Lyle) derived from corn sugar, anti-inflammatory agents, and CRMN (particularly white colored tetrahydro curcuminoid) were evaluated. The following preservative compositions were made and tested against bacteria, fungus and yeast.

TABLE 69

| | | | | Efficacy (log₁₀ reduction | | | |
|---|---|---|---|---|---|---|---|
| | | | | from control growth*) | | | |
| | | % w/w | % w/w | A. | C. | S. | P. |
| Preservative | Ingredient | in stock | in cream | niger | albicans | aureus | Aeruginosa |
| Preservative | GSE | 16.7 | 0.2 | — | — | — | — |
| 15A | Zemea ® | 41.65 | 0.5 | | | | |
| | Benzyl alcohol | 41.65 | 0.5 | | | | |
| Preservative | GSE | 14.3 | 0.2 | 3.7 | 4.5 | >7 | >7 |
| 15B | Zemea ® | 35.7 | 0.5 | | | | |
| | Benzyl alcohol | 35.7 | 0.5 | | | | |
| | Lactic acid | 14.3 | 0.2 | | | | |
| Preservative | GSE | 20 | 0.2 | 4.6 | 4.5 | >7 | >7 |
| 22 | Zemea ® | 25 | 0.5 | | | | |
| | Benzyl alcohol | 50 | 0.5 | | | | |
| | Tetrahydro | 5.0 | 0.05 | | | | |
| | curcuminoids | | | | | | |
| Preservative | GSE | 16.7 | 0.2 | 4.6 | 7.3 | >7 | >7 |
| 23 | Zemea ® | 20.8 | 0.5 | | | | |
| | Benzyl alcohol | 41.6 | 0.5 | | | | |
| | Lactic acid | 16.7 | 0.2 | | | | |
| | Tetrahydro | 4.2 | 0.05 | | | | |
| | curcuminoids | | | | | | |

*Control growth −1 × 10⁴-5 × 10⁴ in A. niger and 2 × 10⁷-5 × 10⁷ for all other organisms

### Example 12

The present example provides an evaluation of the synergistic activity of various fragrant and fragrant free botanicals with benzyl alcohol and Zemea® against C. albicans.

The following formulations were added to a cream. The pH was adjusted to 4.5-4.7, and the formulations were tested for preservative activity using Method 1 as described in Example 6. Non-fragrant botanicals such as pomegranate seed oil (PSO), mixtures of edible plant extract Kefiprotect (KP), tetrahydrocurcuminoid (THC), and fragrant botanicals such as lemongrass oil (LGO), basil oil (BA) and cinnamon oil (CO) were tested. The botanicals alone were dissolved in 2.5% ethanol and used in the cream for testing. The fragrant oil containing preservatives can be used in skin cleansers and shampoos.

TABLE 70

| | | | | Efficacy (log₁₀ |
|---|---|---|---|---|
| | | | | reduction from |
| | | % w/w | % w/w | control growth^{x}) |
| Preservative | Ingredient | in stock | in cream | C. Albicans |
| Fragrant | LGO | 100 | 0.3 | 4.8 |
| Preservative 25 | BO | 100 | 0.3 | 4.8 |
| | CO | 100 | 0.3 | 4.9 |
| Non-fragrant | PSO | 100 | 0.05 | 1.5 |
| Preservative 26 | PSO | 100 | 0.3 | 1.5 |
| | KP | 100 | 0.3 | 1.5 |
| | THC | 100 | 0.15 | 1.2 |
| Preservative 2 | Benzyl alcohol | 100 | 0.5 | 1.0 |
| | (natural) | | | |
| Preservative 4 | Benzyl alcohol | 38.5 | 0.5 | |
| | Zemea ® | 38.5 | 0.5 | 2.7 |
| Fragrant | LGO | 23.0 | 0.3 | |
| Preservative 4A | Benzyl alcohol | 38.5 | 0.5 | |
| | Zemea ® | 38.5 | 0.5 | 7.2 |
| Fragrant | CO | 23.0 | 0.3 | |
| Preservative 4B | Benzyl alcohol | 38.5 | 0.5 | |
| | Zemea ® | 38.5 | 0.5 | 7.2 |
| Fragrant | BO | 23.0 | 0.3 | |
| Preservative 4C | Benzyl alcohol | 38.5 | 0.5 | |
| | Zemea ® | 38.5 | 0.5 | 7.2 |
| Non-fragrant | PSO | 4.8 | 0.05 | |
| Preservative 4D | Benzyl alcohol | 47.6 | 0.5 | |
| | Zemea ® | 47.6 | 0.5 | 3.8 |
| Non-fragrant | PSO | 23.0 | 0.3 | |
| Preservative 4D-1 | Benzyl alcohol | 38.5 | 0.5 | |
| | Zemea ® | 38.5 | 0.5 | 5.6 |
| Non-fragrant | KP | 23.0 | 0.3 | |
| Preservative 4E | Benzyl alcohol | 38.5 | 0.5 | |
| | Zemea ® | 38.5 | 0.5 | 7.2 |
| Non-fragrant | THC | 9.1 | 0.15 | |
| Preservative 4F | Benzyl alcohol | 60.6 | 1.0 | |
| | Zemea ® | 30.3 | 0.5 | 7.2 |

^{x}Control growth - 1 × 10⁴-5 × 10⁴ for aspergillus and 1 × 10⁷-5 × 10⁷ for candida in all groups

Conclusion: All of the non-fragrant botanicals (anti-inflammatory agents) except PSO demonstrated synergism with the benzyl alcohol and Zemea® combination. PSO was used at very low concentration in this test.

### Example 13

The present example evaluates botanical antimicrobial and anti-inflammatory (AM-AI) compositions for use in skin cleansers and topical creams. The following Table provides a general formula for the AM-AI compositions for skin cleanser. From about 8 to about 10% is added to skin cleansers.

TABLE 71

| Ingredients | % in cleansers (w/w) |
|---|---|
| GSE | 0.1-0.5 |
| Citric acid | 0-1.0 |
| 1,3 propanediol | 0.5-5.0 |
| Benzyl alcohol | 0.25-5.0 |
| Lemongrass oil | 0-0.5 |
| Cinnamon oil | 0-0.5 |
| Orange oil | 0-0.2 |
| TetraHydrocurcuminoids | 0-0.2 |
| Alkanediols (Pentanediol, | 0-1.0 |
| Octanediol, Decanediol) | |
| Ethanol | 0-10 |

The following table provides a specific AM-AI skin cleanser formulations containing the following ingredients were prepared and tested.

TABLE 72

| Ingredients | | | | |
|---|---|---|---|---|
| (% w/w) | AM-AI - 7 | AM-AI - 16 | AM-AI - 17 | AM-AI - 18 |
| GSE | 0.2 | 0.2 | 0.5 | 0.5 |
| Lemongrass oil | 0.3 | 0.3 | 0.3 | 0.3 |
| Orange oil | 0.1 | 0.1 | 0.1 | 0.1 |
| Benzyl alcohol | 0.5 | 1.0 | 0.5 | 1.0 |
| Zemea ® | 1.0 | 1.0 | 1.0 | 1.0 |
| Citric acid | 1.0 | 1.0 | 1.0 | 1.0 |
| THC | 0 | 0.15 | 0 | 0.15 |
| Ethanol (SDA-3C) | 4.9 | 4.25 | 4.6 | 3.95 |

### Example 14

The present example provides an evaluation of rapid efficacy (30 second kill) of soaps containing various AM-AI compositions against S. aureus.

Method 2: 8% of each AM-AI formulation is added to 92% of the plain soap (commercial Softsoap®), mixed and pH is adjusted to 3.2-3.3 with NaOH. The soaps were tested for their efficacy as follows. A mixture of 0.1 ml of 108 cfu/ml of bacterial culture and 0.1 ml of bovine serum was placed in a sterile culture tube. 0.8 ml of the test soap formulation was added to the tube and vortexed for 30 seconds. 9.0 ml drug neutralizing fluid (DNF) was added to the tube to neutralize the activity of the soap, this tube was vortexed and serially diluted with DNF. 0.5 ml of the diluted solution was plated on trypticase soy agar plates, incubated at 37° C. for 24-48 hours, and the colony counts were determined. The plain soap without any AM-AI formulation and phosphate buffered saline (PBS) was also inoculated with culture and processed under similar conditions.

TABLE 73

| | Rapid antimicrobial activity (30 second Kill) |
|---|---|
| | (Test Organism S. aureus) |
| | Log10 reduction from control growth |
| Plain soap (control) | 0.6 |
| AM-AI-7 Soap | 7.2 |
| AM-AI-16 Soap | 7.2 |
| AM-AI-17 Soap | 7.2 |
| AM-AI-18 Soap | 7.2 |

Bacterial growth in Control (PBS) ranges from 1.3-1.7 × 10⁷.

### Example 15

The present example evaluates the effect of pH on the efficacy of soaps. AMI-7 and AMI-16 soaps were tested as described in Example 14.

TABLE 74

| | Rapid antimicrobial activity (30 second Kill) | | |
|---|---|---|---|
| | (Test Organism S. aureus) | | |
| | Log10 reduction from control growth | | |
| | pH 3.2 | pH 4.0 | pH 5.0 |
| AMI-7 Soap | 7.5 | 3.1 | 1.3 |
| AMI-16 Soap | 7.2 | 3.2 | 1.4 |

Conclusion: Efficacy decreases with an increase in pH. The soap compositions are more effective at pH below 5.0.

### Example 16

The present example evaluates the efficacy of soaps containing various synergistic combinations of botanicals with benzyl alcohol and Zemea® mixtures.

Botanicals such as cinnamon oil (CO), lemongrass oil (LG), basil oil, (BO), pomegranate oil (PO), and a mixture of edible plant extracts Kefiprotect (KP) were combined with synthetic benzyl alcohol (BA) and Zemea®. Ethanol (SDA 3C) was used to adjust the total amount of the composition to 6.5 gms. These formulations were incorporated into a plain soap. Their activity against S. aureus after 30 second exposure was determined using Method 2 described above. The pH of all the soaps ranged from 3.8-4.0

The following cleanser compositions were prepared and tested for efficacy after a 30 second exposure period.

TABLE 75

| | | | Activity against |
|---|---|---|---|
| | | | S. aureus |
| Soap | Ingredient | % w/w | (log₁₀ reduction) |
| Soap - L+ | LG | 0.3 | |
| | BA | 0.5 | |
| | Zemea ® | 0.5 | |
| | SDA 3C | 4.7 | |
| | Citric acid | 0.5 | |
| | Plain soap | 93.5 | 2.9 |
| Soap - B+ | BO | 0.3 | 2.7 |
| | BA | 0.5 | |
| | Zemea ® | 0.5 | |
| | SDA 3C | 4.7 | |
| | Citric acid | 0.5 | |
| | Plain Soap | 93.5 | |
| Soap - C+ | BO | 0.3 | |
| | BA | 0.5 | |
| | Zemea ® | 0.5 | |
| | SDA 3C | 4.7 | |
| | Citric acid | 0.5 | |
| | Plain Soap | 93.5 | 2.9 |
| Soap - KP+ | KP | 0.3 | |
| | BA | 0.5 | |
| | Zemea ® | 0.5 | |
| | SDA 3C | 4.7 | |
| | Citric acid | 0.5 | |
| | Plain soap | 93.5 | 2.5 |
| Soap 0 PO+ | PSO | 0.3 | |
| | BA | 0.5 | |
| | Zemea ® | 0.5 | |
| | SDA 3C | 4.7 | |
| | Citric acid | 0.5 | |
| | Plain soap | 93.5 | 2.6 |

Conclusion: All of the soap formulations showed significant activity.

### Example 16A

The present example provides formulations of soaps containing phospholipid PTM.

TABLE 76

| | | |
|---|---|---|
| Soap -LP | LG | 0.3 |
| | Orange oil | 0.1 |
| | BA | 0.5 |
| | Zemea ™ | 0.5 |
| | SDA 3C | 4.1 |
| | Phospholipid PTM | 0.5 |
| | Incroquat | 0.5 |
| | Plain soap | 93.5 |
| Soap - GP | Grapeseed oil | 0.2 |
| | BA | 0.5 |
| | Zemea ™ | 0.5 |
| | SDA 3C | 4.3 |
| | Phospholipid PTM | 0.5 |
| | Incroquat | 0.5 |
| | Plain Soap | 93.5 |
| Soap- LGP | LG | 0.30 |
| | Grape seed oil | 0.15 |
| | Orange oil | 0.1 |
| | BA | 0.5 |
| | Zemea ™ | 0.5 |
| | SDA 3C | 3.95 |
| | Phospholipid PTM | 0.5 |
| | Incroquat | 0.5 |
| | Plain soap | 93.5 |

### Example 17

The present example evaluates rapidly acting botanical AM-AI hand disinfectant lotion. The following Table provides a general formula for the AM-AI compositions comprising GSE, benzyl alcohol, Zemea, THC and a coconut based phospholipid for a hand sanitizing lotion.

TABLE 77

| Ingredients | % (w/w) |
|---|---|
| GSE | 0.2-1.0 |
| Benzyl alcohol | 0.5-2.0 |
| Zemea ® | 0.5-5.0 |
| THC | 0.02-0.2 |
| SDA 40-B Natural alcohol | 5-15 |
| Incroquat Behenyl TMS | 0-2.0 |
| Hydroxypropyl | 0.-0.5 |
| Methylcellulose (Methocel) | |
| Polyqyaternium 10 | 0.05-0.5 |
| Arlasilk phospholipid PTM | 0.5-2.0 |
| (coconut derived) | |
| Water | 30-70 |
| pH | 3.0-6.0 |

The following formulations were prepared. pH was adjusted to 5.0.

TABLE 78

| | % (w/w) | % (w/w) | % (w/w) | % (w/w) | % (w/w) | % (w/w) | % (w/w) |
|---|---|---|---|---|---|---|---|
| Ingredients | HS-1 | HS-2 | HS-3 | HS-4 | HS-5 | HS-6 | HS-7 |
| GSE | 0.5 | 0.5 | 0.5 | 0.5 | 0.5 | 0.5 | 0.2 |
| BA | 1.0 | 1.0 | 0.5 | 0.5 | 0.5 | 0.5 | 0.5 |
| Zemea ® | 1.0 | 1.0 | 0.5 | 0.5 | 0.5 | 0.5 | 0.5 |
| THC | 0.15 | 0.15 | 0.05 | 0.05 | 0.05 | 0.05 | 0.05 |
| Citric acid | 1.0 | 1.0 | — | — | — | — | — |
| LG | 0.1 | — | — | — | — | — | — |
| PO | — | 0.05 | — | — | — | — | — |
| Octoxyglycerin | — | 1.0 | — | — | — | — | — |
| SDA 40-B | 10 | 9.0 | 10 | 10 | 10 | 10 | 10 |
| Natural alcohol | | | | | | | |
| Incroquat Behenyl | 1.0 | 1.0 | 1.0 | 1.0 | — | — | — |
| TMS | | | | | | | |
| Polyquaternium 10 | 0.15 | 0.15 | 0.15 | 0.15 | 0.15 | 0.15 | 0.15 |
| Symrise PCL liquid | 1.0 | 1.0 | — | — | — | — | — |
| 100 | | | | | | | |
| Arlasilk | 0.5 | 0.5 | 1.0 | 0.5 | 1.0 | 0.5 | 1.0 |
| phospholipid PTM | | | | | | | |
| Hydroxypropyl | — | — | — | — | 0.15 | 0.15 | 0.15 |
| methylcellulose | | | | | | | |
| (Methocel) | | | | | | | |
| Water | 83.6 | 83.65 | 86.3 | 86.8 | 87.15 | 87.65 | 87.45 |

TABLE 79

| | % (w/w) | % (w/w) | % (w/w) |
|---|---|---|---|
| Ingredients | HS-8 | HS-9 | HS-10 |
| GSE | 0.5 | 0.5 | 0.5 |
| BA | 0.5 | 0.5 | 0.5 |
| Zemea ™ | 0.5 | 0.5 | 0.5 |
| THC | 0.05 | 0.05 | 0.05 |
| SDA 40-B | 10.325 | 11.95 | 11.95 |
| Natural alcohol | | | |
| Incroquat Behenyl | 0.5 | 1.0 | — |
| TMS | | | |
| U-care Jr | 0.075 | 0.15 | 0.15 |
| Arlasilk phospholipid | — | 0.5 | 0.5 |
| PTM | | | |
| Hydroxypropyl | — | — | 0.15 |
| methylcellulose | | | |
| (Methocel) | | | |
| Water | 87.55 | 84.85 | 85.7 |

Evaluation of efficacy. Method 2 was used to test these hand disinfectant lotions.

TABLE 80

| | Rapid antimicrobial activity (30 second Kill) |
|---|---|
| | (Test Organism S. aureus) |
| | Log10 reduction from control growth |
| HS-1 | 3.0 |
| HS2 | 3.3 |
| HS-3 | 4.8 |
| HS-4 | 3.5 |
| HS-5 | 4.8 |
| HS-6 | 3.8 |
| HS-7 | 4.5 |
| HS-8 | 4.7 |
| HS-9 | 6.1 |
| HS-10 | 5.6 |

Bacterial growthin Control (PBS) ranges from 2.0-2.2 × 10⁷.

### Example 18

The present example describes general and specific formulations for AM-AI compositions for topical creams.

TABLE 81

| General formula | % in cleansers (w/w) |
|---|---|
| GSE | 0.1-0.5 |
| Lactic acid | 0-0.5 |
| 1,3 propanediol (Zemea ®) | 0.5-10.0 |
| Benzyl alcohol | 0.5-5.0 |
| Lemongrass oil | 0-0.5 |
| TetraHydrocurcuminoids | 0-0.2 |

TABLE 82

| | Ingredients | % (w/w) |
|---|---|---|
| AM-AI antifungal cream 1 | White Petrolatum | 4.0 |
| | Stearyl Alcohol | 5.6 |
| | Polyquaternium 10 | 0.24 |
| | Inroquat Behenyl TMS | 2.4 |
| | Polowax N F | 2.4 |
| | Isopropyl Myristate | 3.2 |
| | Sorbitan Oleate | 1.6 |
| | Polyoxyl 40 Stearate | 1.6 |
| | Propylene Glycol | 1.6 |
| | Benzyl alcohol | 1.0 |
| | Grape seed extract | 0.2 |
| | Tetrahydrocucuminoid | 0.15 |
| | Zemea ® | 1.0 |
| | Phospholipid PTM | 0.5 |
| | Water | 74.51 |
| AM-AI antifungal cream 2 | White Petrolatum | 4.0 |
| | Stearyl Alcohol | 5.6 |
| | Polyquaternium 10 | 0.24 |
| | Inroquat Behenyl TMS | 2.4 |
| | Polowax N F | 2.4 |
| | Isopropyl Myristate | 3.2 |
| | Sorbitan Oleate | 1.6 |
| | Polyoxyl 40 Stearate | 1.6 |
| | Propylene Glycol | 1.6 |
| | Benzyl alcohol | 1.0 |
| | Grape seed extract | 0.2 |
| | Tetrahydrocucuminoid | 0.1 |
| | Kefiprotect ® | 0.1 |
| | Zemea ® | 1.0 |
| | Lactic acid | 0.5 |
| | Water | 74.46 |
| AM-AI antifungal cream 3 | White Petrolatum | 4.0 |
| | Stearyl Alcohol | 5.6 |
| | Polyquaternium 10 | 0.24 |
| | Inroquat Behenyl TMS | 2.4 |
| | Polowax N F | 2.4 |
| | Isopropyl Myristate | 3.2 |
| | Sorbitan Oleate | 1.6 |
| | Polyoxyl 40 Stearate | 1.6 |
| | Propylene Glycol | 1.6 |
| | Benzyl alcohol | 1.0 |
| | Grape seed extract | 0.2 |
| | Tetrahydrocucuminoid | 0.15 |
| | Lemongrass oil | 0.5 |
| | Zemea ® | 1.0 |
| | Lactic acid | 0.5 |
| | Octanediol | 1.0 |
| | Water | 73.01 |
| AM-AI antifungal cream 4 | White Petrolatum | 4.0 |
| | Stearyl Alcohol | 5.6 |
| | Polyquaternium 10 | 0.24 |
| | Inroquat Behenyl TMS | 2.4 |
| | Polowax N F | 2.4 |
| | Isopropyl Myristate | 3.2 |
| | Sorbitan Oleate | 1.6 |
| | Polyoxyl 40 Stearate | 1.6 |
| | Propylene Glycol | 1.6 |
| | Benzyl alcohol | 1.0 |
| | Grape seed extract | 0.2 |
| | Tetrahydrocucuminoid | 0.15 |
| | Lemongrass oil | 0.5 |
| | Zernea ® | 1.0 |
| | Octoxyglyerin | 1.0 |
| | Lactic acid | 0.5 |
| | Water | 73.01 |

### Example 19

The present example provides formulations for alcohol-based hand sanitizer compositions.

TABLE 83

| Ingredients | % in cleansers (w/w) |
|---|---|
| GSE | 0.1-0.5 |
| Lactic acid | 0-0.5 |
| 1,3 propanediol (Zemea ®) | 0.5-5.0 |
| Benzyl alcohol | 0.5-5.0 |
| Lemongrass oil | 0-0.3 |
| Octoxyglycerin | 0-3.0 |
| Ethyl alcohol | 40-70 |
| Water | 10-30 |
| TetraHydrocurcuminoids | 0-0.1 |
| Pomegranate oil | 0-0.1 |

The present example also provides formulations containing GSE, benzyl alcohol, Zemea®, THC, and a coconut based phospholipid for alcohol-based hand sanitizer (AHS) compositions.

TABLE 84

| Ingredients | % (w/w) |
|---|---|
| GSE | 0.2-1.0 |
| Lactic acid | 0.2-2.0 |
| 1,3 propanediol (Zemea ®) | 0.5-5.0 |
| Benzyl alcohol | 0.5-2.0 |
| Water | 30-70 |
| TetraHydrocurcuminoids | 0.02-0.2 |
| SDA 40-B natural alcohol | 60-80 |
| Incroquat Behenyl TMS | 0-0.3 |
| Polyquaternium 10 | 0.05-0.3 |
| Arlasilk phospholipids PTM | 0.5-2.0 |
| (coconut derived) | |
| SymsitiveTM 1609 (Symrise) | 0-1.0 |
| pH | adjusted to 3.0-6.0 |

The following specific formulations were prepared.

TABLE 85

| | % (w/w) | % (w/w) | % (w/w) | % (w/w) |
|---|---|---|---|---|
| Ingredients | AHS-1 | AHS-2 | AHS-3 | AHS-4 |
| GSE | 0.2 | 0.2 | 0.2 | 0.2 |
| Benzyl alcohol | 0.5 | 0.5 | 0.5 | 0.5 |
| Zemea ® | 0.5 | 0.5 | 0.5 | 0.5 |
| Ethyl alcohol | 67.2 | 67.2 | 67.2 | 67.2 |
| THC | 0.05 | 0.05 | 0.05 | 0.05 |
| Incroquat Behenyl TMS | — | — | 1.0 | 1.0 |
| Polyquaternium 10 | 0.1 | 0.1 | 0.1 | 0.1 |
| SymsitiveTM 1609 (Symrise) | — | 0.5 | — | 0.5 |
| Arlasilk phospholipid PTM | 1.0 | 1.0 | 1.0 | 1.0 |
| Hydroxypropyl | 0.05 | 0.05 | — | — |
| methylcellulose (Methocel) | | | | |
| Water | 30.4 | 29.9 | 29.45 | 28.95 |

Evaluation of efficacy. Method 2 was used to test these alcohol hand disinfectants.

TABLE 86

| | Rapid antimicrobial activity (15 second Kill) |
|---|---|
| | (Test Organism S. aureus) |
| | Log10 reduction from control growth |
| AHS-1 | >7.0 |
| AHS2 | >7.0 |
| AHS-3 | >7.0 |
| AHS-4 | >7.0 |

Bacterial growthin Control (PBS) ranges from 2.0-2.2 × 10⁷.

### Example 20

The present example provides a formulation for an AM-AI topical cream Acne treatment.

TABLE 87

| Ingredients | % in cleansers (w/w) |
|---|---|
| GSE | 0.1-0.5 |
| Salicylic acid | 0.5-3.0 |
| Lactic acid | 0-0.2 |
| 1,3 propanediol (Zemea ®) | 0.5-5.0 |
| Benzyl alcohol | 0.5-5.0 |
| Cinnamon oil | 0.1-0.3 |
| Octoxyglycerin | 0-3.0 |
| TetraHydrocurcuminoids | 0.04-0.2 |

### Example 21

The present example provides general and specific formulations for AM-AI veterinary products.

TABLE 88

| General Formulation | |
|---|---|
| Ingredients | % (w/w) |
| Safflower oil | 10-20 |
| Lemongrass oil | 0-0.3 |
| Water | 50-70 |
| Xanthum gum | 0-0.5 |
| Zinc lactate | 0-0.2 |
| Symrelief (Bisabolol + Ginger extract) | 0-0.2 |
| Curcumin | 0-0.2 |
| PSO | 0-0.2 |
| Benzyl alcohol | 0-5.0 |
| 1.3 propanediol | 0-5.0 |
| Calendula oil | 0.5-0.1 |
| Glycerin | 5-12 |
| Grape fruit seed extract | 0.2-3.0 |
| Lactic acid | 0.2-0.5 |
| pH adjusted with 10N NaoH | 6.5-6.7 |

TABLE 89

| Mastitits treatment lotion 1 | % (w/w) |
|---|---|
| Safflower oil | 17.0 |
| Lemongrass oil | 0.1 |
| Water | 67.75 |
| Xanthum gum | 0.45 |
| Zinc lactate | 0.2 |
| Symrelief (Bisabolol + Ginger extract) | 0.2 |
| Calendula oil | 0.5 |
| Glycerin | 10.6 |
| Grape fruit seed extract | 3.0 |
| Lactic acid | 0.2 |
| pH adjusted with 10N NaoH | 6.5-6.7 |

TABLE 90

| Mastitits treatment lotion 2 | % (w/w) |
|---|---|
| Safflower oil | 17.0 |
| Water | 66.9 |
| Xanthum gum | 0.45 |
| Hydroxycurcuminoid | 0.15 |
| Benzyl alcohol | 1.0 |
| Symrelief (Bisabolol + Ginger extract) | 0.2 |
| Calendula oil | 0.5 |
| Glycerin | 10.6 |
| Grape fruit seed extract | 3.0 |
| Lactic acid | 0.2 |
| pH adjusted with 10N NaoH | 6.5-6.7 |

TABLE 91

| Mastitits treatment lotion 3 | % (w/w) |
|---|---|
| Safflower oil | 17.0 |
| Water | 61.54 |
| Xanthum gum | 0.45 |
| Hydroxycurcuminoid | 0.15 |
| Benzyl alcohol | 1.0 |
| Pomegranate seed oil | 0.1 |
| Calendula oil | 0.5 |
| Glycerin | 10.6 |
| Grape fruit seed extract | 3.0 |
| Lactic acid | 0.2 |
| pH adjusted with 10N NaoH | 6.5-6.7 |

TABLE 92

| Mastitits treatment lotion 4 | % (w/w) |
|---|---|
| Safflower oil | 17.0 |
| Water | 68.0 |
| Xanthum gum | 0.45 |
| Hydroxycurcuminoid | 0.15 |
| Benzyl alcohol | 1.0 |
| Zemea ® | 1.0 |
| Pomegranate see oil | 0.1 |
| Calendula oil | 0.5 |
| Glycerin | 10.6 |
| Grape fruit seed extract | 1.0 |
| Lactic acid | 0.2 |
| pH adjusted with 10N NaoH | 6.5-6.7 |

The antibacterial efficacy of the Mastitis treatment lotions was evaluated using the following methodology.

Method 3. Trypticase soy agar (TSA) plates were seeded with 0.3 ml of 10⁸ cfu of bacteria/ml and dried for 10 minutes at room temperature. 0.3 ml of the lotion was uniformly applied on the surface of the plate. The plates were incubated for 1 hour at 37° C. The plate was rinsed with 9.4 ml of drug neutralizing fluid (DNF). The rinse fluid was collected and serially diluted. The dilutions were plated on TSA. The plates were then incubated at 37° C. for 24-48 hours. As a control, 0.3 ml PBS was spread uniformly on a plate and processed in the same manner as the lotion.

TABLE 93

| | Efficacy of Mastitis lotion 1 | |
|---|---|---|
| | against S. aureus | log₁₀ reduction |
| Lotion | CFU/plate | from control growth |
| Control | 3.1 × 10⁸ | — |
| Lotion 1 | 2.9 × 10⁴ | 4.3 |
| Lotion 2 | 1.8 × 10⁴ | 4.4 |

The following cow teat dip solution was prepared.

TABLE 94

| Cow teat dip solution ingredients | % (w/w) |
|---|---|
| Safflower oil | 10.0 |
| Water | 74.1 |
| Xanthum gum | 0.45 |
| Hydroxycurcuminoid | 0.15 |
| Benzyl alcohol | 1.0 |
| Zemea ® | 1.0 |
| PCL liquid 100 (Symrise) | 1.0 |
| Calendula oil | 0.5 |
| Glycerin | 10.6 |
| Grape fruit seed extract | 1.0 |
| Lactic acid | 0.2 |
| pH adjusted with 10N NaoH | 6.5-6.7 |

### Example 22

The present example provides a specific formulations for a topical cream product.

TABLE 95

| Topical cream ingredients | % (w/w) |
|---|---|
| Petrolatum | 9.68 |
| Stearyl alcohol | 14.52 |
| Isopropyl myristate | 4.84 |
| Sorbitan oleate | 2.42 |
| Polyoxy 40 stearate (Myrj 52) | 6.05 |
| Germal + | 0.3 |
| Propylene glycol | 4.0 |
| Zinc lactate | 0.2 |
| Zinc oxide | 0.3 |
| Calendula oil | 1.0 |
| Silver sulfadiazine | 1.0 |
| Benzyl alcohol | 0.5 |
| THC | 0.075 |
| 1,3 propanediol | 0.5 |
| Lactic acid | 0.06 |
| Water | 54.56 |

### Example 23

In the present example, central venous polyurethane catheters were coated with the following solution and tested for efficacy.

TABLE 96

| | A | B |
|---|---|---|
| Coating solution ingredients | % (w/w) | % (w/w) |
| Chlorhexidine | 3.5 | 2.5 |
| Silver sulfadiazine | 0.75 | 0.75 |
| Decanediol | — | 0.5 |
| 1,3 propanediol | — | 0.5 |
| Benzyl alcohol | — | 0.5 |
| THC | — | 0.05 |
| Polyurethane 60D | 1.0 | 1.0 |
| Polylurethane 93A | 4.0 | 4.0 |
| Methanol | 30 | 29.5 |
| Tetrahydrofuran | 60.75 | 59.7 |
| Lactic acid | — | 1.0 |

The catheters were tested for their antibacterial activity using the following zone of inhibition test method. Catheter segments of 0.5 cm in length were tested in vitro for their ability to inhibit microbial growth using agar diffusion assay. Test catheters segments were vertically embedded in TSA plates seeded with 10⁸ cfu/ml of bacterial culture (10⁶ cfu/ml for C. albicans). To evaluate the retention of inhibitory activity, after recording the zone of inhibition on the first day, catheter segments were transferred daily to fresh TSA plates. The zone of inhibition was then measured.

TABLE 97

| | Zone of inhibition (mm) | Zone of inhibition (mm) |
|---|---|---|
| Test organism | A | B |
| S. aureus | 11.5 | 13.5 |
| P. aeruginosa | 7.0 | 12.0 |
| C. albicans | 10.0 | 14.0 |

Conclusion: Benzyl alcohol, 1,3 propanediol and THC enhances the efficacy.

### Example 24

The present example provides an evaluation of rapid antibacterial activity by antimicrobial compositions containing benzyl alcohol, 1,3-propanediol, and botanicals (essential oils, fruit acids and botanical extracts).

Method A: 0.8 ml of a test solution was mixed with 0.1 ml of bacterial culture (10⁸ cfu/ml) and 0.1 ml of bovine serum and vortexed for 15 seconds. 9 ml of drug neutralizing Fluid (DNF) was then added and serially diluted with DNF and plated on trypticase soy agar (TSA) plates. The plates were incubated for 24-48 hours at 37° C., and colony counts were determined. For a control, a gel base was used alone. The gel base (Base 26) contains 0.2% hydroxymethylpropyl cellulose and 0.2% polyquaternium10, and 0.5% 1,3 propanediol in water.

Table 98 provides a general formulation for aqueous hand disinfectants containing benzyl alcohol, 1,3 propanediol, fruit acid, and botanicals.

TABLE 98

| Ingredients | % (w/w) |
|---|---|
| Botanical extract | 0.0-4.0 |
| Benzyl alcohol | 0.5-4.0 |
| Aliphatic alcohol (C1-4) | 0.0-10.0 |
| Fruit acid (Lactic/citric acid) | 0.2-4.0 |
| Alkylglycoside | 0.0-2.0 |
| Polyquartenium 10 | 0.0-0.2 |
| Hydroxyl propyl methyl cellulose | 0.0-0.3 |
| Water | 50.0-90.0 |
| Glycerine | 0.0-5.0 |
| Benzoic acid | 0.0-1.0 |
| Bisbolol + Ginger extract | 0.0-0.1 |

Table 99 provides specific formulations for aqueous hand disinfectants.

TABLE 99

| Ingredients | #18 | #19 | #20 | #21 | #29 |
|---|---|---|---|---|---|
| Pomegranate | 2.0 | 1.0 | 0 | 0 | 0 |
| seed oil | | | | | |
| Kefiprotect* | 0 | 0 | 2.0 | 1.0 | 4.0 |
| Benzyl alcohol | 1.0 | 2.0 | 1.0 | 2.0 | 1.0 |
| 1,3 Propanediol | 2.0 | 2.0 | 2.0 | 2.0 | 2.0 |
| Citric acid | 0.2 | 0.2 | 0.2 | 0.2 | 0.2 |
| Glucopon | 1.0 | 1.0 | 1.0 | 1.0 | 1.0 |
| 215UP | | | | | |
| SDA 3C | 8.8 | 8.8 | 8.8 | 8.8 | 7.0 |
| Base 26 | 85.0 | 85.0 | 85.0 | 85.0 | 85.0 |

*Mixture of fermented oregano and thyme plant extracts

Table 100 provides additional specific formulations for aqueous hand disinfectants containing benzyl alcohol, 1,3 propanediol, and botanicals.

TABLE 100

| Ingredients | #22 | #23 | 18LA | 18LAK | 18LAK5 |
|---|---|---|---|---|---|
| Pomegranate | 0.2 | 0 | 0 | 0 | 0 |
| seed extract | | | | | |
| Ursole | 0 | 0.2 | 0 | 0 | 0 |
| Kefiprotect | 0 | 0 | 0 | 0.024 | 1.0 |
| Grapefruit | 0 | 0 | 2.0 | 2.0 | 2.0 |
| seed extract | | | | | |
| Benzyl | 2.0 | 2.0 | 0.6 | 0.6 | 0.6 |
| alcohol | | | | | |
| 1,3 | 2.0 | 2.0 | 0.6 | 0.6 | 0.6 |
| Propanediol | | | | | |
| Citric acid | 0 | 0.2 | 0.2 | 0 | 0 |
| Lactic acid | 0 | 0 | 0.2 | 0.2 | 0.2 |
| Glucopon | 1.0 | 1.0 | 0 | 0 | 1.0 |
| 215UP | | | | | |
| SDA 40B | 7.0 | 7.0 | 9.0 | 9.0 | 8.0 |
| Water | 2.8 | 2.6 | 2.4 | 2.576 | 1.6 |
| Base 26 | 85.2 | 85.0 | 84.8 | 84.976 | 85.0 |

Table 101 provides an evaluation of the in vitro rapid (15 seconds) antibacterial efficacy of an aqueous hand disinfectant containing various Botanicals against S. aureus.

TABLE 101

| Group | log₁₀ reduction from control growth |
|---|---|
| 18 | 2.63 |
| 19 | 5.78 |
| 20 | 2.36 |
| 21 | 4.54 |
| 22 | 2.93 |
| 23 | 2.44 |
| 29 | 2.35 |
| 18LA | 7.34 |
| 18LAK | 7.5 |

Table 102 provides a general formulation for a stock solution of aqueous hand disinfectant containing higher concentrations of benzyl alcohol. The stock solution is used in various personal care products in amounts ranging from 2.0-20% (w/w).

TABLE 102

| Ingredients | % (w/w) Range |
|---|---|
| Botanical extract | 10.0-20.0 |
| Fruit acid | 0.5-4.0 |
| Benzyl alcohol | 5.0-10.0 |
| Propanediol | 5.0-10.0 |

Table 103 provides specific formulations of aqueous hand disinfectant containing higher concentrations of benzyl alcohol.

TABLE 103

| Ingredients | 18LA1 | 18LA2 | 37 | 37A |
|---|---|---|---|---|
| Grapefruit seed | 2.0 | 2.0 | 0 | 2.0 |
| exrtract | | | | |
| Benzyl alcohol | 1.0 | 0.6 | 2.0 | 2.0 |
| 1,3 Propanediol | 1.0 | 0.6 | 3.0 | 3.0 |
| Lactic acid | 0.2 | 0.2 | 2.0 | 2.0 |
| Glucopon 215UP | 1.0 | 1.0 | 1.0 | 1.0 |
| SDA 3C | 8.0 | 8.0 | 7.0 | 7.0 |
| Water | 1.8 | 2.55 | 0 | 0 |
| Symrelief | 0 | 0.05 | 0 | 0.05 |
| Base 26 | 85.0 | 85.0 | 85.0 | 82.95 |

Table 104 shows in vitro rapid kill (15 seconds) data for aqueous hand disinfectant containing higher concentrations of benzyl alcohol.

TABLE 104

| | log₁₀ reduction from control growth | | |
|---|---|---|---|
| Organism | 18LA | 18LA1 | 37 |
| E. coli | 7.06 | 7.06 | 7.80 |
| S. aureus | 7.14 | 7.14 | 4.71 |

These results demonstrate that botanicals, in particular GSE and pomegranate seed extract, show good activity when used in combination with benzyl alcohol and fruit acid. Benzyl alcohol at higher concentrations along with fruit acid are also effective without any botanical extracts.

Table 105 shows specific formulations of aqueous hand disinfectants containing higher concentrations of benzyl alcohol.

TABLE 105

| Ingredients | 18LA 4 | 18LA5 | 37B | 18LA4-S | 18LA6 | 18LA7 |
|---|---|---|---|---|---|---|
| Grapefruit | 1.0 | 1.0 | 0.0 | 1.0 | 2.0 | 0.0 |
| seed exrtract | | | | | | |
| Benzyl alcohol | 2.0 | 2.0 | 2.0 | 2.0 | 2.0 | 2.0 |
| Kefiprotect | 0 | 0 | 0 | 0 | 0 | 2.0 |
| 1,3 Propanediol | 3.0 | 3.0 | 3.0 | 3.0 | 3.0 | 3.0 |
| Lactic acid | 2.0 | 2.0 | 2.0 | 2.0 | 2.0 | 2.0 |
| Glucopon | 1.0 | 1.0 | 1.0 | 1.0 | 1.0 | 1.0 |
| 215UP | | | | | | |
| SDA 3C | 6.0 | 0 | 0 | 6.0 | 10.0 | 10.0 |
| Water | 0 | 6.0 | 7.0 | 0 | 0 | 0 |
| Base 26 | 85.0 | 85.0 | 85.0 | 84.95 | 80.0 | 80.0 |
| Symrelief | 0 | 0 | 0 | 0.05 | 0 | 0 |

### Example 25

The present example provides an evaluation of synergistic antibacterial activity of the combination of (1) benzyl alcohol and fruit acids; and (2) benzyl alcohol and biguanides or benzalkonium chloride with and without fruit acids.

The present example evaluates rapid (15 seconds) antibacterial activity of various agents, alone and in combination, in an aqueous gel base (Base 26) using S. aureus as the test organism. One method of testing (Method A) uses 0.8 ml of the test solution mixed with 0.1 ml of bacterial culture (10⁸ cfu/ml) and 0.1 ml of Bovine serum. The solution is vortexed for 15 seconds. 9.0 ml of drug neutralizing Fluid (DNF) is then added and then serially diluted with DNF and plated on TSA plates. Plates are incubated for 24-48 hours at 37° C. and colony counts were determined. For A control, the base was used alone.

Table 106 provides rapid antibacterial activity (log₁₀ reduction from the control growth) with the organism S. aureus.

TABLE 106

| Group (% w/w) | log₁₀ reduction |
|---|---|
| Benzyl alcohol 0.5 | 0.13 |
| Benzyl alcohol 1.0 | 0.14 |
| Benzyl alcohol 2.0 | 0.18 |
| Benzyl alcohol 3.0 | 0.2 |
| 1,3 Propanediol 3.0(PD) | 0.2 |
| Lactic acid (LA) 0.2 | 0.1 |
| Lactic acid 2.0 | 0.11 |
| Citric acid (CA) 0.2 | 0.1 |
| BA0.5 + LA0.2 | 0.10 |
| BA0.5 + LA 2.0 | 0.13 |
| BA1.0 + LA 2.0 | 1.93 |
| BA2.0 + LA2.0 | 4.21 |
| BA3.0 + LA0.2 | 3.24 |
| BA3.0 + LA2.0 | 4.4 |
| BA3.0 + CA0.2 | 2.9 |
| PD 3.0 + LA 0.2 | 0.5 |
| BA3.0 + PD3.0 + LA0.2 | 3.24 |
| BA3.0 + PD3.0 + LA2.0 | 4.4 |
| BA2.0 + PD3.0 + LA2.0 | 4.21 |
| BA 6.0 + PD 6.0 + LA 2.0 | 7.0 |
| Benzalkonium chloride (BZK) 0.1 | 2.7 |
| BZK0.1 + citric acid0.2 | 2.2 |
| PD3.0 + BZK0.1 + Citric0.2 | 1.9 |
| BA3.0 + PD3.0 + citric0.2 | 2.7 |
| BA3.0 + PD3.0 + BZK0.1 | 2.69 |
| BA3.0 + Citric0.2 + BZK0.1 | 7.3 |
| BA3.0 + PD3.0 + citric0.2 + BZK0.1 | 7.3 |
| BA3.0 + PD3.0 + lactic0.2 + BZK0.1 | 7.5 |
| Chlorhexidine gluconte (CHG) 0.2 | 1.43 |
| Chlorhexidine gluconate 0.5 | 2.4 |
| BA3.0 + PD3.0 + lactic acid0.2 + CHG0.2 | 4.97 |
| BA3.0 + PD3.0 + lactic acid0.2 + CHG 0.5 | 7.37 |

The data demonstrates the following. Benzyl alcohol at 1% and more than 1% exhibits synergistic activity with citric and lactic acid. 1,3 propanediol makes the solution clear and stable. Benzalkonium chloride (BZK) and chlorhexidine exhibit synergistic activity with benzyl alcohol and fruit acids.

Table 107 provides the results from the evaluation of synergistic antibacterial activity of benzyl alcohol and various organic acids.

TABLE 107

| Groups (% w/w) | log₁₀ reduction |
|---|---|
| Benzyl alcohol 2.0 | 0.12 |
| Benzoic acid 2.0 | 0.1 |
| Benzylalcohol2.0 + benzoic acid2.0 | 6.2 |
| Ascorbic acid2.0 | 0.1 |
| Benzyl alcohol + ascorbic acid2.0 | 0.1 |
| Lactic acid 2.0 | 0.11 |
| BA2.0 + LA2.0 | 4.21 |
| Benzoicacid2.0 + Lactic acid 2.0 | 0.1 |
| Benzoic 1.0 + Lactic1.0 + benzyl alcohol 2.0 | 4.0 |

The data demonstrates that benzoic acid, lactic acid and combinations thereof exhibit synergistic activity with benzyl alcohol. The organic acid ascorbic acid was not effective in this regard.

### Example 26

The present Example evaluates a rapidly acting aqueous hand disinfectant containing synergistic combinations of benzyl alcohol, fruit acid, with or without benzalkonium chloride. The following Table provides a summary of a general formulation of such compounds.

TABLE 108

| Ingredients | % Range |
|---|---|
| Benzyl alcohol | 1.0-5.0 |
| 1,3 Propanediol | 1.0-5.0 |
| Fruitacid | 0.2-2.0 |
| Benzalkonium chloride | 0.0-0.12 |
| Alcohol | 0.0-10.0 |
| Polyquartenium 10 | 0.0-0.2 |
| Hydroxypropyl methyl cellulose | 0.0-0.3 |
| Glycerine | 0.0-0.5 |
| Bisbolol + Ginger extract (Symrelief) | 0.0-0.1 |
| Water | 50.0-90.0 |

Table 109 provides below specific formulations for compositions of aqueous hand disinfectants.

TABLE 109

| | % (w/w) | | | | |
|---|---|---|---|---|---|
| Ingredients | 28 | A | D | 28 B | 28C |
| Benzalkonium chloride | 0.1 | 0.1 | 0.1 | 0.1 | 0.1 |
| Benzyl alcohol | 3.0 | 3.0 | 0 | 3.0 | 3.0 |
| 1,3 propanediol | 3.0 | 0 | 0 | 4.0 | 4.0 |
| Citric acid | 0.2 | 0.2 | 0 | 0 | 0 |
| Lactic acid | 0 | 0 | 0 | 0.2 | 0.2 |
| SDA 3C | 7.0 | 7.0 | 7.0 | 7.0 | 7.0 |
| Base 26 | 84.9 | 85.0 | 85.0 | 85.0 | 85.0 |
| Water | 1.8 | 4.7 | 7.9 | 0.7 | 0.65 |
| Symreleif | 0 | 0 | 0 | 0 | 0.05 |

The data demonstrate that the combination of benzyl Alcohol, propanediol, citric acid, and benzalkonium chloride is more effective than benzalkonium chloride alone.

Tables 110 and 111 provide an evaluation of the in vitro rapid (15 seconds) antibacterial efficacy of aqueous hand disinfectant.

TABLE 110

| | Test organism 1 × 10⁸ |
|---|---|
| | cfu/ml S. aureus |
| | log₁₀ reduction from |
| Group | control growth S. aureus |
| A | 6.48 |
| D | 3.16 |
| 28 | 5.48 |
| 28B | 6.63 |

TABLE 111

| | Test organism 1 × 10⁸ cfu/ml | |
|---|---|---|
| | log₁₀ reduction from control growth | |
| Group | S. aureus | P. aeruginosa |
| 28B | 6.63 | 8.22 |

### Example 27

The present Example evaluates the activity of rapidly acting hand disinfectant soaps containing benzyl alcohol, propanediol, and fruit acid (BPF) with or without benzalkonium or triclosan. The method of testing is same method as described above as Method A, however using 10⁹ organism instead 10⁸. Table 112 summarizes a general formulation for the compositions of hand disinfectant soaps.

TABLE 112

| Ingredients | % Range |
|---|---|
| Benzyl alcohol | 1.0-3.0 |
| 1,3 Propanediol | 1.0-5.0 |
| Fruitacid | 0.2-2.0 |
| Triclosan | 0.0-0.5 |
| Biguanide | 0.0-0.5 |
| Benzalkonium chloride | 0.1-0.12 |
| Benzethonium chloride | 0.0-0.18 |
| Phenoxyethanol | 0.0-1.0 |
| IncromineoxideL | 5.0-15.0 |
| Montaline C 40 | 5.0-10.0 |
| Crosultane C 50 | 3.0-5.0 |
| Nonionic surfactant | 0.5-5.0 |
| Dipropylene glycol | 0.0-5.0 |
| Diglycerol | 0.0-5.0 |
| Glycerine | 0.0-5.0 |
| Water | 40.0-80.0 |

Table 113 provides certain specific formulas of hand disinfectant soaps.

TABLE 113

| | % (w/w) | | | | | |
|---|---|---|---|---|---|---|
| | 14 | | | 15 | 16 | 14 |
| Ingredients | (BPC) | 14Tc | 14BZT | (Tc) | (Citric) | (BZK) |
| Citric acid | 1.0 | 1.0 | 1.0 | 1.0 | 1.0 | 1.0 |
| Benzyl alcohol | 2.0 | 2.0 | 2.0 | 2.0 | 0 | 2.0 |
| Propane diol | 1.0 | 1.0 | 1.0 | 1.0 | 0 | 1.0 |
| Phenoxy ethanol | 1.0 | 1.0 | 1.0 | 1.0 | 0 | 1.0 |
| SDA 40 B | 10 | 10 | 10 | 10 | 10 | 10 |
| Triclosan | 0 | 0.15 | 0 | 0.15 | 0 | 0 |
| Benzethonium | 0 | 0 | 0.18 | 0 | 0 | 0 |
| chloride | | | | | | |
| Benzalkonium | 0 | 0 | 0 | 0 | 0 | 0.1 |
| chloride | | | | | | |
| Water | 58 | 57.85 | 57.82 | 57.85 | 62 | 57.9 |
| Incromine oxide | 13 | 13 | 13 | 13 | 13 | 13 |
| Montalene | 5 | 5 | 5 | 5 | 5 | 5 |
| Dipropylene | 5 | 5 | 5 | 5 | 5 | 5 |
| glycol | | | | | | |
| Crosultane C-50 | 3 | 3 | 3 | 3 | 3 | 3 |
| Pluronic F 87 NF | 1 | 1 | 1 | 1 | 1 | 1 |

Table 114 provides an evaluation of the in vitro rapid (15 seconds) antibacterial efficacy of hand disinfectant soap against S. aureus.

TABLE 114

| | Log₁₀ reduction from |
|---|---|
| Group | control growth |
| 14 (BPC) | 5.32 |
| 14TC | 8.4 |
| 14BZT | 7.5 |
| 15 (TC) | 0.5 |
| 16 (Citric) | 0.3 |
| BZK A | 4.14 |
| 14BZK | 6.60 |

In Table 114, “BZK A” is the soap formulation containing 14BZK except BPF and phenoxyethanol. “TC” is triclosan. “The data demonstrate that triclosan and BZK exhibits synergistic action with BPC. “BZT” is benzethonium chloride. “BZK” is benzalkonium chloride. “BPF” is the combination of benzyl alcohol, propanediol, and fruit acid. “BPC” is the combination of benzyl alcohol, propanediol, and citric acid.

### Example 28

The present example relates to an alcohol based hand disinfectant containing benzyl alcohol, propanediol and lactic acid (BPL). Table 115 below provides the general formula for such alcohol based hand disinfectants.

TABLE 115

| Ingredients | % w/w |
|---|---|
| Benzyl alcohol | 1-5 |
| 1,3 propanediol (Zemea) | 1-5 |
| Lactic acid | 0.2-4 |
| Benzoic acid | 0-2 |
| Grape fruit seed extract | 0.2-2 |
| Chlorhexidine gluconate | 0-0.2 |
| Polyhexamethyl biguanide (PHMB) | 0-0.3 |
| Octanediol | 0-1.0 |
| Aliphatic Alcohol | 60-70 |
| Water | 20-30 |
| Polyquartenium 10 | 0.1-0.3 |
| Hydroxypropyl methy cellulose | 0.1-0.3 |
| Symrelief | 0-0.1 |
| Aloe barbadensis juice | 0-1.0 |

Table 116 provides for specific compositions of alcohol based hand sanitizers (ABHS).

TABLE 116

| | % (w/w) | | | | | | |
|---|---|---|---|---|---|---|---|
| | | | | | | ABHS - | ABHS- |
| Ingredients | A-4 | B-4 | C-4 | D-4 | E-4 | 5 | 6 |
| Benzyl alcohol | 1 | 1 | 1 | 1 | 1 | 1 | 1 |
| Zemea | 1 | 1 | 1 | 1 | 1 | 3 | 3 |
| Lactic acid | 2.0 | 0.2 | 0.2 | 0.2 | 0 | 0 | 0 |
| Grape fruit | 0.2 | 0.2 | 0 | 0 | 0 | 0 | 0 |
| seed extract | | | | | | | |
| Chlorhexidine | 0 | 0 | 0.2 | 0 | 0 | 0 | 0 |
| gluconate | | | | | | | |
| Polyhexamethyl | 0 | 0 | 0 | 0 | 0 | 0.3 | 0.3 |
| biguanide | | | | | | | |
| (PHMB) | | | | | | | |
| Octanediol | 0 | 0 | 0 | 0.5 | 0.5 | 0 | 0 |
| Lactic acid | 0 | 0 | 0 | 0 | 0.2 | 0.2 | 2.0 |
| SDA 3C alcohol | 67.2 | 67.2 | 67.2 | 67.2 | 67.2 | 67.2 | 67.2 |
| Water | 28.2 | 30 | 30 | 29.7 | 29.7 | 27.9 | 26.05 |
| Polyquartenium | 0.2 | 0.2 | 0.2 | 0.2 | 0.2 | 0.2 | 0.2 |
| 10 | | | | | | | |
| Hydroxypropyl | 0.2 | 0.2 | 0.2 | 0.2 | 0.2 | 0.2 | 0.2 |
| methy cellulose | | | | | | | |
| Symrelief | 0 | 0 | 0 | 0 | 0 | 0 | 0.05 |

Table 117 provides an evaluation of the in vitro rapid (15 second) antibacterial efficacy of alcohol based hand disinfectants against MRSA.

TABLE 117

| | log₁₀ reduction from |
|---|---|
| Group | control growth |
| A-4 | >8.0 |
| B-4 | >8.0 |
| C-4 | >8.0 |
| D-4 | >8.0 |
| E-4 | >8.0 |

Table 118 provides the data for in vitro rapid kill (15 seconds) by ABHS 5.

TABLE 118

| | FDA TFM Method | |
|---|---|---|
| | Log₁₀ reduction from | % |
| Organism | control growth | kill |
| MRSA | 8.05 | 100 |
| S. aureus | 8.45 | 100 |
| P. aeruginosa | 8.20 | 100 |
| E. coli | 8.57 | 100 |
| K. pneumonia | 3.84 | 99.98 |

### Example 29

The present example relates to alcohol-based broad spectrum rapidly acting wash off hand disinfectant containing BPL.

Regular and proper hand washing has been emphasized as an important infection control strategy by the Centers for Disease Control and Prevention. Increased compliance with hand washing has been shown to significantly reduce carriage of potential pathogens on the hands of healthcare workers and has resulted in a significant reduction in nosocomial infection. Studies show that the rate of handwashing compliance is lower than 50%. To address these problems, the use of alcohol-based sanitizers containing emollients has been recommended. In addition to saving time, the use of alcohol-based products was reported to be more effective than soap and water in reducing infections; however, alcohol-based hand rub is not an option if the hands are visibly soiled or contaminated with proteins and organic matter. See Girou et al, BMJ 325:362-367 (2002); Hilburn et al., Am. J. Infect, Control 31:109-116 (2003). Hand hygiene guidelines for healthcare personnel published by the Centers for Disease Control and Prevention recommend that alcohol-based hand gels and foams be used routinely, with intermittent thorough hand washing with soaps throughout the day. Furthermore Alcohol-based products, have very poor activity against bacterial spores such as Clostridium difficile and against certain nonenveloped viruses. It has been reported that C. difficile infection, which is associated with diarrhea, is frequently transmitted among hospitalized patients via the hands of healthcare workers caring for such patients. Washing with soap can remove pathogens from the hands of hospital personnel.

To address this problem, an alcohol-based rinse off hand disinfectant has been developed, which contains the rapidly acting alcohol (60%), a rinse off cleansing disinfectant containing synergistic combination of combination of Benzyl alcohol and fruit acid, emollients and foaming agents. When this product is applied on the hand the alcohol rapidly inactivates the pathogens and evaporates off within a minute. Then the hand is lathered with water for 15 seconds and then rinsed off.

The compositions in the present Example are alcohol based broad spectrum rapidly acting wash off hand disinfectant. Table 119 provides the general formula for the compositions containing BPL.

TABLE 119

| Ingredients | % w/w |
|---|---|
| Aliphatic alcohol (C1-6) | 60-70 |
| Hydroxy propyl cellulose | 0.5-1.0 |
| Incroquat Behenyl TMS 50 | 0.2-1.0 |
| Benzyl alcohol | 1.0-5.0 |
| 1,3 Propanediol | 1.0-5.0 |
| Glycerine | 1.0-5.0 |
| Water | 5.0-20.0 |
| Lactic acid | 0.2-2.0 |
| Benzoic acid | 0-1.0 |
| Incromine oxide L | 3.0-10 |
| Pluronic F87 NF | 0.5-2.0 |
| Cocoamidopropyl betaine | 5.0-10.0 |
| Masil SF 19 | 0.5-2.0 |
| Aloe barbadensis Juice | 0.5-20 |
| Symrelief | 0-0.1 |

Table 120 provides specific formulations for the alcohol-based, wash-off, hand disinfectants.

TABLE 120

| Ingredients | 2A | 2B | 2C | 2D |
|---|---|---|---|---|
| SDA 40 B | 64.84 | 64.84 | 64.84 | 64.84 |
| Klucel | 0.5 | 0.5 | 0.5 | 0.5 |
| Benzyl alcohol | 2.0 | 2.0 | 2.0 | 2.0 |
| 1,3 Propanediol | 2.0 | 3.0 | 2.0 | 5.0 |
| Phenoxyethanol | 1.0 | 1.0 | 1.0 | 1.0 |
| Glycerine | 1.0 | 1.0 | 3.0 | 3.0 |
| Water | 10.66 | 9.66 | 6.56 | 3.56 |
| Citric acid | 1.0 | 1.0 | 1.0 | 1.0 |
| Incromine oxide | 8.0 | 8.0 | 8.0 | 8.0 |
| L | | | | |
| Pluronic F87 NF | 1.0 | 1.0 | 1.0 | 1.0 |
| Cocamidopropyl | 8.0 | 8.0 | 8.0 | 8.0 |
| betaine | | | | |
| Masil SF 19 | — | — | 1.0 | 1.0 |
| Aloe | — | — | 1.0 | 1.0 |
| barbadensis | | | | |
| juice | | | | |
| Symrelief | — | — | 0.1 | 0.1 |

Table 121 provides compositions of alcohol based broad spectrum rapidly acting wash off hand disinfectant.

TABLE 121

| Ingredients | 3C | 3D | 4C | 4D | 5C | 5D |
|---|---|---|---|---|---|---|
| SDA 40 B | 64.84 | 64.84 | 64.84 | 64.84 | 64.84 | 64.84 |
| Klucel | 1.0 | 1.0 | 0.5 | 0.5 | — | — |
| K₄M | — | — | 0.3 | 0.3 | 0.3 | 0.3 |
| Polyquartenium10 | — | — | — | — | 0.2 | 0.2 |
| Benzyl alcohol | 2.0 | 2.0 | 2.0 | 2.0 | 2.0 | 2.0 |
| 1,3 Propanediol | 2.0 | 5.0 | 2.0 | 5.0 | 2.0 | 5.0 |
| Phenoxyethanol | 1.0 | 1.0 | 1.0 | 1.0 | 1.0 | 1.0 |
| Glycerine | 3.0 | 3.0 | 3.0 | 3.0 | 3.0 | 3.0 |
| Water | 6.06 | 3.06 | 6.26 | 3.26 | 6.56 | 3.56 |
| Citric acid | 1.0 | 1.0 | 1.0 | 1.0 | 1.0 | 1.0 |
| Incromine oxide L | 8.0 | 8.0 | 8.0 | 8.0 | 8.0 | 8.0 |
| Pluronic F87 NF | 1.0 | 1.0 | 1.0 | 1.0 | 1.0 | 1.0 |
| Cocamidopropyl | 8.0 | 8.0 | 8.0 | 8.0 | 8.0 | 8.0 |
| Beataine | | | | | | |
| Masil SF 19 | 1.0 | 1.0 | 1.0 | 1.0 | 1.0 | 1.0 |
| Aloe barbadensis | 1.0 | 1.0 | 1.0 | 1.0 | 1.0 | 1.0 |
| Juice | | | | | | |
| Symrelief | 0.1 | 0.1 | 0.1 | 0.1 | 0.1 | 0.1 |

Table 122 provides a composition of an alcohol based broad spectrum rapidly acting wash off hand disinfectant (ABHS 5-E).

TABLE 122

| ABHS 5-E Ingredients | % w/w |
|---|---|
| SDA 40 B | 64.84 |
| Hydroxy propyl cellulose | 1.0 |
| Incroquat Behenyl TMS 50 | 0.5 |
| Benzyl alcohol | 2.0 |
| 1,3 Propanediol | 5.0 |
| Glycerine | 3.0 |
| Water | 6.56 |
| Lactic acid | 1.0 |
| Incromine oxide L | 5.0 |
| Pluronic F87 NF | 1.0 |
| Cocoamidopropyl betaine | 8.0 |
| Masil SF 19 | 1.0 |
| Aloe barbadensis Juice | 1.0 |
| Symrelief | 0.1 |

Table 123 provides the results from an in vitro rapid kill (15 seconds) of ABHS 5E.

TABLE 123

| | FDA TFM Method | |
|---|---|---|
| | log₁₀ reduction | % |
| Organism | from control growth | kill |
| MRSA | 8.05 | 100 |
| S. aureus | 8.45 | 100 |
| P. aeruginosa | 8.20 | 100 |
| E. coli | 8.57 | 100 |

### Example 30

The present Example provides a surface disinfectants composition containing benzyl alcohol, fruit acid and biguanide. Table 124 provides the general formulation for such compounds.

TABLE 124

| Ingredient | % w/w |
|---|---|
| Vantocil | 0.1-0.5 |
| Glucopon (alkyl Polyglycoside) | 0.5-3.0 |
| Lactic acid | 0.2-2.0 |
| Citric acid | 0-2.0 |
| Benzoic acid | 0-1.0 |
| Benzyl alcohol | 0.5-10.0 |
| Aliphatic Alcohol | 0-10 |
| Water | 80-95 |

An evaluation of synergistic activity was carried out of biguanide (Vantocil), benzyl alcohol, and fruit acids. The following ingredients were added in a surfactant base containing water and alkyl polyglycoside surfactant (Glucopon) (Table 125).

TABLE 125

| Ingredient | S5 | S7 | S8 | S9 |
|---|---|---|---|---|
| Vantocil | 0.15 | 0.15 | 0.15 | — |
| Glucopon | 1.0 | 1.0 | 1.0 | 1.0 |
| Lactic acid | — | 0.2 | 0.2 | 0.2 |
| Benzyl | — | — | 1.0 | 1.0 |
| alcohol | | | | |
| Water | 98.85 | 98.65 | 97.65 | 97.8 |

Table 126 provides the dadta for an in vitro rapid (15 second) antibacterial efficacy of surface disinfectants against S. aureus.

TABLE 126

| | Log₁₀ reduction |
|---|---|
| Groups | from control |
| S5 | 0.84 |
| S7 | 2.67 |
| S8 | 4.16 |
| S9 | 1.20 |

The data shows that Vantocil exhibits synergistic activity with benzyl alcohol and lactic acid. Table 87 provides a further evaluation of synergistic activity of biguanide (Vantocil), benzyl alcohol, and fruit acids. The following ingredients were added in a surfactant base containing water and alkyl polyglycoside surfactant (Glucopon) (Table 127).

TABLE 127

| | % w/w | | | | | | | | |
|---|---|---|---|---|---|---|---|---|---|
| Ingredient | T1 | T2 | T3 | T4 | T5 | B7 | B 8 | T8 | T9 |
| Vantocil | 0.3 | 0.15 | 0.15 | 0.15 | 0.15 | 0.15 | 0.15 | — | — |
| Glucopon | 1.0 | 1.0 | 1.0 | 1.0 | 1.0 | 1.0 | 1.0 | 1.0 | 1.0 |
| Citric acid | — | 2.0 | — | 2.0 | — | 2.0 | — | — | 2.0 |
| Lactic acid | — | — | 2.0 | — | 2.0 | — | 2.0 | — | — |
| Benzyl alcohol | — | — | — | 1.0 | 1.0 | 2.0 | 2.0 | 2.0 | 2.0 |
| SDA 3C | 7.0 | 7.0 | 7.0 | 7.0 | 7.0 | 7.0 | 7.0 | 7.0 | 7.0 |
| Water | 91.7 | 89.85 | 89.85 | 88.85 | 88.85 | 87.85 | 87.85 | 90.0 | 88.0 |

Table 128 provides the results from an in vitro rapid (15 second) antibacterial efficacy of surface disinfectants against S. aureus.

TABLE 128

| | Log₁₀ reduction |
|---|---|
| Groups | from control |
| T1 | 2.80 |
| T2 | 2.95 |
| T3 | 3.02 |
| T4 | 4.12 |
| T5 | 4.03 |
| B7 | 5.45 |
| B8 | 7.28 |
| T8 | 1.41 |
| T9 | 1.83 |

Conclusion: Vantocil exhibits synergistic activity with Benzyl alcohol and fruit acids

### Example 31

The present example evaluates an antifungal diaper rash cream/antifungal skin cream containing BPL. This cream contains the following agents in a hydrophilic cream base benzyl alcohol, tetrahydrocurcuminoid, fruit acid and chemical antibacterial miconazole, and preservative levels of chlorhexidine and BZK. Table 129 provides the formulation for antifungal skin cream 27.

TABLE 129

| | |
|---|---|
| 1. Water | 65.02 |
| 2. Zinc gluconate | 0.10 |
| 3. Polyquartenium 10 | 0.24 |
| 4. Incroquat Behenyl TMS | 3.2 |
| 5. Polawax | 3.2 |
| 6. Petroleum Jelly | 4.7 |
| 7. Stearyl alcohol | 7.4 |
| 8. Myrj 52 | 2.8 |
| 9. Zinc Oxide | 0.20 |
| 10. Propylene Glycol | 2.0 |
| 11. Isopropyl Myristate | 3.30 |
| 12. Sorbitan Oleate | 1.50 |
| 13. Miconazole | 2.0 |
| 14. Dipropyleneglycol | 2.0 |
| 15. Benzyl alcohol | 0.8 |
| 16. 1,3 Propanediol (Zemea) | 0.5 |
| 17. Tetrahydrocurcuminoid | 0.05 |
| 18. Octanediol | 0.5 |
| 19. Lactic acid (88% active) | 0.2 |
| 20. Benzalkonium chloride (Powder) | 0.09 |
| 21. Chlorhexidine gluconate | 0.2 |

An evaluation of the efficacy of the ntifungal cream- (AF-27) and miconazole cream (AF-M) was carried out. AF-M 2% Miconazole was added to the same cream base as 27 except it does not contain Sand 15-21.

Method C: Zone of inhibition (test organism C. albicans ATCC #11651). Table 130 provides the data for the zone of inhibition.

TABLE 130

| | Zone of Inhibition (mm) | |
|---|---|---|
| Groups | C. albicans | A. niger |
| AF-Z27 | 19.5 | 19.5 |
| AF-M | 12.0 | 9.0 |

Method D: Evaluation of efficacy in pig skin method (test organism C. albicans). Pigskin pieces were soaked in Candida albicans culture (10⁷ cfu/ml) and incubated at 37° C. for 3 hours. The pigskins were removed, blotted with kimwipes, and each piece was covered with the cream and incubated at 37° C. for 3 hours. At the end of incubation, DNF (drug neutralizing fluid) was added to each piece, mixed to remove the cream and loosely adhered bacteria on the skin.

Loosely adhered organism: The fluid containing the cream was removed, serially diluted with DNF and aliquots plated on TSA and incubated for 24-48 hours and colonies were counted.

Tightly adhered organism: DNF was added to the rinsed pigskin and sonicated for 20 minutes to remove the tightly adhered bacteria. The fluid after sonication was serially diluted, plated on TSA and, incubate for 24-48 hours and colony counts were determined. Table 131 provides the evaluation of efficacy in the pig skin method (test organism C. albicans).

TABLE 131

| | Loosely attached | Tightly adhered |
|---|---|---|
| | organism | organism |
| Groups | log₁₀ reduction from control | |
| AF-27 | 3.31 | 3.9 |
| AF-M | 0.54 | 0.27 |

Method E: In vitro efficacy of AF creams against Aspergillus niger. Cream was inoculated with A. niger culture (10⁵ cfu/gm) mixed well and incubated at 30° C. for 24 hours. At the end of the incubation period, DNF was added, mixed, serially diluted with DNF and plated on TSA for 30° C. for 24-48 hours and colony counts were determined. Table 132 provides the efficacy data of AF creams on A. niger (24 hours incubation).

TABLE 132

| | log₁₀ reduction |
|---|---|
| Groups | from control |
| AF-Z27 | 4.92 |
| AF-M | 0.65 |

Conclusion: Antifungal activity of miconazole can be significantly enhanced by the use of synergistic combination of benzyl alcohol, fruit acid, biguanide and benzalkonium chloride.

### Example 32

The present Example provides various formulations for antifungal diaper rash creams.

TABLE 133

| Ingredients | 28S | 29S | 30 | 31A | 31B | 32 | 33A | 33B |
|---|---|---|---|---|---|---|---|---|
| Water | 49.21 | 43.21 | 41.85 | 36.15 | 36.25 | 41.8 | | |
| Zinc gluconate | 0.10 | 0.1 | 0.1 | 0.2 | 0.2 | 0.2 | 0.4 | 0.4 |
| Polyquartenium 10 | 0.24 | 0.24 | — | — | — | — | — | — |
| Incroquat Behenyl TMS | 3.2 | 3.2 | 3.6 | — | — | — | — | — |
| Polawax | 3.2 | 3.2 | — | — | — | — | — | — |
| Mineral oil | — | — | 2.0 | — | — | — | — | — |
| White petrolatum | — | — | — | 11.0 | 11.0 | 10.0 | 47.05 | 46.95 |
| Petroleum Jelly | 4.7 | 5.6 | 5.6 | — | — | — | — | — |
| Stearyl alcohol | 7.4 | 8.9 | 8.9 | 16.0 | 16.0 | 9.0 | 16.0 | 16.0 |
| Myrj 52 [Polyoxyl40] | 2.8 | 3.4 | 3.4 | 6.7 | 6.7 | 6.5 | 6.7 | 6.7 |
| Zinc Oxide | 3.0 | 5.0 | 10.0 | 10.0 | 10.0 | 5.0 | 10.0 | 10.0 |
| Propylene Glycol | 2.0 | 2.0 | 2.0 | | | | | |
| Isopropyl Myristate | 3.30 | 4.0 | — | 6.0 | 6.0 | 6.0 | 6.0 | 6.0 |
| Sorbitan Oleate | 1.50 | 1.8 | — | 2.7 | 2.7 | 2.7 | 2.7 | 2.7 |
| Cetearyl alcohol | — | — | 4.4 | — | — | — | — | — |
| Popyleneglycol | — | — | 5.0 | — | — | — | — | — |
| Zinc stearate | 2.0 | 2.0 | 2.0 | 4.0 | 4.0 | 4.0 | 4.0 | 4.0 |
| Miconazole | 2.0 | 2.0 | 2.0 | 2.0 | 2.0 | 2.0 | 2.0 | 2.0 |
| Dipropyleneglycol | 2.0 | 2.0 | 2.0 | — | — | — | — | — |
| Benzyl alcohol | 0.8 | 0.8 | 0.8 | 1.0 | 1.0 | 0.8 | 1.0 | 1.0 |
| 1,3 Propanediol (Zemea) | 0.5 | 0.5 | 0.5 | 3.0 | 3.0 | 0.5 | 3.0 | 3.0 |
| Tetrahydrocurcuminoid | 0.05 | 0.05 | 0.05 | 0.05 | 0.05 | 0.05 | 0.05 | 0.05 |
| Octanediol | 0.5 | 0.5 | 0.5 | — | — | — | — | — |
| Lactic acid (88% active) | 0.2 | 0.2 | 0.2 | 1.0 | 1.0 | 0.2 | 1.0 | 1.0 |
| Benzalkonium chloride | 0.1 | 0.1 | 0.1 | — | 0.1 | 0.1 | 0.1 | — |
| (Powder) | | | | | | | | |
| Chlorhexidine gluconate | 0.2 | 0.2 | 0.2 | 0.2 | — | — | — | 0.2 |
| Calendula oil | 1.0 | 1.0 | 1.0 | — | — | 1.0 | — | — |
| Silicone D C 1403 | 5.0 | 5.0 | — | — | — | 5.0 | — | — |
| Silicone D C 3225 C | 5.0 | 5.0 | — | — | — | 5.0 | — | — |
| Butyleneglycol | — | — | 2.0 | — | — | — | — | — |
| Sorbitan Oleate | — | — | 1.8 | — | — | — | — | — |

### Example 33

The Example provides the formulation for an anti-bacerial first aid cream containing BPL.

TABLE 134

| Ingredients | % (w/w) |
|---|---|
| Water | 65.51 |
| Zinc gluconate | 0.20 |
| Polyquartenium 10 | 0.24 |
| Incroquat Behenyl TMS | 3.2 |
| Polawax | 3.2 |
| Petroleum Jelly | 4.7 |
| Stearyl alcohol | 7.4 |
| Myrj 52 | 2.8 |
| Zinc Oxide | 0.50 |
| Propylene Glycol | 2.0 |
| Isopropyl Myristate | 3.30 |
| Sorbitan Oleate | 1.50 |
| Dipropyleneglycol | 2.0 |
| Benzyl alcohol | 0.8 |
| 1,3 Propanediol (Zemea) | 0.5 |
| Tetrahydrocurcuminoid | 0.05 |
| Octanediol | 0.5 |
| Lactic acid (88% active) | 0.2 |
| Calendula oil | 1.0 |
| Benzalkonium chloride (Powder) | 0.1 |
| PHMB | 0.3 |

### Example 34

The present Example evaluates various antimicrobial/wound healing topical creams containing BPL and botanicals. Table 135 provides a summary of the cream formulations.

TABLE 135

| | % w/w | | | |
|---|---|---|---|---|
| Ingredients | A | A3 | A4 | A5 |
| Water | 72.84 | 67.84 | 67.84 | 67.84 |
| Polyquarternium 10 | 0.24 | 0.24 | 0.24 | 0.24 |
| Incroquat Behenyl TMS | 2.40 | 2.40 | 2.40 | 2.40 |
| Polawax | 2.40 | 2.40 | 2.40 | 2.40 |
| Petroleum Jelly | 4.00 | 4.00 | 4.00 | 4.00 |
| Stearyl alcohol | 5.61 | 5.61 | 5.61 | 5.61 |
| Propylene glycol | 1.60 | 1.60 | 1.60 | 1.60 |
| Isopropyl myristate | 3.21 | 3.21 | 3.21 | 3.21 |
| Sorbitan Oleate | 1.60 | 1.60 | 1.60 | 1.60 |
| Myrj 52 | 1.60 | 1.60 | 1.60 | 1.60 |
| Pomegranate seed oil | 0.2 | 0.2 | 0.2 | 0.2 |
| Lactic acid | 0.2 | 0.2 | 0.2 | 0.2 |
| Benzyl alcohol | 2.0 | 2.0 | 2.0 | 2.0 |
| 1,3 Propanediol | 2.0 | 2.0 | 2.0 | 2.0 |
| Tetrahydrocurcuminoid | 0.1 | 0.1 | 0.1 | 0.1 |
| Mineral oil | — | 1.0 | 1.0 | 1.0 |
| Fermented soy protein | — | — | 2.0 | — |
| Resveratrol | — | 2.0 | 2.0 | 2.0 |
| Glycerine | — | 2.0 | — | 1.0 |
| Aloe barbadensis Juice | — | — | — | 1.0 |

Table 136 provides the data for the antimicrobial efficacy (Zone of Inhibition) for the test organism S. aureus.

TABLE 136

| | Zone of |
|---|---|
| Groups | Inhibition (mm) |
| A | 0 |
| A3 | 9.0 |
| A4 | 9.0 |

### Example 35

The present example provides formulations for oral care compositions containing benzyl alcohol and fruit acids with broad spectrum antimicrobial activity including antifungal activity.

Ventillator associated pneumonia (VAP) has been reported to result from oral pathogens adhering to the ventillator/endotracheal tubes and the use of Oral rinse containing antibacterials such as chlorhexidine may prevent ventilator associated pneumonia. Table 137 provides a summary of formulations for various compositions of oral care products.

TABLE 137

| | % (w/w) | | | | | | | | |
|---|---|---|---|---|---|---|---|---|---|
| Ingredients | OCP1 | OCP2 | OCP3 | OCP4 | OCP5 | OCP6 | OCP7 | OCP8 | OCP9 |
| Water | 70.46 | 70.46 | 66.528 | 66.338 | 66.238 | 66.078 | 66.235 | 76.737 | 76.587 |
| Polyquaternium10 | 0.175 | 0.175 | 0 | 0 | 0 | 0 | — | — | — |
| Hydroxypropul | 0.175 | 0.175 | 0 | 0 | 0 | 0 | — | — | — |
| cellulose | | | | | | | | | |
| Glycerin | 10 | 10 | 10 | 10 | 10 | 10 | 10 | 10 | 10 |
| Sodium saccharin | 0.08 | 0.08 | 0.08 | 0.08 | 0.08 | 0.08 | 0.08 | 0.08 | 0.08 |
| Pluronic F127 | 0.3 | 0.3 | 0.3 | 0.3 | 0.3 | 0.3 | 0.3 | 0.3 | 0.3 |
| Sorbic acid | 0.1 | 0.1 | 0 | 0 | 0 | 0 | — | — | — |
| Potassium sorbate | 0.1 | 0.1 | 0 | 0 | 0 | 0 | — | — | — |
| Spearmint oil | 0.01 | 0.01 | 0 | 0 | 0 | 0 | — | — | — |
| Zinc salicylate | 0.05 | 0.05 | 0 | 0.05 | 0.05 | 0.05 | 0.05 | 0.05 | 0.05 |
| Copper salicylate | | | | | | | 0.025 | 0.025 | 0.025 |
| Thymol | 0.05 | 0.05 | 0.05 | 0.05 | 0.05 | 0.05 | 0.064 | 0.064 | 0.064 |
| Menthol | 0 | 0 | 0.04 | 0.04 | 0.04 | 0.04 | 0.04 | 0.04 | 0.04 |
| Eucalyptol | 0 | 0 | 0.092 | 0.092 | 0.092 | 0.092 | 0.092 | 0.092 | 0.092 |
| Methyl salicylate | 0 | 0 | 0.06 | 0 | 0.06 | 0.06 | 0.06 | 0.06 | 0.06 |
| Benzyl alcohol | 0.6 | 0.6 | 1.0 | 1.0 | 1.0 | 1.0 | 1.0 | 1.0 | 1.0 |
| Grapefruit seed | 2.0 | 2.0 | 0 | 0 | 0 | 0 | — | — | — |
| extract | | | | | | | | | |
| 1,3 propranediol | 0.6 | 0.6 | 0 | 0 | 0 | 0 | — | — | — |
| Lactic acid | 0.2 | 0.2 | 0 | 0.2 | 0.2 | 0.2 | 0.2 | 0.2 | 0.2 |
| Sorbital solution | 0 | 0 | 0.1 | 0.1 | 0.1 | 0.1 | 0.1 | 0.1 | 0.1 |
| Benzoic acid | 0 | 0 | 0.1 | 0.1 | 0.1 | 0.1 | 0.1 | 0.1 | 0.1 |
| Sodium benzoate | 0 | 0 | 0.05 | 0.05 | 0.05 | 0.05 | 0.05 | 0.05 | 0.05 |
| Ethanol | 15 | 15 | 21.6 | 21.6 | 21.6 | 21.6 | 21.6 | 11.104 | 11.104 |
| Benzalkonium | 0.1 | 0 | 0 | 0 | 0 | 0 | — | — | — |
| chloride | | | | | | | | | |
| Chlorhexidine | 0 | 0.1 | 0 | 0 | 0 | 0 | — | — | — |
| gluconate | | | | | | | | | |
| Silver nitrate | 0 | 0 | 0 | 0 | 0.02 | 0 | — | — | — |
| Hydrogen peroxide | 0 | 0 | 0 | 0 | 0.02 | 0 | — | — | — |
| Sodium perborate | 0 | 0 | 0 | 0 | 0 | 0.2 | — | — | — |
| Chlorphyllin | — | — | — | — | — | — | 0.004 | 0 | — |
| Coloring agent | — | — | — | — | — | — | 0 | 0.002 | 0.002 |
| Citrus extract | — | — | — | — | — | — | — | 0.5 | 0.5 |
| Triclosan | — | — | — | — | — | — | — | — | 0.15 |

Table 138 provides the data for rapid antibacterial activity of mouth rinse OCP 8 (Method A).

TABLE 138

| | log₁₀ reduction from |
|---|---|
| Organism | control growth |
| S. aureus | 3.6 |
| P. aeruginosa | 4.14 |
| MRSA | 2.64 |

### Example 36

The present Example provides preservative compositions containing BPL. Table 139 provides a summary of the general formulation for stock solutions and for that used in cream product.

TABLE 139

| | Composition | Use level in |
|---|---|---|
| | in Stock | cream (1-1.5%) |
| | Range | Range |
| Benzyl alcohol | 40-85 | 0.4-1.3 |
| Lactic acid | 10-20 | 0.1-0.3 |
| 1,3 Propanediol | 15-40 | 0.15-0.6 |
| Tetrhydrocurcuminoid | 3-10 | 0.03-0.15 |

Table 140 provides the formulations for various preservative compositions (PC).

TABLE 140

| | PC8 | | PC14 | | PC18 | | PC19 | | PC20 | |
|---|---|---|---|---|---|---|---|---|---|---|
| | | Cream | | Cream | | Cream | | Cream | | Cream |
| Ingredients | Stock | (1.1% stock) | Stock | (1.3% stock) | Stock | (1.2% stock) | Stock | (1.5% stock) | Stock | (1.5% stock) |
| Benzyl alcohol | 72.7 | 0.8 | 61.5 | 0.8 | 83.4 | 1.0 | 66.7 | 1.0 | 66.7 | 1.0 |
| 1,3 Propanediol | 22.7 | 0.25 | 19.2 | 0.25 | | | 16.6 | 0.25 | 20.0 | 0.3 |
| Tetrhydro- | 4.6 | 0.05 | 3.9 | 0.05 | | | 3.40 | 0.05 | | |
| curcuminoid | | | | | | | | | | |
| Lactic acid | | | 15.4 | 0.2 | 16.6 | 0.2 | 13.3 | 0.2 | 13.3 | 0.2 |

Method of evaluating the efficacy of preservatives. Test Method B: Bacteria: 10⁸ CFU organism/ml. For the test samples, preservative was added to 10 grams of the cream at a concentration 0f 1.5-2% and mixed well. From this sample, 1 gram aliquots were placed into 10 ml sterile plastic culture tubes and 0.1 ml (100 micro liters) of the test inoculums was added and vortexed until uniformly blended. The tubes were then placed into incubators at 37° C. for 24 hours. At the end of the incubation period, 9.0 ml of Butterfield Phosphate Buffered solution with neutralizer was added to the incubated cultured sample and vortexed until completely mixed. The samples were serially diluted and then plated in Trypticase soy agar (TSA). The plates were incubated at 37° C. temperature for 24-48 hours, and the counts were read. Placebo cream was tested similarly and used as the control. Table 141 shows the efficacy of preservative compositions against S. aureus and P. aeruginosa.

TABLE 141

| | S. aureus | P. aeruginosa |
|---|---|---|
| | log₁₀ reduction | log₁₀ reduction |
| Groups | from control | from control |
| #14 | 7.70 | 7.91 |
| #18 | 4.86 | 7.91 |
| #19 | 7.70 | 7.91 |
| #20 | 7.70 | 7.91 |

### Example 37

Example 36 provides various formulations for preoperative skin disinfectant compositions. These compositions contain synergistic combinations of benzyl alcohol, fruit acid, and antimicrobials such as chlorhexidine glluconate (CHG) or povidone iodine (PVI).

TABLE 142

| | Pre-Op | Pre-Op | Pre-Op | Pre-Op |
|---|---|---|---|---|
| | Disin- | Disin- | Disin- | Disin- |
| | fectant - | fectant - | fectant - | fectant - |
| | CHG | CHG-Gel | PVI | PVI-Gel |
| Ingredient | % w/w | % w/w | % w/w | % w/w |
| Benzyl alcohol | 3 | 3 | 3 | 3 |
| Lactic acid | 2 | 2 | 2 | 2 |
| SDA 3C | 67.2 | 67.2 | — | — |
| alcohol | | | | |
| CHG | 2 | 2 | — | — |
| Polyquaternium | — | 0.2 | — | 0.2 |
| 10 | | | | |
| Hydroxypropyl | — | 0.2 | — | 0.2 |
| methyl cellulose | | | | |
| (K4M) | | | | |
| 1,3 propanediol | — | — | 2 | 2 |
| Glycerine | — | — | 4 | 4 |
| PVI | — | — | 7.5 | 7.5 |
| Water | 25.8 | 25.4 | 81.5 | 81.1 |

### Example 38

The present Example provides an evaluation of synergistic antibacterial activity of benzyl alcohol and citrus fruit extract in the presence of proteinaceous media.

Citrus fruit extract was obtained from PL Thomas (BiosecurF440D organic citrus fruit extract concentrate). The following concentrations of compounds were added to S. aureus culture (10⁸ cfu/ml of media containing 50% TSB and 50% bovine serum). After 1 minute, drug neutralizing fluid (DNF) was added and mixed. The samples were then serially diluted with DNF and plated in TSA plate. The plates were incubated for 24-48 hours at 37° C. and colony counts were determined.

TABLE 143

| | Antibacterial activity against |
|---|---|
| | S. Aureus (10⁸ CFU/ml) |
| Groups (% w/w) | log₁₀ reduction |
| Citrus extract 1.0 | 1.61 |
| Citrus extract 0.5 | 1.0 |
| Benzyl alcohol 2.0 | 0.1 |
| Citrus 0.5 + Lactic acid 0.2 | 0.7 |
| Benzyl alcohol 2.0 + Citrus oil 0.5% | 7.94 |
| Benzyl alcohol 2.0 + Lactic | 7.94 |
| acid 0.2 + Citrus oil 0.5% | |

The data show that benzyl alcohol and citrus extract exhibits significant synergism.

### Example 39

The present Example provides an evaluation of alcohol hand disinfectants in a pig skin model. In the present Example, Purell (alcohol-based hand sanitizer (Gojo) was evaluated. Additionally, a second Purell formulation was evaluated, Purell+(purell hand sanitizer+2% benzyl alcohol+3% zemea+2% lactic acid).

The Example measured rapid and sustained activity using pigskin method which simulates ASTM E1174 test for hand disinfectant. Two skin pairs were rinsed and washed with antibacterial soap 30 seconds. One piece of the pair was contaminated with 30 μl of a 10⁷⁻ cfu bacterial culture, the two pieces were rubbed for 30 seconds and allowed to air dry for 30 seconds. The bacteria was eluted with PBS and plated after serial dilution. These counts were used as baseline counts.

To evaluate the efficacy of test solutions, the same pair of skin pieces was rinsed and washed using non-antibacterial soap and recontaminated as above. After the 30 second drying period 0.5 ml of the antibacterial soap being tested was placed on the skin and rubbed together. The rest of the procedure was followed as described above for the baseline counts except that Drug neutralizing fluid was used for the test as the sampling fluid.

Bacterial contamination and application of test solutions were repeated (total of 5 application), only difference in the method is after the application of test solution the skins were left at room temperature for drying for 5 minutes before recontamination. After the fifth application and drying for 5 minutes pigskins were rinsed with Drug neutralizing fluid to elute the remaining bacteria. Table 144 provides the results from rapid and sustained activity using pigskin method using the test organism S. aureus.

TABLE 144

| | After first application | After 5^{th} application |
|---|---|---|
| | Log10 reduction from control | Log10 reduction from control |
| | growth | growth |
| Purell | 1.80 | 0.55 |
| Purell+ | 2.75 | 2.50 |

Required log₁₀ reduction for rapid and sustained activity by the ASTM E1174 test is 2.0 log₁₀ for rapid and 3.0 log₁₀ for sustained activity. In conclusion, the addition of BPL to Purell enhances the activity especially the sustained activity significantly.

### Example 40

The present Example provides formulations for exemplary, but not limiting, preservative compositions of the present invention.

TABLE 145
Preservative Composition 21A

| | Composition of | Cream containing |
|---|---|---|
| Ingredients | stock solution | 1.0% stock |
| Benzyl alcohol | 80 | 0.8 |
| Citrus extract | 20 | 0.2 |

TABLE 146
Preservative Composition 21B

| | Composition of | Cream containing |
|---|---|---|
| Ingredients | stock solution | 12% stock |
| Benzyl alcohol | 66.7 | 0.8 |
| Citrus extract | 16.7 | 0.2 |
| Grapefruit seed extract | 16.7 | 0.2 |

### Example 41

The present Example provides an evaluation of nutraceutical and food antibacterial (NFA) compositions. The following table provides the details of NFA preservative composition #1.

TABLE 147

| | Composition of | Concetration range |
|---|---|---|
| Ingredients | stock solution | in use level |
| Benzyl alcohol | 80 | 0.4-1.6 |
| Citrus extract | 10.0 | 0.05-0.2 |
| Grapefruit seed extract | 10.0 | 0.05-0.2 |

The use level is in 50-200 fold dilution of stock in water.

The antibacterial activity of NFA 1 (1 to 100 dilution) was evaluated. 100 ul of S. aureus (10⁶ cfu/ml) was added to 1 ml of the diluted preservative and left at room temperature for 1 minute. Another set was left at room temperature for 5 minutes. Drug neutralizing fluid was added to the samples after appropriate time and serially diluted. Aliquots were plated on Trypticase soy agar plate and incubated at 37° C. for 24-48 hours. For control, PBS was used instead of the preservative and processed similarly.

TABLE 148

| | log₁₀ reduction from |
|---|---|
| Time | control growth |
| 1 minute | 5.3 |
| 5 minute | 5.3 |

### Example 42

The present Example provides various formulations for cosmaceutical preservative compositions containing benzyl alcohol and citrus extract.

TABLE 149A
Formulation 14A

| | | Amount in cream |
|---|---|---|
| Ingredients | Stock (%) | containing 1.3% stock |
| Benzyl alcohol | 61.54 | 0.8 |
| Citrus extract (BS440D) | 15.38 | 0.2 |
| Tetrahydrocurcuminoid | 3.85 | 0.05 |
| (THC) | | |
| 1,3-propanediol | 19.23 | 0.25 |
| Use level is 1.0-2.0% | | |

TABLE 149B
Formulation 14B

| | | Amount in cream |
|---|---|---|
| Ingredients | Stock (%) | containing 1.35% stock |
| Benzyl alcohol | 37.0 | 0.5 |
| Citrus extract (BS440D) | 22.3 | 0.3 |
| Tetrahydrocurcuminoid | 3.70 | 0.05 |
| (THC) | | |
| 1,3-propanediol | 37.0 | 0.5 |

TABLe 149C
Formulation 14C

| | | Amount in cream |
|---|---|---|
| Ingredients | Stock (%) | containing 1.55% stock |
| Benzyl alcohol | 32.2 | 0.5 |
| Citrus extract (BS440D) | 19.4 | 0.3 |
| Tetrahydrocurcuminoid | 3.20 | 0.05 |
| (THC) | | |
| 1,3-propanediol | 32.3 | 0.5 |
| Lactic acd | 12.9 | 0.2 |
| Use level is 1.2-2.0% | | |

### Example 43

The present Example provides a formulation and evaluation of neutraceutical and food preservative (NP) compositions. Specifically, this formulation contains benzyl alcohol and citrus extract.

TABLE 150

| NPA | Stock (%) |
|---|---|
| Benzyl alcohol | 80 |
| Citirus extract | 20 |
| NPB | Stock (%) |
| Benzyl alcohol | 80 |
| Citrus extract | 10 |
| Grapefruit seed extract | 10 |
| Use Level is 1-2% | |

The method used for the evaluation of the efficacy of the NP compositions includes the following. 1 ml of NP blend was added to S. aureus culture (0.1 ml of 106 cfu/ml). After vortexing the blend for 1 minute, drug neutralizing fluid (DNF) was added and mixed. The blends were then serially diluted with DNF and plated in TSA plates. The plates were incubated for 24-48 hours at 37° C. and colony counts were determined. The following Table provides the results.

TABLE 151

| | log₁₀ reduction from control growth | |
|---|---|---|
| Organism | NPA | NPB |
| S. aureus | 5.3 | 4.9 |
| MRSA | 4.24 | (Not Done) |
| E. coli | 5.6 | 5.0 |

### Example 44

The present Example provides a formulation for an oral care composition containing benzyl alcohol and citrus extract. The following Table provides the details of the test compositions (OCP8) with Lysterine.

TABLE 152

| Ingredients | OCP8 % (w/w) | Lysterine |
|---|---|---|
| Water | 76.739 | NA |
| Glycerin | 10.0 | NA |
| Sodium saccharin | 0.08 | NA |
| Pluronic F127 | 0.3 | NA |
| Zinc salicylate | 0.05 | — |
| Copper salicylate | 0.025 | — |
| Thymol | 0.064 | 0.064 |
| Menthol | 0.04 | 0.04 |
| Eucalyptol | 0.092 | 0.092 |
| Methyl salicylate | 0.06 | 0.06 |
| Benzyl alcohol | 1.0 | — |
| Lactic acid | 0.2 | — |
| Sorbitol solution | 0.1 | NA |
| Benzoic acid | 0.1 | NA |
| Sodium benzoate | 0.05 | NA |
| Ethanol | 10.6 | 21.6 |
| Citrus extract [C-320C] | 0.5 | — |

An evaluation of the rapid killing efficacy of oral care products was carried out. 0.8 ml of OCP8 and Lysterine mouth wash was added to 0.1 ml of 108 cfu/ml of bacteria (MRSA) and 0.1 ml of Bovine serum After vortexing for 15 seconds, 9 ml of drug neutralizing fluid (DNF) was added and mixed. The samples were then serially diluted with DNF and plated in TSA plates. The plates were incubated for 24 hours at 37° C. and colony counts were determined. The following table provides the results for the rapid antibacterial (15 seconds) activity of the mouthrinse OCP8 against the test organism MRSA.

TABLE 153

| | log₁₀ reduction from |
|---|---|
| Group | control growth |
| OCP8 | 3.63 |
| Lysterine | 2.7 |

### Example 45

The present Example provides a formulation and evaluation of an aqueous hand santifizer containing benzyl alcohol and botanicals. The following table provides 3 nonlimiting examples of formulations.

TABLE 154

| | 18LA8 | 37D | 32 |
|---|---|---|---|
| Phase A | | | |
| Grapefruit seed | 1.0 | 0 | 0 |
| extract | | | |
| Citrus extract | 0 | 0.5 | 0 |
| (Biosecure F440D) | | | |
| Benzethonium | 0 | 0 | 0.2 |
| chloride | | | |
| Benzyl alcohol | 2 | 2 | 2 |
| 1,3 Propanediol | 3 | 3 | 3 |
| Lactic acid | 2.0 | 2.0 | 0 |
| Citric acid | 0 | 0 | 2.0 |
| Glucopon 215UP | 1 | 1 | 1 |
| SDA 3C | 10 | 10 | 0 |
| SDA 40B | 0 | 0 | 10 |
| Phase B | | | |
| Water | 80.1 | 80.6 | 80.8 |
| HPMC (K4M) | 0.2 | 0.2 | 0.2 |
| Polyquaternium10 | 0.2 | 0.2 | 0.2 |
| 1,3 Propanediol | 0.5 | 0.5 | 0.5 |
| Zinc lactate | 0 | 0 | 0.1 |
| pH 3.3-3.6 | | | |

The following Table provides the data for in vitro rapid kill (15 seconds) using the FDA TEM method (Method A described above).

TABLE 155

| | log₁₀ reduction from control growth | | | |
|---|---|---|---|---|
| Organism | 37D | 18LA-8 | 32 | Purell |
| E. Coli | 7.80 | 7.06 | 8.0 | 6.39 |
| MRSA | 7.25 | 8.02 | 7.25 | 8.1 |
| S. aureus | 8.8 | 8.14 | 8.14 | 8.64 |
| P. aeruginosa | 7.3 | 8.1 | 8.2 | 7.56 |
| K. pneumonia | 4.5 | 4.6 | 4.5 | 4.0 |

Method B. Rapid and sustained activity using pigskin method which simulates the ASTM E1174 test for hand disinfectants. Two skin pairs were rinsed and washed with antibacterial soap for 30 seconds. One piece of the pair was contaminated with 30 μl of a 107-cfu bacterial culture. The two pieces were rubbed for 30 seconds and allowed to air dry for 30 seconds. The bacteria was eluted with PBS and plated after serial dilution. These counts were used as baseline counts. To evaluate the efficacy of test solutions, the same pair of skin pieces were recontaminated as above. After the 30 second drying period, 0.5 ml of the antibacterial product being tested was placed on the skin and rubbed together. The rest of the procedure was followed as described above for the baseline counts except that drug neutralizing fluid was used for the test as the sampling fluid. Bacterial contamination and application of test solutions were repeated (total of 5 applications). The only difference in the method is after the application of test solution, the skins were left at room temperature for drying for 5 minutes before recontamination. After the fifth application and drying for 5 minutes, pigskins were rinsed with drug neutralizing fluid to elute the remaining bacteria.

The following Table provides the data for rapid and sustained activity using pigskin method (stimulates ASTEM E1174 test for hand disinfectant) against the organism S. aureus. The required log₁₀ reduction for rapid and sustained activity by the ASTM E1174 test is 2.0 log₁₀ for rapid and 3.0 log₁₀ for sustained activity.

TABLE 156

| | After first application | After 6th application |
|---|---|---|
| | Log10 reduction | Log10 reduction |
| | from control | from control |
| Composition | group | group |
| 37D | 2.3 | 4.5 |
| 18 LA-8 | 2.96 | 3.67 |
| Purell | 1.8 | 0.55 |

### Example 46

The present example is directed to the preparation of hydrophilic creams.

The following formulation is a placebo cream without wound healing agents and antimicrobial agents.

TABLE 157
Hydrophilic cream base (Placebo cream)

| Ingredient | % (w/w) |
|---|---|
| Petrolatum | 8.0 |
| Stearyl alcohol | 12.0 |
| Isopropyl Myristate | 4.0 |
| Sorbitan oleate | 2.0 |
| Polyoxy 40 stearate (Myrj 52) | 5.0 |
| Germal + | 0.3 |
| Propylene glycol | 4.0 |
| Water | 64.7 |

The following formulation is a wound healing cream containing zinc salts and calendula oil (W-ZC cream).

TABLE 158
W-ZC cream

| Ingredient | % (w/w) |
|---|---|
| Petrolatum | 8.0 |
| Stearyl alcohol | 12.0 |
| Isopropyl Myristate | 4.0 |
| Sorbitan oleate | 2.0 |
| Polyoxy 40 stearate (Myrj 52) | 5.0 |
| Germal + | 0.3 |
| Propylene glycol | 4.0 |
| Zinc Lactate | 0.2 |
| Zinc Oxide | 0.3 |
| Calendula oil | 1.0 |
| Water | 63.2 |

The following formulation is an antimicrobial cream containing silver sulfadiazine (AgSD cream).

TABLE 159
AgSD cream

| Ingredient | % (w/w) |
|---|---|
| Petrolatum | 8.0 |
| Stearyl alcohol | 12.0 |
| Isopropyl Myristate | 4.0 |
| Sorbitan oleate | 2.0 |
| Polyoxy 40 stearate (Myrj 52) | 5.0 |
| Germal + | 0.3 |
| Propylene glycol | 4.0 |
| Silver sulfadiazine | 1.0 |
| Water | 63.7 |

The following formulation is an antimicrobial and wound healing cream containing silver sulfadiazine, zinc salts, and calendula oil (AgSD-ZC).

TABLE 160
AgSD-ZC cream

| Ingredient | % (w/w) |
|---|---|
| Petrolatum | 8.0 |
| Stearyl alcohol | 12.0 |
| Isopropyl Myristate | 4.0 |
| Sorbitan oleate | 2.0 |
| Polyoxy 40 stearate (Myrj 52) | 5.0 |
| Germal + | 0.3 |
| Propylene glycol | 4.0 |
| Zinc Lactate | 0.2 |
| Zinc Oxide | 0.3 |
| Calendula oil | 1.0 |
| Silver Sulfadiazine | 1.0 |
| Water | 62.2 |

The following formulation is a cream containing silver sulfadiazine, zinc salts, calendula oil, and a silver releasing agent and stabilizer (AgSD-ZC-1 cream). Specifically, the cream contains lactic acid as the silver releasing agent and sodium perborate as the stabilizer.

TABLE 161
AgSD-ZC-a cream

| Ingredient | % (w/w) |
|---|---|
| Petrolatum | 8.0 |
| Stearyl alcohol | 12.0 |
| Isopropyl Myristate | 4.0 |
| Sorbitan oleate | 2.0 |
| Polyoxy 40 stearate (Myrj 52) | 5.0 |
| Germal + | 0.3 |
| Propylene glycol | 4.0 |
| Zinc Lactate | 0.2 |
| Zinc Oxide | 0.3 |
| Calendula oil | 1.0 |
| Silver sulfadiazine | 1.0 |
| Lactic acid | 1.0 |
| Sodium perborate | 1.0 |
| Water | 60.2 |

The following formulation is a cream containing silver sulfadiazine, zinc salts, calendula oil, lactic acid as a silver releasing agent, sodium perborate as a stabilizer, and octanediol as an antifungal activity enhancing agent (AgSD-ZC-2 cream).

TABLE 162
AgSD-ZC-2 cream

| Ingredient | % (w/w) |
|---|---|
| Petrolatum | 8.0 |
| Stearyl alcohol | 12.0 |
| Isopropyl Myristate | 4.0 |
| Sorbitan oleate | 2.0 |
| Polyoxy 40 stearate (Myrj 52) | 5.0 |
| Germal + | 0.3 |
| Propylene glycol | 4.0 |
| Zinc Lactate | 0.2 |
| Zinc Oxide | 0.3 |
| Calendula oil | 1.0 |
| Silver sulfadiazine | 1.0 |
| Lactic acid | 1.0 |
| Sodium perborate | 1.0 |
| 1,2 Octanediol | 0.5 |
| Water | 59.7 |

### Example 47

The present example determines the antibacterial activity of topical creams for the treatment of surface wounds.

Zone of inhibition test. Trypticase soy agar plates were seeded with 0.1 ml of 108 cfu of various bacteria and 107 cfu of C. albicans. Four wells of 0.7 cm diameter were made on the plate using cork borer. Each well was filled with 0.1 gm of the cream, and the plates were incubated for 24 hors at 37° C. The zones of inhibition were measured.

TABLE 163
Zones of Inhibition (mm) of creams

| Organisms | | | | AgSD- | AgSD- | AgSD |
|---|---|---|---|---|---|---|
| Gram Positive | Z | ZC | AgSD | ZC | ZC- 1 | ZC- 2 |
| S. aureus- | 8.0 | 9 | 15.5 | 16.0 | 25 | 25 |
| MRSA | 11 | 12 | 14 | 14 | 33 | 34 |
| P. aeruginosa | 10 | 19 | 15 | 16 | 19.5 | 20 |
| C. albicans | 8 | 8 | 16 | 17 | 18 | 19 |

Conclusion: Creams containing silver releasing agent, stabilizer (AgSD-ZC 1) and the same + octanediol (AgSD ZC 2) show higher zones of inhibition.

### Example 48

The present example provides an evaluation of various creams on their efficacy in reducing bacterial growth on infected burn wounds.

Pig Skin Method. Pig skin was washed and sterilized by soaking in 70% ethanol for 15 minutes. Several 1.5 cm² pieces were cut and rinsed in sterile saline. A circular cylinder (1 cm diameter) was heated on a Bunsen burner for 10 seconds by keeping and pressing for 10 seconds on the dorsal side of the skin. After 10 minutes, the burned surface was inoculated with 10 ul of 108 cfu/ml of the test organism and incubate at 37° C. for 1 hour. 0.1 gm of various creams were applied on each of the infected skin, spread evenly, then incubated for 2 hours at 37° C. (3 skin samples were used for each group). Then, the cream was removed by wiping with sterile wet gauze. The 3 samples of skin were transferred to a sterile tube containing 30 ml sterile saline (3 skins from 1 group/30 ml). The samples were vortexed for 10 seconds, and the skins were removed to fresh saline and the rinsing process repeated. The skins were removed and blotted dry on a sterile guaze. Each skin was transferred to a culture tube containing 4.0 ml drug inactivating media, sonicated for 20 minutes to remove the adherent bacteria from the skin to the media. 0.5 ml of the media was plated on trypticase soy agar. The plates were then incubated for 24-48 hours and the colony counts were determined

TABLE 164
Reduction of bacterial counts in Pig Skin
( Log10 reduction from control cream)

| Group | S aureus | P aeruginosa | C. albicans |
|---|---|---|---|
| AgSD | 0.2 | 1.1 | 0.32 |
| AgSD-ZC | 1.2 | 1.1 | 0.4 |
| AgSD-ZC-1 | 3.0 | 3.9 | 0.59 |
| AgSD-ZC-2 | 3.5 | 4.2 | 1.32 |

Conclusion: Creams containing silver releasing agent, stabilizer (AgSD-ZC 1) and the same + octanediol (AgSD ZC 2) show higher efficacy. The cream containing Octanediol show higher antifungal activity.

### Example 49

The present example is directed to a topical anti inflammatory/wound healing/antimicrobial composition containing silver sulfadiazine, synergistic combinations of benzyl alcohol, curcumin, 1,3 propanediol, calendula oil and zinc salts for the treatment of burn wound and other surface wound infections.

In order to develop a broad spectrum antimicrobial, anti-inflammatory topical cream with wound healing properties for control of burn and other surface wound infections, a cream containing silver sulfadiazine, and the synergistic combination of benzyl alcohol, tetrahydroxy curcuminoids (THC), 1,3 propanediol (BTCP), calendula oil and zinc salts was developed. The pH was adjusted to 6.3-6.4. Placebo cream A (below) is a cream without wound healing agents and antimicrobial agents

TABLE 165
Placebo cream A

| Ingredient | % (w/w) |
|---|---|
| Petrolatum | 9.68 |
| Stearyl alcohol | 14.52 |
| Isopropyl Myristate | 4.84 |
| Sorbitan oleate | 2.42 |
| Polyoxy 40 stearate (Myrj 52) | 6.05 |
| Germal + | 0.3 |
| Propylene glycol | 4.0 |
| Water | 58.19 |

The following formulation is a cream containing silver sulfadiazine (AgSD-A).

TABLE 166
AgSD-A cream

| Ingredient | % (w/w) |
|---|---|
| Petrolatum | 9.68 |
| Stearyl alcohol | 14.52 |
| Isopropyl Myristate | 4.84 |
| Sorbitan oleate | 2.42 |
| Polyoxy 40 stearate (Myrj 52) | 6.05 |
| Germal + | 0.3 |
| Propylene glycol | 4.0 |
| Silyersulfadiazine | 1.0 |
| Water | 57.19 |

The following cream contains silversulfadiazine, one insoluble zinc salt and one soluble zinc salt, and calendula oil (Silvadex 1).

TABLE 167
Silvadex 1

| Ingredient | % (w/w) |
|---|---|
| Petrolatum | 9.68 |
| Stearyl alcohol | 14.52 |
| Isopropyl Myristate | 4.84 |
| Sorbitan oleate | 2.42 |
| Polyoxy 40 stearate (Myrj 52) | 6.05 |
| Germal + | 0.3 |
| Propylene glycol | 4.0 |
| Zinc Lactate | 0.2 |
| Zinc Oxide | 0.3 |
| Calendula oil | 1.0 |
| Silversulfadiazine | 1.0 |
| Lactic acid | 0.06 |
| Water | 55.63 |

The following cream contains silver sulfadiazine, zinc salts, calendula oil and BTCP (Silvadex 2).

TABLE 168
Silvadex 2

| Ingredient | % (w/w) |
|---|---|
| Petrolatum | 9.68 |
| Stearyl alcohol | 14.52 |
| Isopropyl Myristate | 4.84 |
| Sorbitan oleate | 2.42 |
| Polyoxy 40 stearate (Myrj 52) | 6.05 |
| Germal + | 0.3 |
| Propylene glycol | 4.0 |
| Zinc Lactate | 0.2 |
| Zinc Oxide | 0.3 |
| Calendula oil | 1.0 |
| Silversulfadiazine | 1.0 |
| Benzyl alcohol | 0.5 |
| THC | 0.075 |
| 1,3 propanediol | 0.5 |
| Lactic acid | 0.06 |
| Water | 54.56 |

The following Table provides the zones of inhibition (mm) of creams against C. albicans.

TABLE 169

| | C.albicans |
|---|---|
| Silvadex 1 | 20 |
| Silvadex 2 | 25 |
| AgSD ZC-2 | 19 |
| Commercial SSD | 16 |
| (Kendall) | |

Conclusion: Silvadex creams containing BTCP are more effective than that containing Octanediol.

### Example 50

The present example is directed to wound healing and infection control in burned rats treated with various creams.

36 Rats were deeply anesthetized using ketamine-xylazine mixture injection given intramuscularly (50 mg/kg each). A brass bar (20×20×100 mm) was heated in boiling water for 15 minutes and the end of the heated bar was applied on the shaved back of the rats for 45 seconds. The wound area was measured.

After a period of 30 minutes, freshly prepared bacterial inoculums of Pseudomonas aeruginosa (MTCC 741) containing 10⁸ cfu per ml was applied topically on the site of burn wound area at the dose rate of 2000 per rat. Infection was done only once.

All of the animals were divided in different groups of 9 animals in each group and given various treatment 4 hours after infection. About 1 gm of cream was applied topically in each rat wound twice daily for 12 days.

Each day before applying the new cream, the old cream residue was removed by gently rubbing the burn wound area with sterile saline gauze.

On day 12 after the induction of burn wound/bacterial infection, the burn wound eschar was removed surgically. The burn wound area was measured. Animals were sacrificed at the termination of the experiment.

After the wound eschar was removed, swab samples were taken from the center of the burn wound area from all 36 rats (from all four treatment groups), and a semi quantitative bacterial assay was performed by spreading the swab culture from each rat on a nutrient agar plate, and incubating the plates at 37° C. for 24 hrs. The bacterial growth on the plates was determined.

The following table provides the percentage of reduction of wound area and bacterial counts in wound area of rats burned and treated with various creams.

TABLE 170
Wound area (mm²) of animals on day 1 and day 12

| | | % Reduction in | |
|---|---|---|---|
| | | wound area from | Bacterial counts |
| Group | Treatment | day 1 to day 12 | on day 12 |
| 1 | Placebo Cream | 16.86 | 7.5 × 10⁴ |
| 2 | Commercial | 9.09 | 2.5 × 10⁴ |
| | silversulfadiazene | | |
| 3 | AgSD-A cream | 18.47 | 3.03 × 10² |
| 4 | Silvadex 1 | 27.97 | 1.6 × 10¹ |

### Example 51

The present example is directed to the efficacy of NP-CG1 on contaminated meat. 1 cm² samples of pig flesh with skin were contaminated with E. coli by soaking them in E. Coli culture (104 cfu/ml) for 4 hours. The skin/flesh were removed and blotted dry and divided into 3 groups of 4 pieces per group. Each group was soaked for 5 minutes in solution, removed and rinsed with saline. The solution contained saline rinse (group 1), FDC-1 rinse (group 2), or commercial vegetable fruit wash (VF wash) (group 3). The formulation for the FDC-1 rinse is provided below.

TABLE 171

| FDC-1 | % w/w |
|---|---|
| Benzyl alcohol | 2.0 |
| Citric acid | 1.0 |
| Citrus extract | 0.2 |
| Glucopon 215 UP | 2.0 |
| Water | 94.8 |
| pH 3.5 | |
| Use undiluted | |

Each piece was then transferred to a culture tube and 5 ml drug neutralizing fluid (DNF) was added and sonicated for 20 minutes to remove the adherent bacteria to the fluid. After serial dilution, the samples were plated on Tripticase soy agar and incubated for 24 hours. The following Table provides the levels of bacterial growth amongst the groups.

TABLE 172
Efficacy of Disinfectant cleanser

| Group | Bacterial Growth ( Log10) | Log reduction |
|---|---|---|
| Group I ( control) | 5.3 | — |
| FDC- 1 | 2.3 | 3.0 |
| VF wash | 5.1 | 0.2 |

Various patent and non-patent publications are cited herein, the contents of which are hereby incorporated by reference in their entireties.

1-22. (canceled)

23. An antifungal topical cream comprising a synergistic combination of 0.5-5% w/w benzyl alcohol and one or more of compounds selected from the group consisting of
(a) 0.3-5.0% w/w 1,3 propanediol and its derivatives,
(b) 0.04-0.5% w/w botanicals selected from the group consisting of curcumin compounds,
(c) 0.04-1.05% w/w essential oils, fruit extracts, and plant extracts,
(d) 0.2-2.0% w/w fruit acid, and
(e) 0.5-2.0% alkanediols.

24. (canceled)

25. An antimicrobial composition comprising:
(a) from about 0.5% to about 10% (w/w) benzyl alcohol or its derivatives; and
(b) from about 0.2 to about 4.0% (w/w) botanical extracts;
wherein the combination of benzyl alcohol and botanical extract exhibits synergistic activity.

26-31. (canceled)

32. The antimicrobial composition of claim 25, wherein the botanical extract is selected from the group consisting of grapefruit seed extract, grapefruit peel extract, pomegranate seed extract, citrus extract, oregano extract, thyme extract, resveratrol, curcumin compounds, green tea extract, white tea extract, soy extract, fermented soy protein, aloe vera extract, and aloe vera juice.

33-38. (canceled)

39. An antimicrobial composition comprising a synergistic combination of:
(a) from about 2% to about 10% (w/w) benzyl alcohol and its derivatives;
(b) from about 2% to about 4% (w/w) fruit acids;
(c) from about 0% to about 10% (w/w) 1,3 propanediol;
(d) from about 0% to about 4% (w/w) botanical extracts;
(e) from about 0% to about 1% (w/w) essential oil; and
(f) from about 0% to about 5% (w/w) synthetic antimicrobials.

40. A disinfectant products comprising the antimicrobial composition according to 39.

41. (canceled)

42. An alcohol based skin disinfectant comprising:
(a) from about 5% to about 70% (w/w) an aliphatic alcohol;
(b) from about 1% to about 5% (w/w) benzyl alcohol
(c) from about 0.2% to about 4% monocarboxylic fruit acid;
(d) from about 0% to about 10% alkanediol;
(e) from about 0% to about 2% synthetic antibacterial agent (0-2%); and
(f) from about 20% to about 90% water.

41. (canceled)

44. A topical composition comprising synergistically effective amounts of:
(a) a silver compound;
(b) an essential oil or individual constituent; and
(c) one or more zinc salts.

45. The topical composition of claim 44, wherein the silver compound is silver sulfadiazene.

46. The topical composition of claim 44, wherein the essential oil or individual constituent is selected from the group consisting of calendula oil, curcuminoids, and mixtures thereof.

47. The topical composition of claim 44, further comprising one or more additional antimicrobial agents.

48. The topical composition of claim 44, further comprising one or more alkanediol.

49. The topical composition of claim 48, wherein the alkanediol is selected from the group consisting of 1,3 propanediol, octanediol, decanediol, and mixtures thereof.

50. The topical composition of claim 44, further comprising a fruit acid.

51. The topical composition of claim 49, wherein the fruit acid is selected from the group consisting of citric acid, lactic acid, and mixtures thereof.

52. The topical composition of claim 44, wherein the zinc salts comprise a soluble zinc salt and a nonsoluble zinc salt.

53. (canceled)

54. The topical composition of claim 48, further comprising benzyl alcohol.

55. A food disinfectant cleanser comprising from about 0.5 to about 5.0% benzyl alcohol, from about 0.2 to about 2.0% fruit acid, from about 0.2 to about 1.0% botanical extract, from about 0.1 to about 5.0% surfactant, and water.
